(19) United States
(12) Patent Application Publication
(10) Pub. No.: US 2002/0120429 A1
(43) Pub. Date: Aug. 29, 2002

(54) Methods for modeling multi-dimensional domains using information theory to resolve gaps in data and in theories

(75) Inventor: Peter J. Ortoleva, Bloomington, IN (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Peter J. Ortoleva, Bloomington, IN

(21) Appl. No.: 10/017,829

(22) Filed: Dec. 7, 2001

Related U.S. Application Data
(63) Continuation-in-part of application No. 09/818,752, filed on Mar. 27, 2001.
(60) Provisional application No. 60/254,433, filed on Dec. 8, 2000.

(51) Int. Cl. G06F 17/10

(52) U.S. Cl. 703/2

(57) ABSTRACT

Disclosed are methods for modeling multi-dimensional domains by merging multiple input data sets into a model, applying multiple dynamic theories to evolve the model, and using information theory to resolve gaps in, and discrepancies among, the data sets and the theories. One example is a three-dimensional geologic basin simulator that integrates seismic inversion techniques with other data to predict fracture location and characteristics. The geologic simulator delineates the effects of regional tectonics, petroleum-derived overpressure, and salt tectonics and constructs maps of high-grading zones of fracture producibility. A second example is a living cell simulator that uses chemical kinetic rate laws of transcription and translation polymerization to compute mRNA and protein populations as they occur autonomously, in response to changes in the surroundings, or from injected viruses or chemical factors. Features such as the eukaryotic nucleus are treated with a novel mesoscopic reaction-transport theory. Metabolic reactions take place in appropriate compartments.

### CROSS-REFERENCE TO RELATED APPLICATIONS

The present application is a continuation-in-part of U.S. patent application Ser. No. 09/818,752, filed on Mar. 27, 2001, and also claims the benefit of U.S. Provisional Patent Application No. 60/254,433, filed on Dec. 8, 2000, which is hereby incorporated in its entirety by reference.

### TECHNICAL FIELD

The present invention relates generally to multi-dimensional modeling, and, more particularly, to modeling using information theory to resolve gaps in available data and theories.

### BACKGROUND OF THE INVENTION

The benefits of modeling complex, multi-dimensional domains have long been known. For example, accurate models of geologic domains enhance petroleum extraction while minimizing exploration and production costs. Dynamic models of living cells provide insight into cellular behavior and are useful for predicting the effects of pharmaceuticals and optimizing treatment strategies. Modem sampling and measurement techniques provide a wealth of data sets but are usually only indirectly related to the required input for these models. Physical and chemical theories have the potential to show how the system modeled should evolve through time and across space. Furthermore, in a number of applications there are a variety of types of data of varying quality which could, in principle, be used to constrain models if an objective approach to evaluating and integrating these data with the models were available.

However, rarely are a complete set of input data and dynamic theories available to the modeler. As a first example of this incompleteness, consider models used by the petroleum industry. Interest in the remote detection of fractures in tight geologic reservoirs has grown as new discoveries of oil and natural gas from conventional reservoirs have declined. The trend in remote detection is to invert seismic data. The problem is that such an inversion may not be possible in principle because a variety of fluid/rock states (grain size, shape, and packing for all minerals; fracture network statistics; and porosity, wetting, saturation, and composition of each fluid phase) yield the same log or seismic response. For example, in an azimuthally anisotropic medium, the principal directions of azimuthal anisotropy are the directions along which the compressional and shear waves propagate. If anisotropy is due solely to fractures, anisotropy data can be used to study dominant fracture orientations. However, observed rose diagrams show that in most cases a fracture network consists of many intersecting fracture orientations. Geochemical data (pore fluid composition, fluid inclusion analyses, and vitrinite reflectance) are often ambiguous indicators of geological history due to variations in pore-fluid composition and temperature during basin evolution. Furthermore, the interpretation of well log and geochemical data is labor-intensive. Therefore, the maximum benefits of these data are often not realized.

A complete exploration and production (E&P) model characterizing a fractured reservoir requires a large number of descriptive variables (fracture density, length, aperture, orientation, and connectivity). However, remote detection techniques are currently limited to the prediction of a small number of variables. Some techniques use amplitude variation with offsets to predict fracture orientations. Others delineate zones of large Poisson's ratio contrasts which correspond to high fracture densities. Neural networks have been used to predict fracture density. Porosity distribution may be predicted through the inversion of multicomponent, three-dimensional (3-D) seismic data. These predictive techniques are currently at best limited to a few fracture network properties. Most importantly, these results only hold if the medium is simpler than a typical reservoir. For example, they may work if there is one fracture orientation and no inherent anisotropy due to sediment lamination or other inhomogeneity and anisotropy.

Difficulties with remote fracture detection come from the many factors affecting mechanical wave speed and attenuation including:

porosity and texture of unfractured rock;

density and phases of pore- and fracture-filling fluids;

fracture length and aperture statistics and connectivity;

fracture orientation relative to the propagation direction;

fracture cement infilling volume, mineralogy, and texture;

pressure and temperature; and

grain size and shape distribution.

These variables cannot be extracted from the speed and attenuation of reflected or transmitted seismic waves, even when the various polarizations and shear vs. compression components are separately monitored. Thus, direct remote detection cannot provide enough information to unambiguously identify and characterize fracture sweetspots.

The petroleum industry requires information about the producibility of fracture networks: cement infilling; geometry, connectivity, density, and preferred orientation as well as parameters for dual porosity/dual permeability reservoir models; stress and reservoir sensitivity to pressure drawdown; petroleum content of the matrix; and fractures. While desirable for optimal exploration and petroleum field development, this level of detailed characterization is far beyond available remote detection methodologies.

Models of geological basins or reservoirs require a host of input parameters and have incomplete physical theories underlying them. Data are usually fraught with errors and are sparse in space and time. What is needed is a procedure that can combine the data and models in order to overcome the shortcomings in both and which can be used to make quantitative predictions of resource location and characteristics and to estimate uncertainties in these predictions.

Living cells are a second domain where modelers work with incomplete data sets and incomplete dynamic theories. The complexity of the bio-chemical, bioelectric, and mechanical processes underlying cell behavior makes the design of drugs and treatment strategies extremely difficult. Furthermore, the cell must be understood as a totality. For example, a cell model should be able to predict whether the activity of a chemical agent targeted to a given cell process could be thwarted by the existence of an alternative biochemical pathway or could lead to unwanted changes to other necessary processes. While many individual cellular processes are well understood, the coupling among these processes should be accounted for in order to understand the full dynamics of the cell. As the laws yielding the evolution of a cellular system are nonlinear in the descriptive variables (concentrations, numbers of macromolecules of various types, electric potential), a host of nonlinear phenomena (e.g., multiple steady states, periodic or chaotic temporal evolution and self-organization) are findamental characteristics of cell behavior and therefore a comprehensive, fully coupled process model should be used to capture them.

In geologic, biologic, and other modeling, what is needed is a way to merge multiple types of input data sets into a model and to use comprehensive (multiple process) dynamic theories to evolve the model all the while resolving gaps in, and discrepancies among, the data sets and the theories.

### SUMMARY OF THE INVENTION

The above problems and shortcomings, and others, are addressed by the present invention, which can be understood by referring to the specification, drawings, and claims. The present invention models multi-dimensional domains based on multiple, possibly incomplete and mutually incompatible, input data sets. The invention then uses multiple, possibly incomplete and mutually incompatible, theories to evolve the models through time and across space. Information theory resolves gaps and conflicts in and among the data sets and theories, thus constraining the ensemble of possible processes and data values. Furthermore, as the information theory approach is based on probability theory, the approach allows for the assessment of uncertainty in the predictions.

One embodiment of the invention is a 3-D geologic basin simulator that integrates seismic inversion techniques with other data to predict fracture location and characteristics. The 3-D finite-element basin reaction, transport, mechanical simulator includes a rock rheology that integrates continuous poroelastic/viscoplastic, pressure solutions deformation with brittle deformation (fracturing, failure). Mechanical processes are used to coevolve deformation with multi-phase flow, petroleum generation, mineral reactions, and heat transfer to predict the location and producibility of fracture sweet spots. Information theory uses the geologic basin simulator predictions to integrate well log, surface, and core data with the otherwise incomplete seismic data. The geologic simulator delineates the effects of regional tectonics, petroleum-derived overpressure, and salt tectonics and constructs maps of high-grading zones of fracture producibility.

In a second embodiment, the invention models a living cell. The cell simulator uses a DNA nucleotide sequence as input. Through chemical kinetic rate laws of transcription and translation polymerization, the cell simulator computes mRNA and protein populations as they evolve autonomously, in response to changes in the surroundings, or from injected viruses or chemical factors. Rules relating amino acid sequence and function and the chemical kinetics of post-translational protein modification enable the cell simulator to capture a cell's autonomous behavior. A full suite of biochemical processes (including glycolysis, the citric acid cycle, amino acid and nucleotide synthesis) are accounted for with chemical kinetic laws. Features, such as the prokaryotic nucleoid and eukaryotic nucleus, are treated with a novel mesoscopic reaction-transport theory that captures atomic scale details and corrections to thermodynamics due to the large concentration gradients involved. Metabolic reactions and DNA/RNA/protein synthesis take place in appropriate compartments, while the cell simulator accounts for active and passive molecular exchange among compartments.

### RIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a schematic flow chart of the Simulation-Enhanced Fracture Detection data modeling/integration approach to geologic basins;

FIG. 2 is a table of the “laboratory” basins for use in reaction, transport, mechanical (RTM) model testing;

FIG. 3 shows the complex network of coupled processes that underlie the dynamics of a sedimentary basin;

FIG. 4a depicts the fluid pressuring, fracturing, and fracture healing feedback cycle;

FIG. 4b shows the predicted evolution of overpressure at the bottom of the Ellenburger Formation;

FIG. 5 shows predicted cross-sections of permeability from a simulation of the Piceance Basin in Colorado;

FIGS. 6a and 6b show how simulations produced by Basin RTM agree with observations from the Piceance Basin;

FIG. 6a shows present-day fluid pressure and least compressive stress;

FIG. 6b shows that, in sandstones, lateral stress and fluid pressures are found to be similar, indicating their vulnerability to fracturing;

FIG. 6c predicts natural gas saturation;

FIG. 7 shows predicted rose diagrams for the Piceance Basin;

FIGS. 8a and 8b are simulations of the Piceance Basin;

FIG. 8a shows an isosurface of overpressure (15 bars) toned with depth;

FIG. 8b shows that the distribution of fracture length reflects lithologic variation and the topography imposed by the basement tectonics;

FIGS. 9a and 9b show Basin RTM's predictions of fault-generated fractures and their relation to the creation of fracture-mediated compartments and flow;

FIG. 10 is a simulated time sequence of oil saturation overlying a rising salt dome;

FIG. 11 is a simulation of subsalt oil;

FIG. 12 is a simulated quarter section of a salt diapir;

FIG. 13 is a flow chart showing how the interplay of geologic data and RTM process modules evolve a basin over each computational time interval;

FIG. 14 shows a prediction of Andector Field fractures;

FIG. 15 is a table of input data available for the Illinois Basin;

FIG. 16 shows a simulation of the Illinois Basin; data from the Illinois Basin have been used to simulate permeability (shown) and other important reservoir parameters;

FIG. 17 shows the 3-D stratigraphy of the Illinois Basin;

FIG. 18 is a map of the Texas Gulf coastal plain showing locations of the producing Austin Chalk trend and Giddings and Pearsall Fields;

FIG. 19 is a map of producing and explored wells along the Austin Chalk trend;

FIG. 20 is a generalized cross-section through the East Texas Basin;

FIG. 21a is a cross-section of the Anadarko Basin showing major formations and a basin-scale compartment surrounded by a lithology-crossing top seal, fault, and the Woodford Shale;

FIGS. 21b, 21c, and 21d are 3-D views of the Anadarko Basin;

FIG. 21b shows locations of high quality pressure data;

FIG. 21c shows an isosurface of 10 bars overpressure;

FIG. 21d shows an isosurface of 7 bars underpressure;

FIG. 22 is a tectonic map of the Anadarko Basin showing major structures;

FIG. 23 shows a Basin RTM simulation of Piceance Basin overpressure, dissolved gas concentration, and gas saturation;

FIG. 24 lists references to theoretical and experimental relations between log tool response and fluid/rock state;

FIGS. 25a and 25b are Basin RTM-simulated sonic log and error graphs used to identify basement heat flux;

FIG. 26 shows a Basin RTM simulation of lignin structural changes at the multi-well experiment site, Piceance Basin;

FIGS. 27a, 27b, and 27c show a zone of high permeability and reservoir risk determined using information theory;

FIGS. 28a and 28b show an information theory-predicted high permeability zone using fluid pressure data and a reservoir simulator as well as minimal core data;

FIGS. 29a and 29b list available Anadarko Basin data;

FIG. 30 is the Hunton Formation topography automatically constructed from interpreted well data;

FIG. 31 is a time-lapse crosswell seismic result from Section 36 of the Vacuum Field;

FIG. 32a shows a cross-section of a tortuous path showing various transport phenomena;

FIG. 32b shows a flow-blocking bubble or globule inhibiting the flow of a non-wetting phase;

FIG. 33 presents preliminary results of a phase geometry dynamics model showing fronts of evolving saturation and wetting;

FIG. 34 compares two synthetic seismic signals created from Basin RTM-predicted data with two different assumed geothermal gradients;

FIG. 35 shows the result of using seismic data to determine basin evolution parameters;

FIGS. 36a, 36b, and 36c show that a reservoir reconstruction model requires information theory to reduce the features of a reservoir consistent with that implied by the upscaling in the reservoir simulator used or the resolution of the available data;

FIGS. 37a and 37b illustrate a cross-section of an upper and lower reservoir separated by a seal with a puncture;

FIG. 38 is a map of the major onshore basins of the contiguous United States;

FIGS. 39a, 39b, and 39c are schematic views of cases wherein a reservoir is segmented or contains anomalously high permeability (Super-K);

FIG. 40 is a flow chart showing how a reservoir simulator or a complex of basin and reservoir simulators is used to integrate, interpret, and analyze a package of seismic, well log, production history, and other data; when information theory is integrated with the optimal search, the procedure also yields an estimate of uncertainty;

FIG. 41 portrays a Simulator Complex showing basin and reservoir simulator relationships;

FIGS. 42a, 42b, 42c, and 42d show a permeability distribution constructed by information theory and reservoir simulator technology;

FIGS. 43a, 43b, and 43c show information theory/reservoir simulator-predicted initial data from transient production history of a number of wells;

FIGS. 44a and 44b are maps of a demonstration site in the Permian Basin in New Mexico;

FIG. 44a shows waterflood units;

FIG. 44b is a stratigraphic cross-section;

FIG. 45 is a graph showing that the probability of variations of a wave vector k becomes independent of k as k approaches infinity;

FIG. 46 is a data flow diagram showing how the Cyber-Cell simulator uses DNA nucleotide sequence data in a feedback loop;

FIG. 47 shows some of the cellular features that Cyber-Cell models;

FIGS. 48a and 48b suggest that Cyber-Cell can handle non-linear phenomena;

FIG. 48a is a graph of oscillations in Saccharomyces cerevisiae through time;

FIG. 48b shows that nonlinear rate laws allow a cell to transition from a normal state to an abnormal one;

FIGS. 49a, 49b, and 49c show the pathogen Trypanosoma brucei (responsible for sleeping sickness in humans) on which Cyber-Cell has been tested;

FIG. 49a shows the “long and slender” form of the pathogen;

FIG. 49b shows the pathogen in its “sturnpy” form;

FIG. 49c is a graph of predicted concentrations of species within the glycosome as a function of time;

FIG. 50 is a table comparing measured steady state concentrations and the values predicted by Cyber-Cell as shown in FIG. 49c;

FIGS. 51a and 51b illustrate kinetics studies of the T7 family of DNA-dependent RNA polymerases;

FIG. 51a graphs Cyber-Cell's predictions;

FIG. 51b displays measured data;

FIG. 52 shows Cyber-Cell's simulation of the transcription of the HIV-1 Philadelphia strain;

FIGS. 53a and 53b portray the inner workings of the Cyber-Cell simulator as imbedded in an information theory algorithm;

FIG. 53a summarizes the data that Cyber-Cell can integrate;

FIG. 53b shows an exemplary flow chart of the Cyber-Cell/information theory process;

FIG. 54 shows complex polymerization chemical kinetics models used in the Cyber-Cell simulator;

FIGS. 55a and 55b portray the morphology of mesoscopic objects;

FIG. 55a shows an interior medium surrounded by a bounding surface;

FIG. 55b shows the effect of molecular shape on the curvature of the bounding surface;

FIGS. 56a and 56b are graphs of the effects of noise in experimental data;

FIG. 56a graphs the results for 0.3% noise without regularization;

FIG. 56b graphs the results for 2% and 3% noise with regularization; and

FIG. 57 is a graph of the uncertainty calculated by the Cyber-Cell simulator.

### DETAILED DESCRIPTION OF THE INVENTION

Turning to the drawings, the invention is illustrated as being implemented in a suitable environment. The following description is based on embodiments of the invention and should not be taken as limiting the invention with regard to alternative embodiments that are not explicitly described herein. A first embodiment, a geologic basin simulator, is described in Sections I through VIII. Sections IX through XI describe a second embodiment of the invention, a simulator of living cells.

### I. Technical Overview of Simulation-Enhanced Fracture Detection

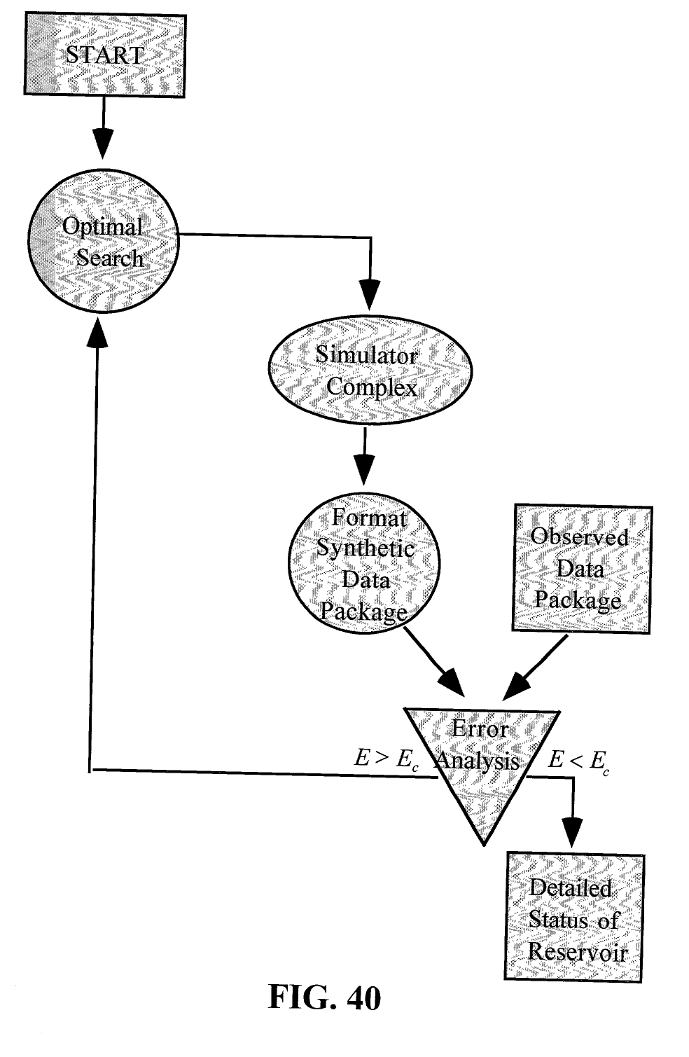

An embodiment of the present invention enhances seismic methods by using a 3-D reaction, transport, mechanical (RTM) model called Basin RTM. Remote observations provide a constraint on the modeling and, when the RTM modeling predictions are consistent with observed values, the richness of the RTM predictions provides detailed data needed to identify and characterize fracture sweetspots (reservoirs). This simulation-enhanced fracture detection (SEFD) scheme is depicted in FIG. 40. The Figure indicates the relation between the input “raw” data and the exploration and production (E&P) output data. Circles indicate processing software, and boxes are input and output information. The SEFD module compares the predicted and observed values of seismic, geological, and other parameters and terminates the iteration when the difference (E) is below an acceptable lower limit (E_{c}). SEFD makes the integration of remote measurement and other observations with modeling both efficient and “seamless.”

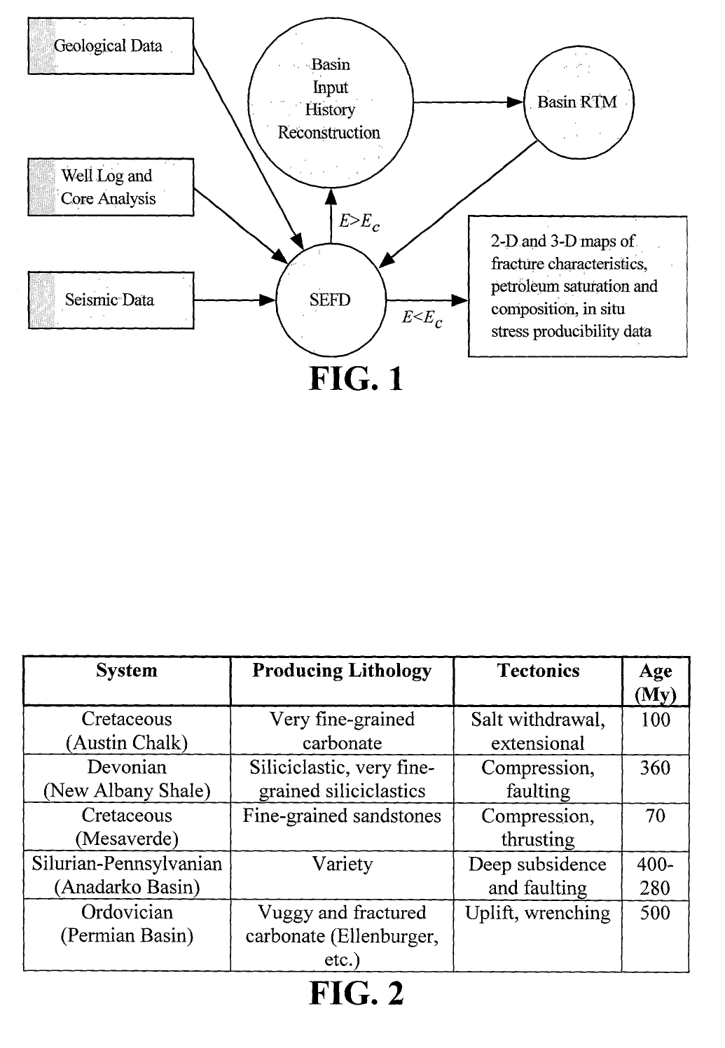

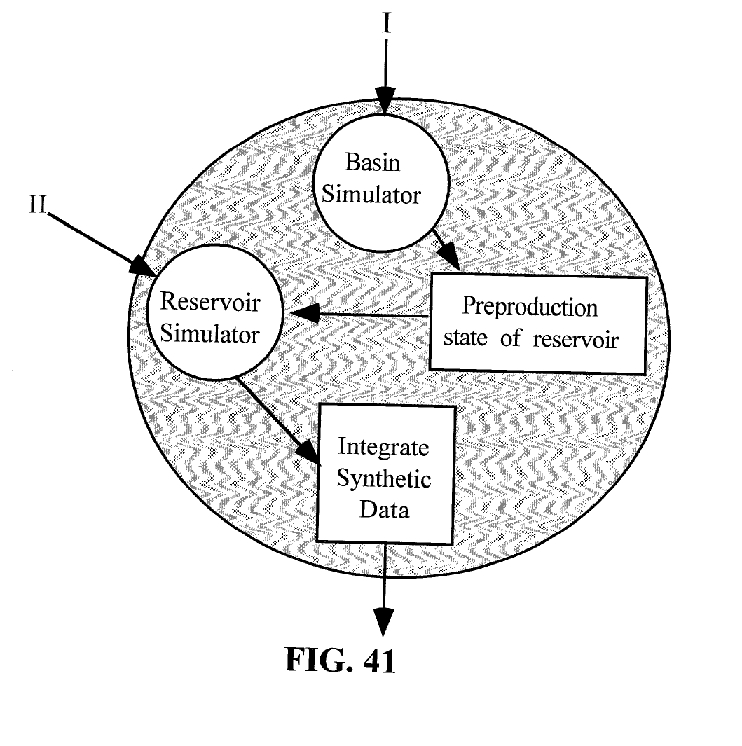

The SEFD algorithm has options for using raw or interpreted seismic data. The output of a 3-D basin simulator, Basin RTM, lithologic information, and other data are used as input to a synthetic seismic program. The latter's predicted seismic signal, when compared with the raw data, is used as the error measure E as shown in FIG. 40. Similarly, well logs and other raw or interpreted data shown in FIG. 1 can be used. The error is minimized by varying the least well constrained basin parameters. This error minimization scheme is embedded in information theory approaches to derive estimates of uncertainty. The basin simulation scheme of FIG. 40 can be integrated with, or replaced by, one involving a reservoir simulator as suggested in FIGS. 40 and 41.

The SEFD method integrates seismic data with other E&P data (e.g., well logs, geochemical analysis, core characterization, structural studies, and thermal data). Integration of the data is attained using the laws of physics and chemistry underlying the basin model used in the SEFD procedure:

conservation of momentum for fluid and solid phases;

conservation of mass for fluid and solid phases; and

conservation of energy.

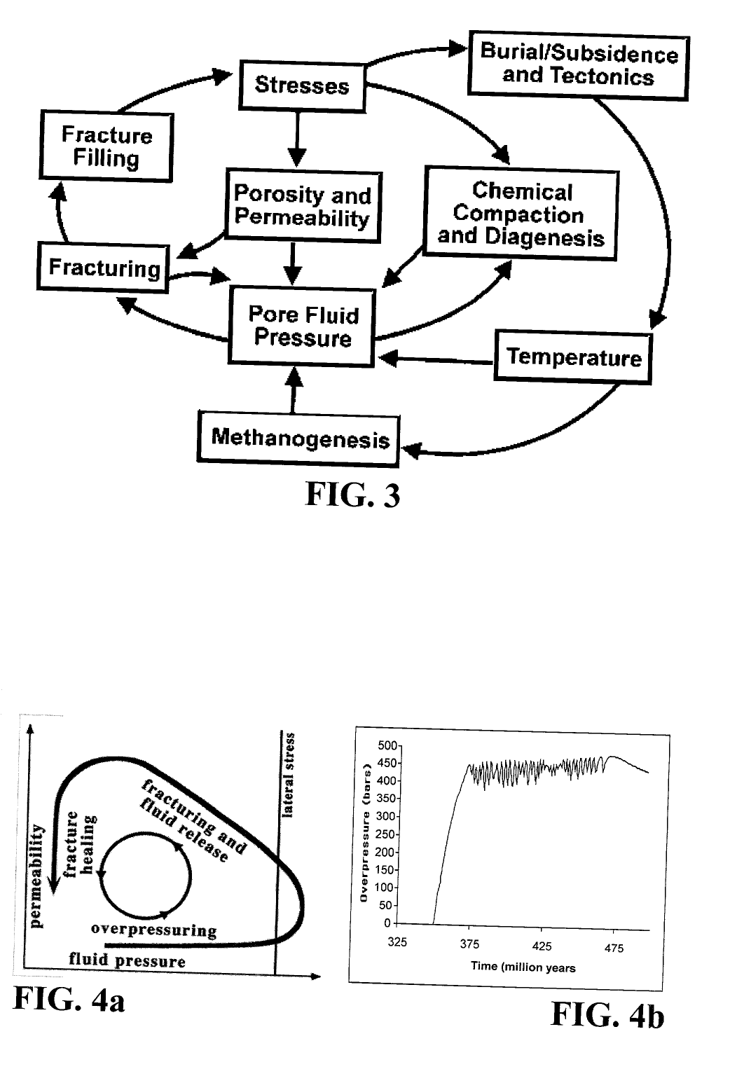

(See FIG. 3.) These laws facilitate extrapolation away from the surface and wellbore and are made consistent with seismic data to arrive at the SEFD approach shown in FIGS. 1, 40, and 41.

The Basin RTM model is calibrated by comparing its predictions with observed data from chosen sites. Calibration sites meet these criteria: richness of the data set and diversity of tectonic setting and lithologies (mineralogy, grain size, matrix porosity). FIG. 2 lists several sites for which extensive data sets have been gathered. Data include the complete suite of formation depths, age, and lithologic character as well as analysis of thermal, tectonic, and sea level history.

Basin RTM attains seismic invertibility by its use of many key fracture prediction features not found in other basin models:

nonlinear poroelasticity/viscosity rheology integrated with pressure solution, fracture strain rates, and yield behavior for faulting;

a full 3-D fracture network statistical dynamics model;

rheologic and multi-phase parameters that coevolve with diagenesis, compaction, and fracturing;

new multi-phase flow and kerogen reactions producing petroleum and affecting overpressure;

tensorial permeability from preferred fracture orientation and consequent directed flows;

inorganic fluid and mineral reactions and organic reactions; and

heat transfer.

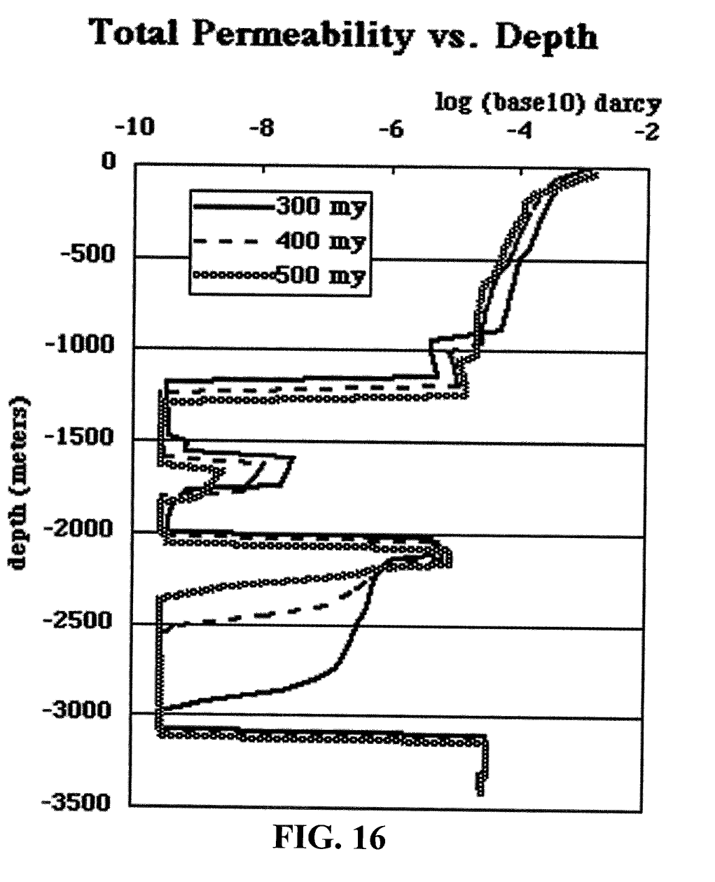

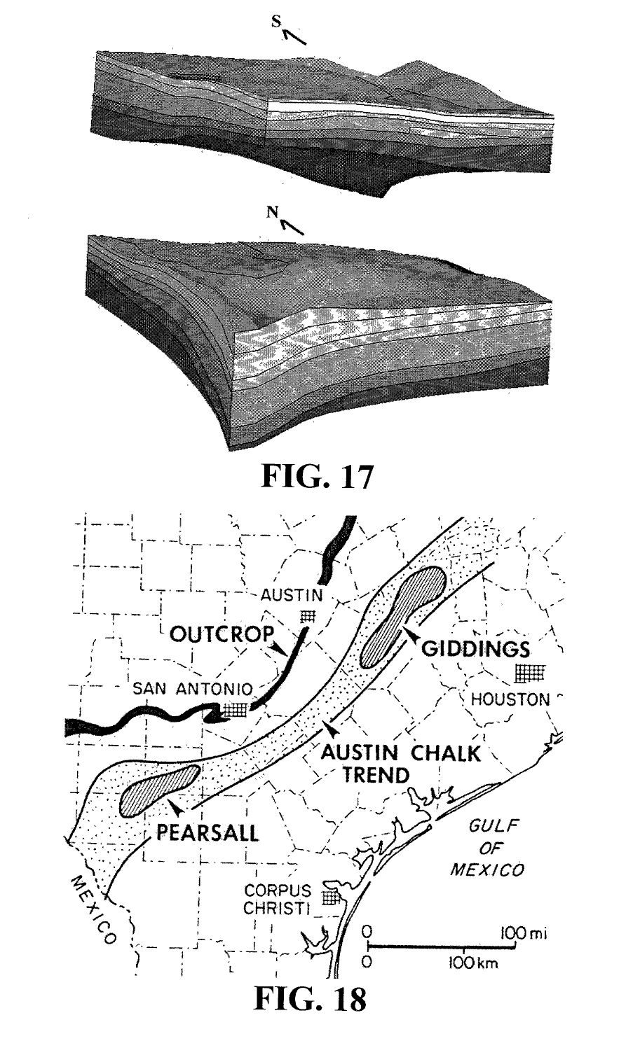

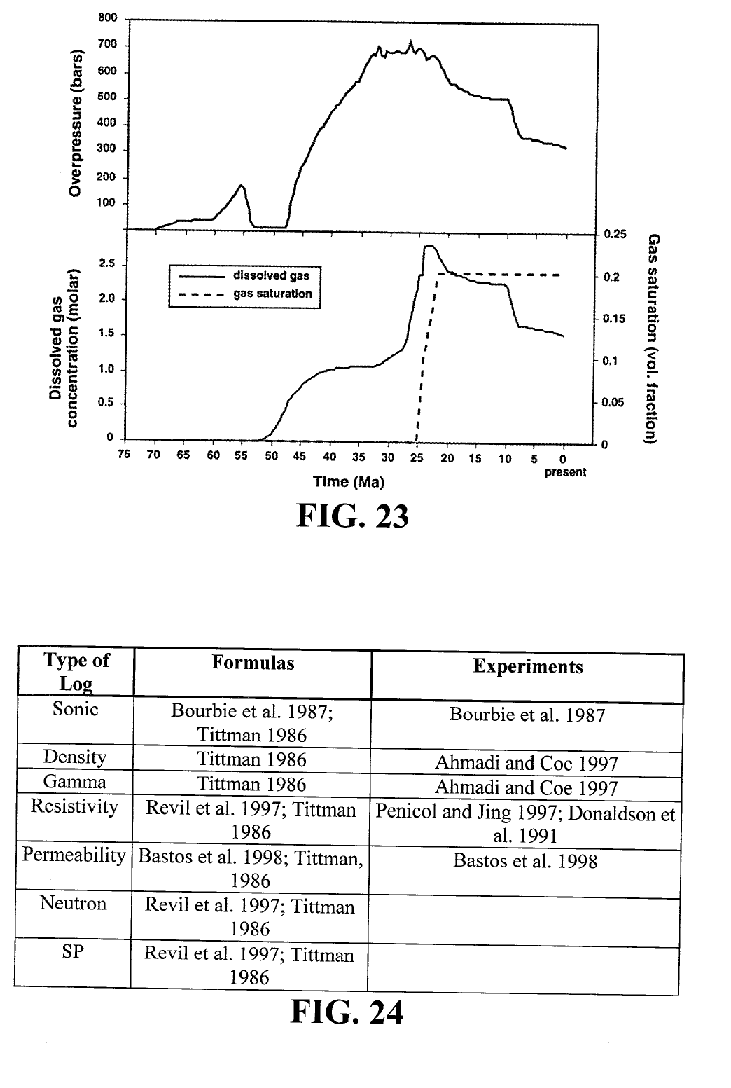

(See FIG. 3.) While previous models have some of these processes, none have all, and none are implemented using full 3-D, finite-element methods. Basin RTM preserves most couplings between the processes shown in FIG. 3. The coupling of these processes in nature implies that to model any one of them requires simulating all of them simultaneously. As fracturing couples to many RTM processes, previous models with only a few such factors cannot yield reliable fracture predictions. In contrast, the predictive power of Basin RTM, illustrated in FIGS. 4 through 12, 14, 16 through 18, 23, and 33, and discussed further below, surmounts these limitations.

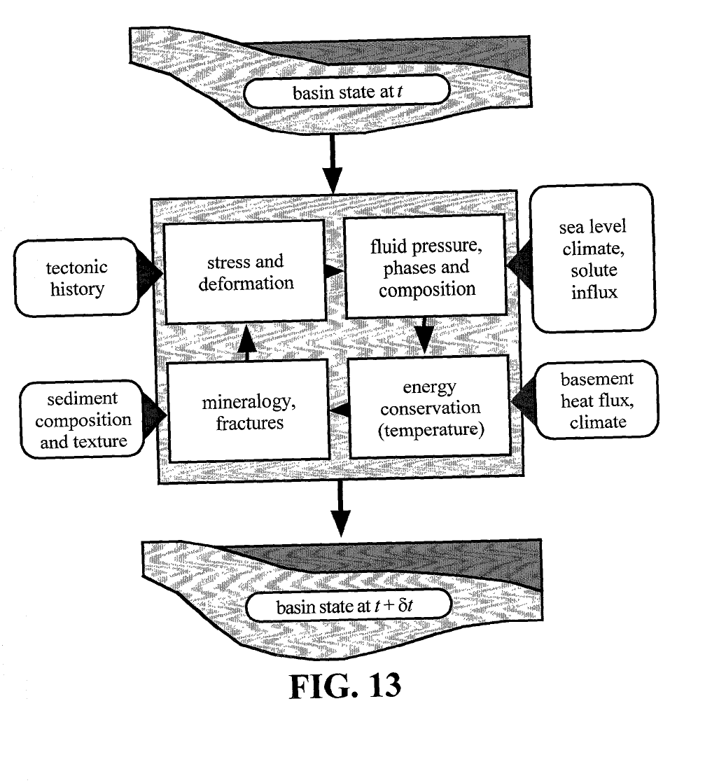

Commonly observed “paradoxes” include fractures without flexure and flexure without fractures. These paradoxes illustrate the inadequacy of previous fracture detection techniques based on statistical correlations. For example, previous models base porosity history on a formula relating porosity to mineralogy and depth of burial. However, porosity evolves due to the detailed stress, fluid composition and pressure, and thermal histories of a given volume element of rock. These histories are different for every basin. Thus, in the real world, there is no simple correlation of porosity with depth and lithologic type. As shown in FIG. 3, aspects of geological systems involve a multiplicity of factors controlling their evolution. Some processes are memory-preserving and some are memory-destroying. Therefore, there are no simple correlations among today's state variables. The detailed history of processes that operated millions of years ago determines today's fracture systems. Basin RTM avoids these problems by solving the fully coupled rock deformation, fluid and mineral reactions, fluid transport, and temperature problems (FIGS. 3 and 13). Basin RTM derives its predictive power from its basis in the physical and chemical laws that govern the behavior of geological materials.

### II. Details of an Exemplary Embodiment of the Geologic Basin Simulator

The variables predicted by the Basin RTM simulator throughout the space and during the time of a basin simulation include:

pressure, composition, and saturation of each pore fluid phase;

temperature and stress;

size, shape, and packing of the grains of all minerals;

fracture network (orientation, aperture, length, and connectivity) statistics; and

porosity, permeability, relative permeabilities, and capillary pressures.

This data can be used directly or through transformation (e.g., synthetic seismic signals, well logs) to provide a measure of agreements with observations as needed for information theory integration of data and modeling. To make these predictions, however, the Basin RTM simulator needs information on phenomenological parameters and basin history parameters (sedimentary, basement heat flux, overall tectonic, and other histories) which themselves are often poorly constrained.

The basin model:

includes formulas relating fluid/rock state to well logging tool response;

includes a chemical kinetic model for type-II kerogen and oil cracking that simulates deep gas generation, models the relation between vitrinite reflectance and the kerogen composition, and integrates the above with the 3-D multi-phase, miscible fluid flow model;

implements the measured data/Basin RTM integration technology as shown in FIG. 1; and

expands and formats a basin database for use as in FIG. 1 and uses graphics modules to probe the data.

A complex network of geochemical reactions, fluid and energy transport, and rock mechanical processes underlies the genesis, dynamics, and characteristics of petroleum reservoirs in Basin RTM (FIGS. 3 and 13). Because prediction of reservoir location and producibility lies beyond the capabilities of simple approaches as noted above, Basin RTM integrates relevant geological factors and RTM processes (FIG. 13) in order to predict fracture location and characteristics. As reservoirs are fundamentally 3-D in nature, Basin RTM is fully 3-D.

The RTM processes and geological factors used by Basin RTM are described in FIGS. 3 and 13. External influences such as sediment input, sea level, temperature, and tectonic effects influence the internal RTM processes. Within the basin, these processes modify the sediment chemically and mechanically to arrive at petroleum reserves, basin compartments, and other internal features.

Basin RTM predicts reservoir producibility by estimating fracture network characteristics and effects on permeability due to diagenetic reactions or gouge. These considerations are made in a self-consistent way through a set of multi-phase, organic and inorganic, reaction-transport and mechanics modules. Calculations of these effects preserve cross-couplings between processes (FIGS. 3 and 13). For example, temperature is affected by transport, which is affected by the changes of porosity that changes due to temperature-dependent reaction rates. Basin RTM accounts for the coupling relations among the full set of RTM processes shown in FIG. 3.

Key elements of the dynamic petroleum system include a full suite of deformation mechanisms. These processes are strongly affected by basin stress history. Thus, good estimates of the evolution of stress distributions are necessary in predicting these reservoir characteristics. As fracturing occurs when fluid pressure exceeds least compressive stress by tensile rock strength, estimates of the time of fracture creation, growth, healing or closure, and orientation rely on estimates of the stress tensor distribution and its history. Simple estimates of least compressive stress are not sufficient for accurate predictions of fracturing. For example, least compressive stress can vary greatly between adjacent lithologies-a notable example being sandstones versus shales. (See FIGS. 3, 5, 7 through 12, and 14). In Basin RTM, stress evolution is tightly coupled to other effects. Fracture permeability can affect fluid pressure through the escape of fluids from overpressured zones, in turn, fluid pressure strongly affects stress in porous media. For these reasons, the estimation of the distribution and history of stress should be carried out within a basin model that accounts for the coupling among deformation and other processes as shown in FIG. 3.

A rock Theological model based on incremental stress theory is incorporated into Basin RTM. This formalism has been extended to include fracture and pressure solution strain rates with elastic and nonlinear viscous/plastic mechanical rock response. This rheology, combined with force balance conditions, yields the evolution of basin deformation. The Basin RTM stress solver employs a moving, finite-element discretization and efficient, parallelized solvers. The incremental stress rheology used is \dot{ε}=\dot{ε}^{el}+\dot{ε}ⁱⁿ+\dot{ε}^{ps}+\dot{ε}^{fr}. Here \dot{ε} is the net rate of strain while the terms on the right hand side give the specific dependence of the contributions from poroelasticity (el), continuous inelastic mechanical (in), pressure solution (ps), and fracturing (fr). The boundary conditions implemented in the Basin RTM stress module allow for a prescribed tectonic history at the bottom and sides of the basin.

The interplay of overpressuring, methanogenesis, mechanical compaction, and fracturing is illustrated in FIG. 4a. In FIG. 4b, a source rock in the Ellenburger Formation of the Permian Basin (West Texas) is seen to undergo cyclic oil expulsion associated with fracturing.

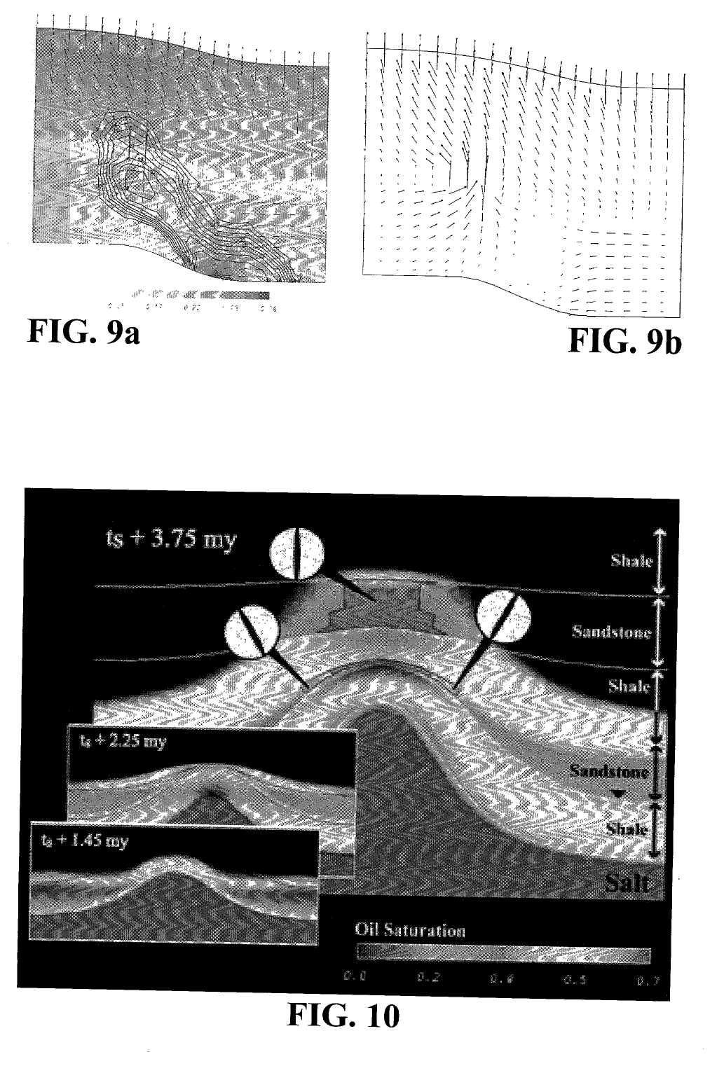

In FIGS. 9a and 9b, the results of Basin RTM show fault-generated fractures and their relation to the creation of fracture-mediated compartments and flow. In FIG. 9a, the shading indicates porosity and shows differences between the four lithologies; the shales (low porosity) are at the middle and top of the domain. Higher porosity regions (in the lower-right and upper-left comers) and the fracture length (contour lines) arose due to the deformation created by differential subsidence. The arrows indicate fluid flow toward the region of increasing porosity (lower-right) and through the most extensively fractured shale. FIG. 9b shows the predicted direction and magnitude of fluid flow velocity. This system shows the interplay of stress, fracturing, and hydrology with overall tectonism-features which give Basin RTM its power.

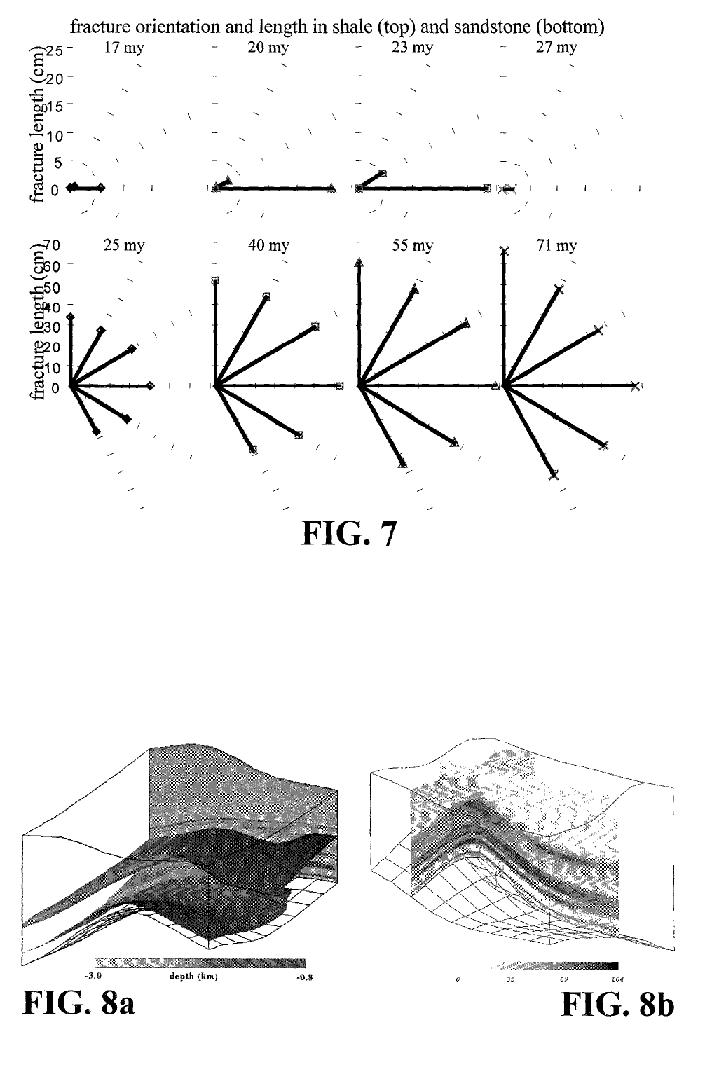

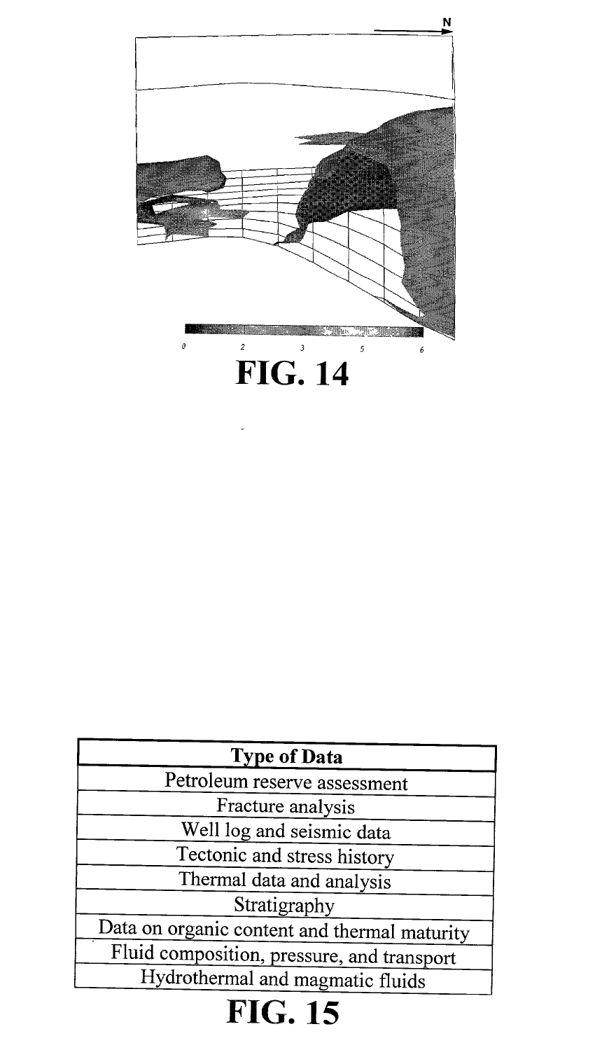

A key to reservoirs is the statistics of the fracture network. Basin RTM incorporates a unique model of the probability for fracture length, aperture, and orientation. The model predicts the evolution in time of this probability in response to the changing stress, fluid pressure, and rock properties as the basin changes. (See FIGS. 7 and 14). The fracture probability formulation then is used to compute the anisotropic permeability tensor. The latter affects the direction of petroleum migration, information key to finding new resources. It also is central to planning infill drilling spacing, likely directions for field extension, the design of horizontal wells, and the optimum rate of production.

FIG. 14 shows a Basin RTM simulation for the Andector Field (Permian Basin, West Texas).

The fracture network is dynamic and strongly lithologically controlled. FIG. 7 shows predicted fracture orientations and lengths for macrovolume elements in shale (top) and sandstone (bottom) at four times over the history of the Piceance Basin study area. Changing sediment properties, stress, and fluid pressure during the evolution of the basin result in the dynamic fracture patterns. Understanding such occurrences of the past, therefore, can be important for identifying or understanding reservoirs in presently unlikely structural and stratigraphic locations. The fractures in a shale are more directional and shorter-lived; those in the sandstone appear in all orientations with almost equal length and persist over longer periods of geological time.

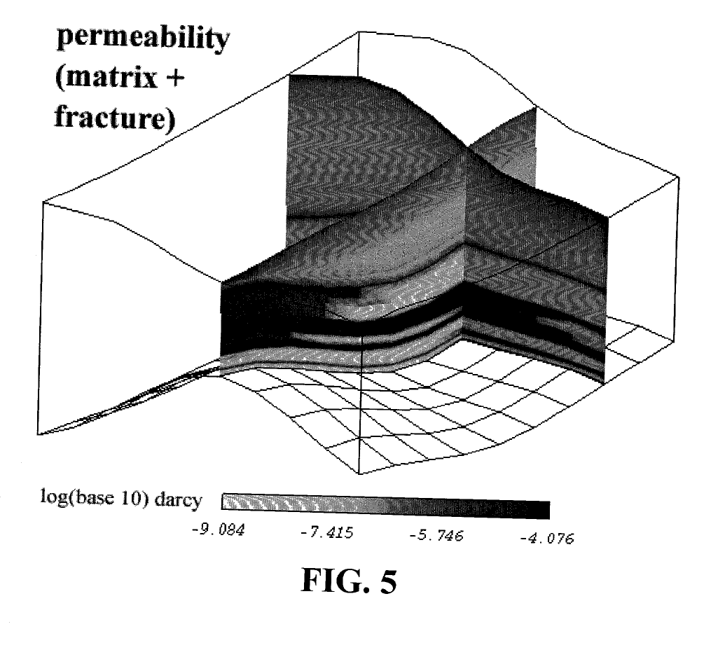

The 3-D character of the fractures in this system is illustrated in FIGS. 5, 8a, and 8b. In FIG. 8a, the folded, multi-layered structure is dictated by the interplay of lithological differences and fracturing and shows the 3-D complexity of the connectivity of over-pressured zones. Thus, using a simple pressure-depth curve to model stacked over-pressured compartments may yield little insight into the full three-dimensionality of the structure.

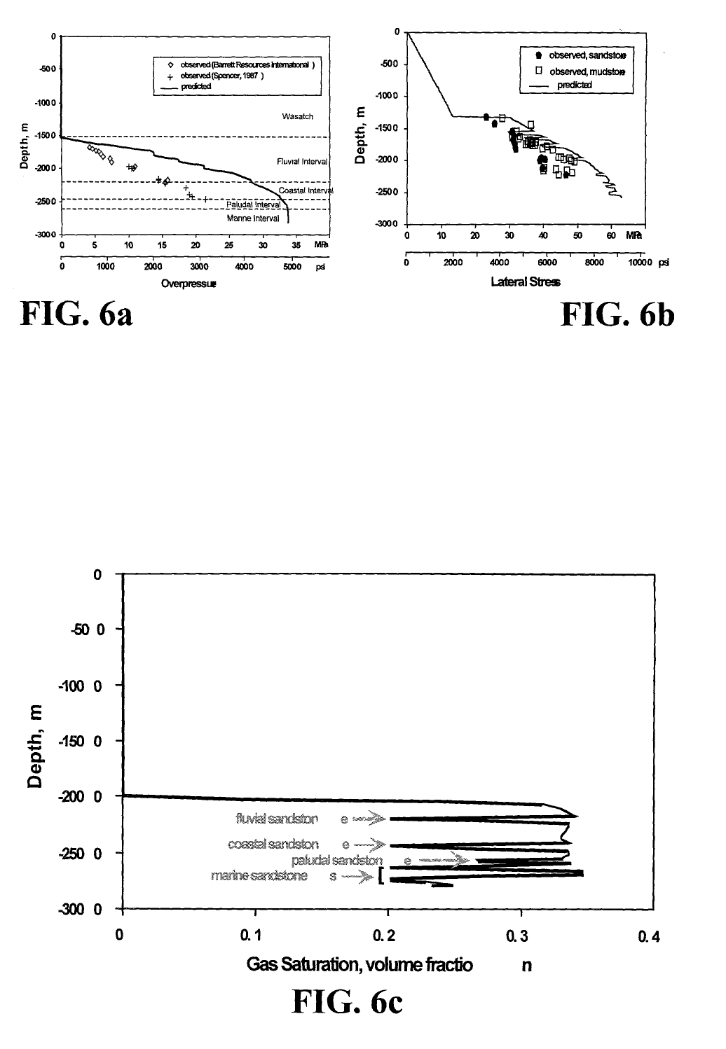

Modules in Basin RTM compute the effects of a given class of processes (FIGS. 3 and 13). The sedimentation/erosion history recreation module takes data at user-selected well sites for the age and present-day depth, thickness, and lithology and creates the history of sedimentation or erosion rate and texture (grain size, shape, and mineralogy) over the basin history. The multi-phase and kerogen decomposition modules add the important component of petroleum generation, expulsion, and migration (FIGS. 6a, 6b, 6c, 10, and 11). Pressure solution modules calculate grain growth/dissolution at free faces and grain-grain contacts. The evolution of temperature is determined from the energy balance. Physico-chemical modules are based on full 3-D, finite-element implementation. As with the stress/deformation module, each Basin RTM process and geological data analysis module is fully coupled to the other modules (FIGS. 3 and 13).

The continuous aspects of the Basin RTM rheology for chalk and shale lithologies are calibrated using published rock mechanical data and well studied cases wherein the rate of overall flexure or compression/extension have been documented along with rock texture and mineralogy. Basin RTM incorporates calibrated formulas for the irreversible, continuous, and poroelastic strain rate parameters and failure criteria for chalk and shale needed for incremental stress rheology and the prediction of the stresses needed for fracture and fault prediction.

The texture model incorporates a relationship between rock competency and grain-grain contact area and integrates the rock competency model with the Markov gouge model and the fracture network statistics model to arrive at a complete predictive model of faulting.

Basin RTM's 3-D grid adaptation scheme (1) is adaptive so that contacts between lithologic units or zones of extreme textural change are captured; and (2) preserves all lithologic contacts.

In the information theory approach of FIGS. 1, 40, and 41, Basin RTM is optimized whereby parameters that are key to the predictions, yet are less well known, are computed by (1) generating a least-square or other error (that represents the difference between the actual data and that predicted by Basin RTM and seismic recreation programs), and (2) minimizing the error and also imposing physical constraints on the time and length scales on which tectonic and other parameters can change.

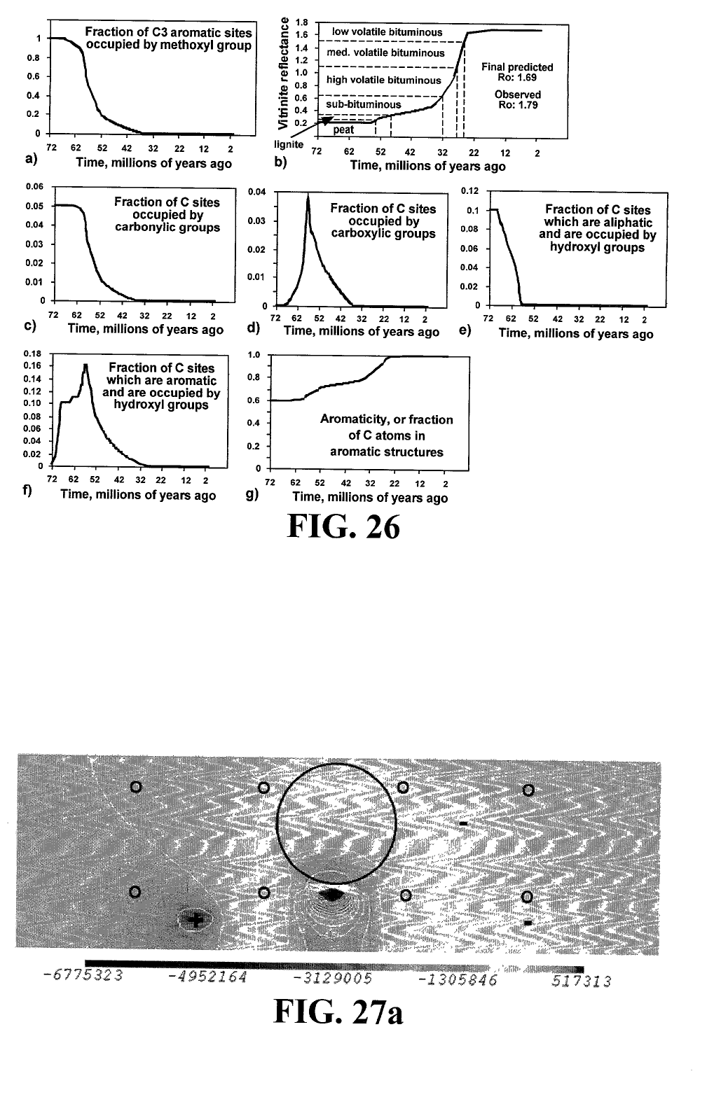

A chemical kinetic model of natural gas generation from coal is used to model the deep gas generation. The new kinetic model for gas generation is based on the structure of lignin, the predominant precursor molecule of coal. Structural transformations of lignin observed in naturally matured samples are used to create a network of eleven reactions involving twenty-six species. The kinetic model representing this reaction network uses multi-phase reaction-transport equations with n^{th} order processes and rate laws. For the immobile species, i.e., those bound with the kerogen, the rate equations take the form

$$\frac{D {C}_{i}}{Dt} = {\sum }_{α} {v}_{iα } {k}_{α}^{eff} {\prod }_{{i}^{′} , {v}_{{i}^{′} α} > 0} {C}_{{i}^{′}}^{{v}_{iα}} \qquad ( 1 )$$

where Cᵢ is moles of immobile kerogen species i per kerogen volume and k_{α}^{eff} is an effective rate coefficient for reaction α that consumes one or more reactant molecules (ν_{αi}<0) and generates product molecules (νᵢₐ>0). The model assumes that the kerogen reactions are irreversible. (See FIG. 26.)

To predict petroleum composition and to take full advantage of the vitrinite and fluid inclusion data, the model uses a chemical kinetic model of kerogen and petroleum reaction kinetics. It includes over twenty species in a model of kerogen or oil to thermal breakdown products based on a chemical speciation/bond breaking approach similar to that developed for lignin kinetics. The model uses a hydrocarbon molecular structure/dynamics code to guide the macroscopic kinetic modeling.

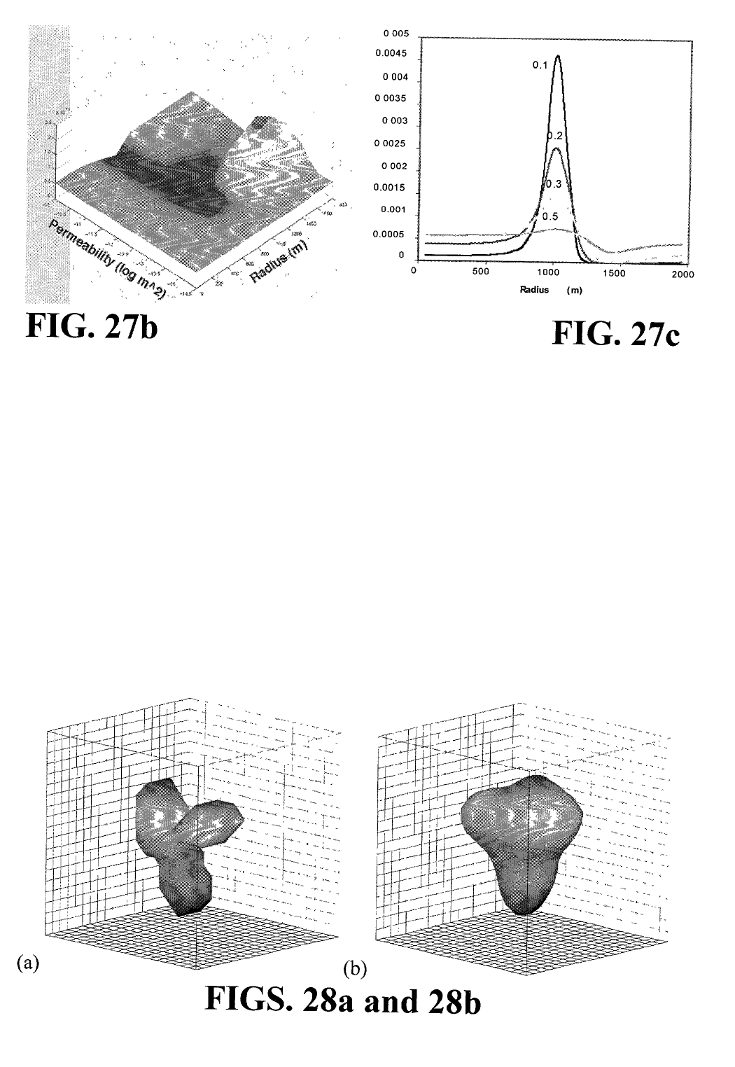

The model also incorporates a risk assessment approach based on information theory. The method differs from others in geostatistics in that it integrates with basin simulation as follows. Information theory provides a method to objectively estimate the probability ρ of a given set A (=A₁, A₂, . . . , A_{N}) of N parameters which are the most uncertain in the analysis. For the present example, these include basement heat flux, overall tectonics, sedimentation/erosion history, etc. The entropy S is then introduced via S=−∫d^{N} Aρlnρ which is found to be an objective measure of uncertainty. The information theory approach is then to maximize S constrained by the information known, the result being an expression for the A-dependence of ρ. An example of probability function p for the radius of the enhanced permeability zone in FIG. 27a is shown in FIG. 27c. Note that as the tolerable error is decreased, the function approaches the Dirac delta function located at r=1000 meters which is the actual radius of the enhanced permeability zone. With such an approach, the model computes the expected location and state of a reservoir and provides quantitative measures of the uncertainties in this prediction.

In this approach, the results of a Basin RTM simulation or of a reservoir simulation yields a set of M predicted variables Ω(=Ω₁, Ω₂, . . . , Ω_{M}). These include porosity, permeability, and mineralogy, geochemical and thermal data, and fracture statistics from which the model calculates synthetic seismic well log and geochemical data. These predictions depend on A via the Basin RTM or reservoir simulator. Setting the average of the Ω to observed values O₁, O₂, . . . , O_{M} of these quantities yields constraints on p. Then maximizing S subject to these constraints (observations) yields ρ(A). With ρ(A), the model provides not only a prediction of the most likely values of the N As, but also of the variance in the As. Thereby, the model computes the variance in predicted reservoir characteristics. Through the integration of this approach with data/modeling technology, the model provides the risk analysis the industry needs to assess the economics of a given study area.

The key is that the relation Ωᵢ(A) can only be obtained through simulations. To surmount the need for using an exceedingly great amount of computer time for each simulation, the model carries out selective simulations and then fits the Ωᵢ(A) to an analytic function by least square or other fitting. Next, the model finds the value of A minimizing the error and then refines the computation in the vicinity of the first approximate value minimizing the error.

Risk assessment is a key aspect of the data/modeling integration strategy There are uncertainties in the geological data needed for input to Basin RTM (notably overall tectonic, sedimentary, and basement heat or mass flux). This leads to uncertainties in data/modeling integration predictions. The model addresses this key issue with a novel information theory approach that automatically embeds risk assessment into data/modeling integration as an additional outerlooping in the flow chart of FIG. 1.

Geostatistical methods are extensively used to construct the state of a reservoir. Traditional geostatistical methods utilize static data from core characterizations, well logs, seismic, or similar types of information. However, because the relation between production and monitoring well data (and other type of dynamic data) and reservoir state variables is quite complicated, traditional geostatistical approaches fail to integrate dynamic and static data. Two significant methods have been developed to integrate the dynamic flow of information from production and monitoring wells and the static data. The goal of both methods is to minimize an “objective function” that is constructed to be a measure of the error between observations and predictions. The multiple data sets are taken into consideration by introducing weighting factors for each data set. The first method (sequential self-calibration) defines a number of master points (which is less than the number of grid points on which the state of the reservoir is to be computed). Then a reservoir simulation is performed for an initial guess of the reservoir state variables that is obtained by the use of traditional geostatistical methods. The nonlinear equations resulting from the minimization of the objective function requires the calculation of derivatives (sensitivity coefficients) with respect to the reservoir state variables. The approximate derivatives are efficiently obtained by assuming that stream lines do not change because of the assumed small perturbations in the reservoir state variables. In summary, the sequential self-calibration method first upscales the reservoir using a multiple grid-type method and then uses stream line simulators to efficiently calculate the sensitivity coefficients. A difficulty in this procedure is that convergence to an acceptable answer is typically not monatomic (and is thereby slow and convergence is difficult to assess). The second method (gradual deformation) expresses the reservoir state as a weighted linear sum of the reservoir state at the previous iteration and two new independent states. The three weighting factors are determined by minimizing the objective function. The procedure is iterated using a Monte Carlo approach to generate new states. The great advance of the present approach over these methods is that (1) it directly solves a functional differential equation for the most probable reservoir state and (2) has a greatly accelerated numerical approach that makes realistic computations feasible.

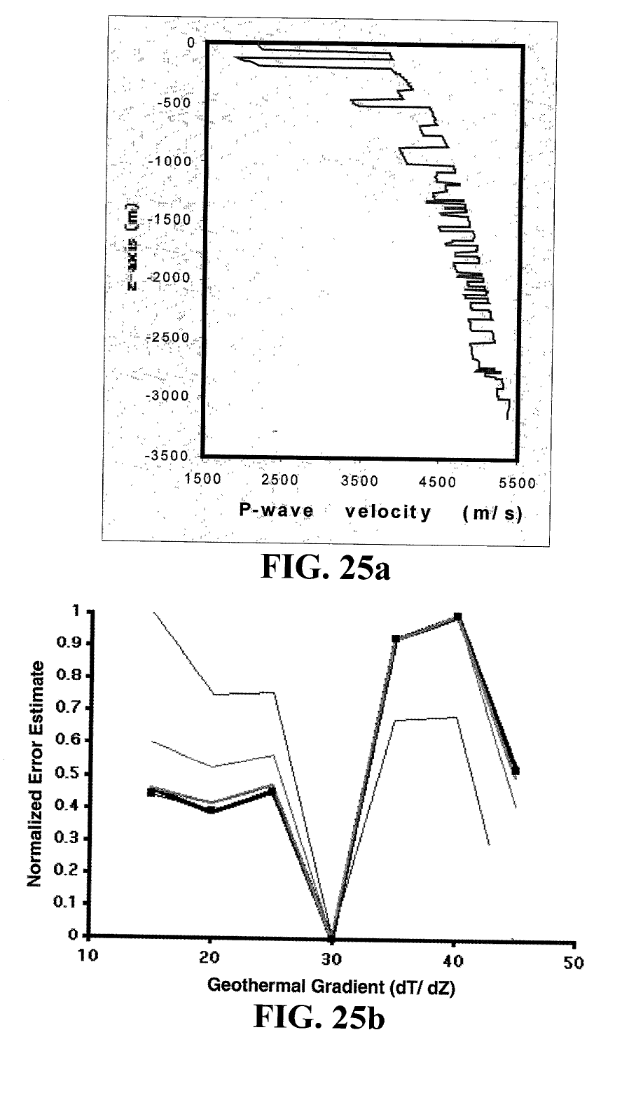

To use well logs in the data/modeling scheme of FIG. 1, the model generalizes formulas from the literature (FIG. 24) relating log tool response to fluid/rock state. A synthetic sonic log for the Piceance Basin of Colorado is shown in FIG. 25a. This log was computed using Basin RTM-predictions of the size, shape, and packing of the grains of all minerals, porosity, pore fluid composition, and phase (state of wetting), and fracture network statistics. The variation in the p-wave velocity is a combined result of density variation and mineral composition, as well as fracture network properties.

III. Geologic Data Types and Availability

Geological input data are divided into four categories (FIG. 13). The tectonic data gives the change in the lateral extent and the shape of the basement-sediment interface during a computational advancement time δt. Input includes the direction and magnitude of extension/compression and how these parameters change through time. These data provide the conditions at the basin boundaries needed to calculate the change in the spatial distribution of stress and rock deformation within the basin. This calculation is carried out in the stress module of Basin RTM.

The next category of geological input data directly affects fluid transport, pressure, and composition. This includes sea level, basin recharge conditions, and the composition of fluids injected from the ocean, meteoric, and basement sources. Input includes the chemical composition of depositional fluids (e.g., sea, river, and lake water). This history of boundary input data is used by the hydrologic and chemical modules to calculate the evolution of the spatial distribution of fluid pressure, composition, and phases within the basin. These calculations are based on single- or multi-phase flow in a porous medium and on fluid phase molecular species conservation of mass. The physico-chemical equations draw on internal data banks for permeability-rock texture relations, relative permeability formulae, chemical reaction rate laws, and reaction and phase equilibrium thermodynamics.

The spatial distribution of heat flux imposed at the bottom of the basin is another input to Basin RTM. This includes either basin heat flow data or thermal gradient data that specify the historical temperature at certain depths. This and climate/ocean bottom temperature data are used to evolve the spatial distribution of temperature within the basin using the equations of energy conservation and formulas and data on mineral thermal properties.

Lithologic input includes a list and the relative percentages of minerals, median grain size, and content of organic matter for each formation. Sedimentation rates are computed from the geologic ages of the formation tops and decomposition relations.

The above-described geological input data and physico-chemical calculations are integrated in Basin RTM over many time steps δt to arrive at a prediction of the history and present-day internal state of the basin or field. Basin RTM's output is rich in key parameters needed for choosing an E&P strategy: the statistics of fracture length, orientation, aperture, and connectivity, in situ stress, temperature, the pressure and composition of aqueous and petroleum phases, and the grain sizes, porosity, mineralogy, and other matrix textural variables.

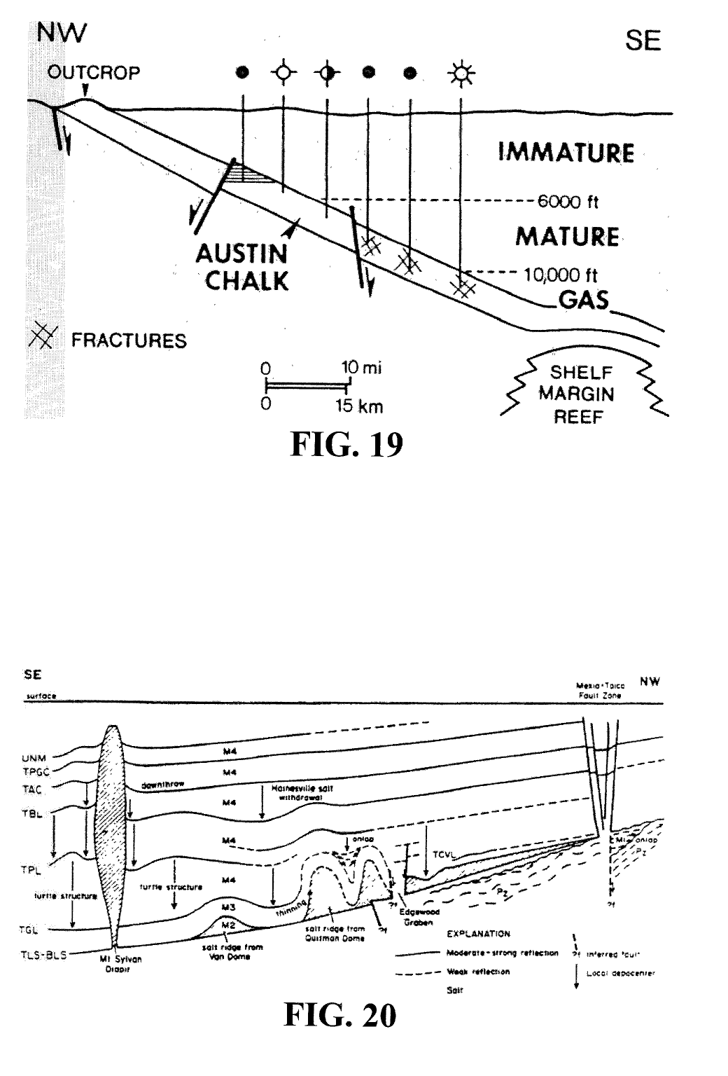

For many basins worldwide, the petroleum industry has large stores of data. A large portion of these data, often acquired at great expense, has not been adequately used. The basin model provides a revolutionary approach that automatically synthesizes these data for E&P analysis, notably the special challenges of deep petroleum and compartmented or fractured regimes. The typical information available includes seismic, well log, fluid inclusion, pore fluid composition and pressure, temperature, vitrinite reflectance, and core characterizations. (See FIGS. 1, 2, 15, 19 through 21, 29b, and 31). Examples of data and locations in U.S. basins are seen in FIGS. 15 through 21.

The use of these data presents several challenges:

the need to extrapolate away from the well or down from the surface;

omnipresent noise or other measurement error;

the time-consuming nature of the manual interpretation of this data; and

the lack of an unambiguous prediction of reservoir location and characteristics from these data.

In the latter context, well logs or seismic data, for example, cannot be used to unambiguously specify the local fluid/rock state (shape, packing and mineralogy, grain size, porosity, pore fluid composition, and fracture network statistics). In the present approach, the uniqueness of the fluid/rock state to seismic/well log response relationship is exploited (similarly for the geochemical data). This avoids the ambiguity in the inverse relationship, seismic/well log data to fluid/rock state, on which log or seismic interpretation is based in other approaches.

The pathway to achieving this goal is via comprehensive basin modeling and information theory. The basin model is a three-dimensional model that uses finite-element simulations to solve equations of fluid and mineral reactions, mass and energy transport, and rock mechanics to predict the fluid/rock state variables needed to compute seismic, well log, and other data. The difference between the basin model-predicted well log and geochemical data and the actual observed data provides a method for optimizing both the interpretation of the data and the richness of the reservoir location and characteristics predicted by the 3-D model, Basin RTM. (See FIGS. 1, 40, and 41.) Information theory provides a methodology whereby these data and the modeling can be used to estimate uncertainty/risk in predictions.

The model focuses on well logs, seismic data, fluid pressure, vitrinite reflectance, and fluid inclusions. It includes formulas that yield the synthetic data from the rock/fluid state as predicted by the Basin RTM output variables. The Basin RTM organic kinetics model predicts the many chemical species quantified in the pore fluid composition, fluid inclusion, and vitrinite reflectance data.

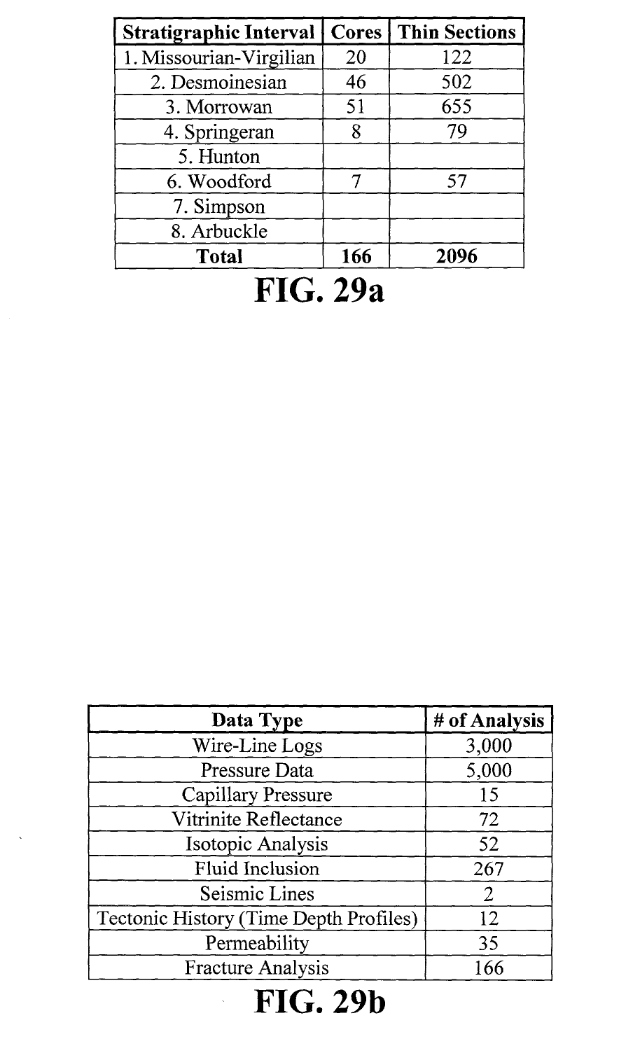

FIGS. 29a and 29b summarize the Anadarko Basin data presently available. Over 25 lithologies have been dated and described texturally and mineralogically. These data are complemented with additional seismic, well log, and other data.

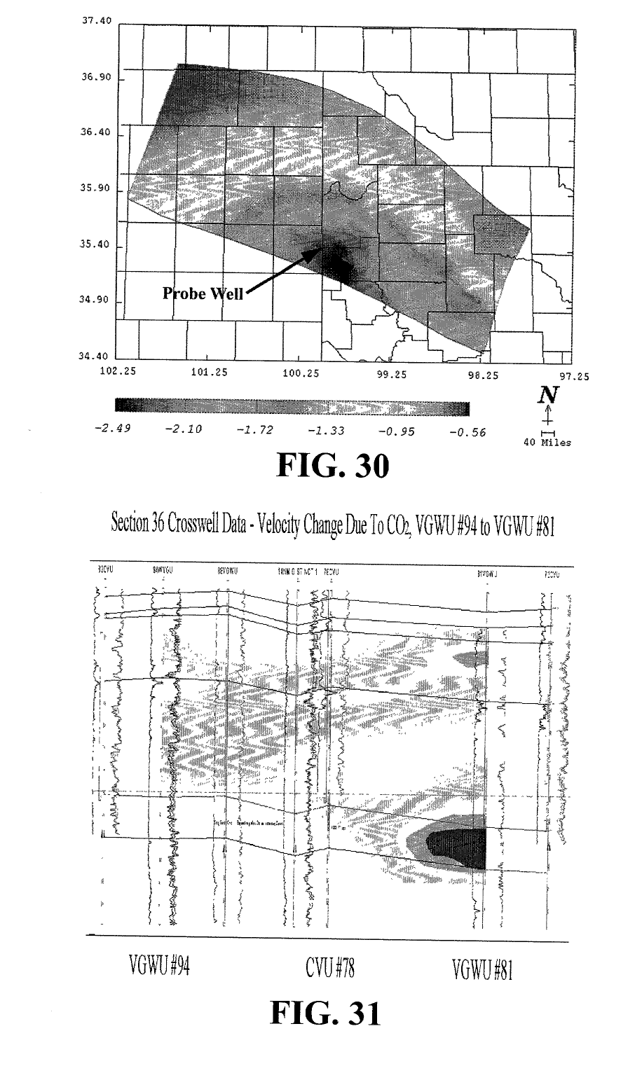

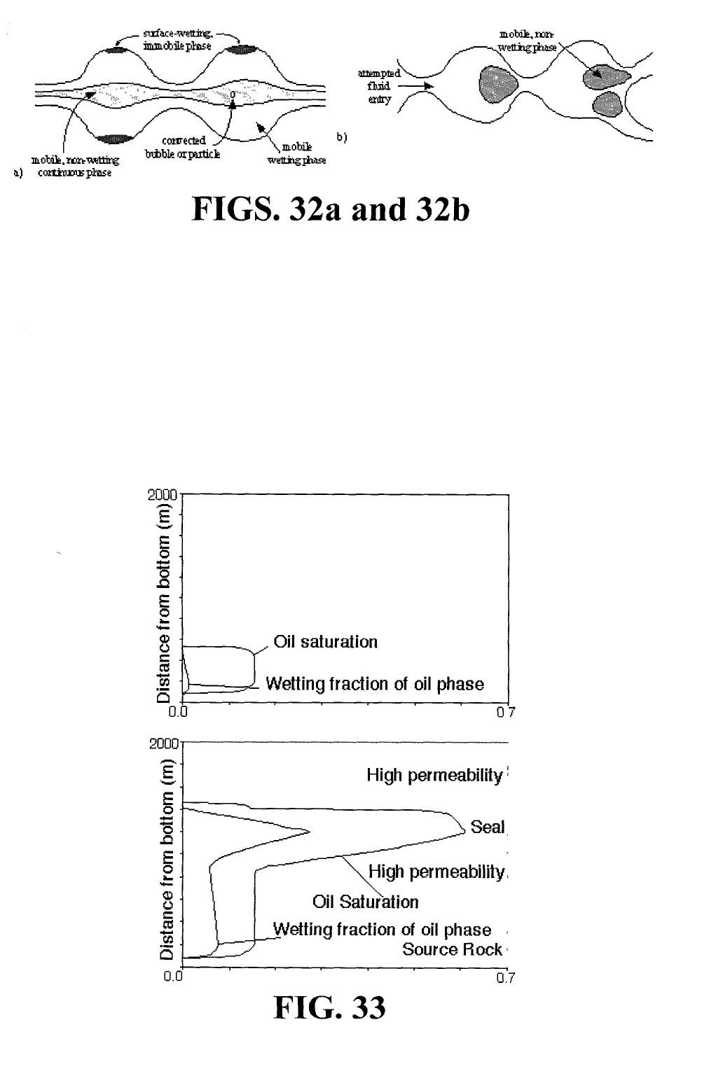

The tools used to browse the database include isosurfaces, cross-sections, and probes along any line. They are in the form of fluid/rock state variables as a function of depth or as synthetic logs for easy comparison with additional data available to the user. The 1-D probe can be placed anywhere in the basin to yield any of a hundred fluid/rock state variables as a function of depth, as suggested in FIG. 30.

Relations between well log response and fluid/rock state have been set forth for a number of logging tools. A brief summary of theoretical formulas or experimental correlations and references is given in FIG. 24. The published and new fluid/rock state to log tool response relations are recast in terms of the specific fluid/rock variables predicted by Basin RTM.

### IV. Salt Tectonic Petroleum Regimes

As salt withdrawal is an important factor in fracturing in some basins, Basin RTM models salt tectonics. (See FIGS. 10 through 12.) Basin RTM addresses the following E&P challenges:

predict the location and geometry of zones of fracturing created by salt motion;

predict the morphology of sedimentary bodies created by salt deformation;

locate pools of petroleum or migration pathways created by salt tectonics; and

assist in the interpretation of seismic data in salt tectonic regimes.

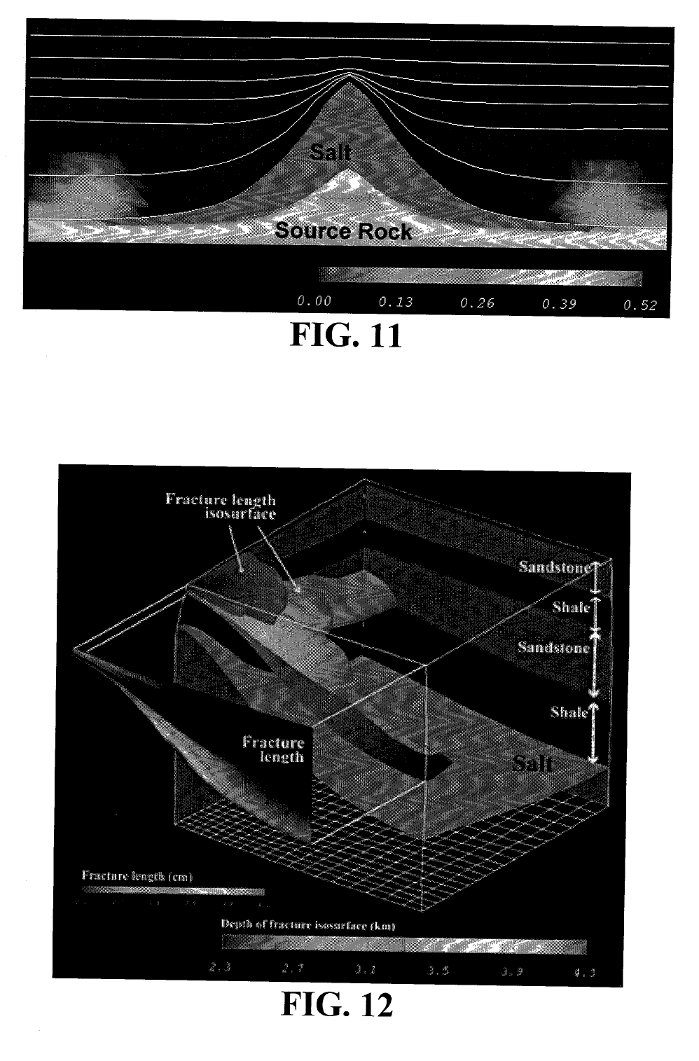

The interplay of salt deformation with the rheology of the surrounding strata is key to understanding the correlation between salt deformation and reservoir location. FIGS. 10 through 12 show simulation results produced by Basin RTM. In FIG. 10, source rock overlying the dome was transiently overpressured and fractured, facilitating upward oil migration within it and into the overlying layers. Orientations of long-lived fractures (residing in the sandstones) illustrate the relationship between the salt motion and fracture pattern. FIG. 11 is similar to FIG. 10 except for an initially finite size (lenticular) salt body. FIG. 11 also adds the co-evolution of subsalt petroleum. It shows the oil saturation with curves indicating lithologic contacts. The overpressure under the salt body and the stress regime on the underlying sediment have preserved porosity in the center region under the salt while the compaction under the edge of the salt led to the formation of a seal. In the quarter section of a salt diaper simulated in FIG. 12, the relationship to fracturing in the overlying sandstones after 3 million years of deformation is shown. It is the integration of these types, of simulations with a suite of geological data through information theory that gives them a greatly enhanced potential for predicting reservoir location and characteristics and associated risks and uncertainties.

### V. Compartmental Petroleum Regimes

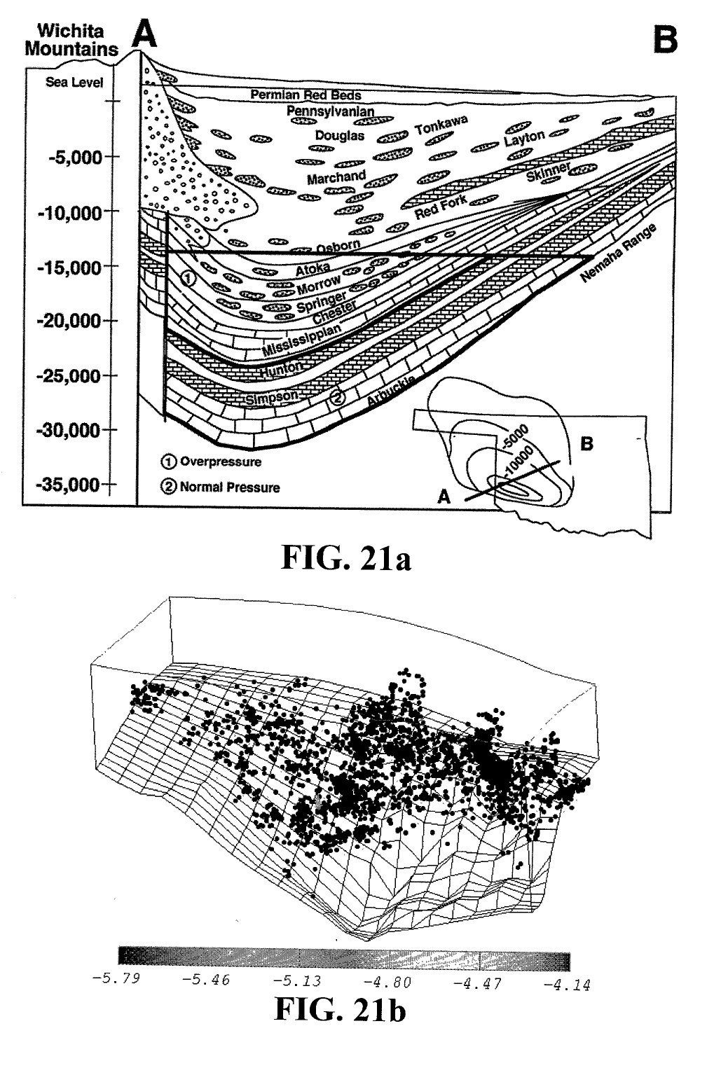

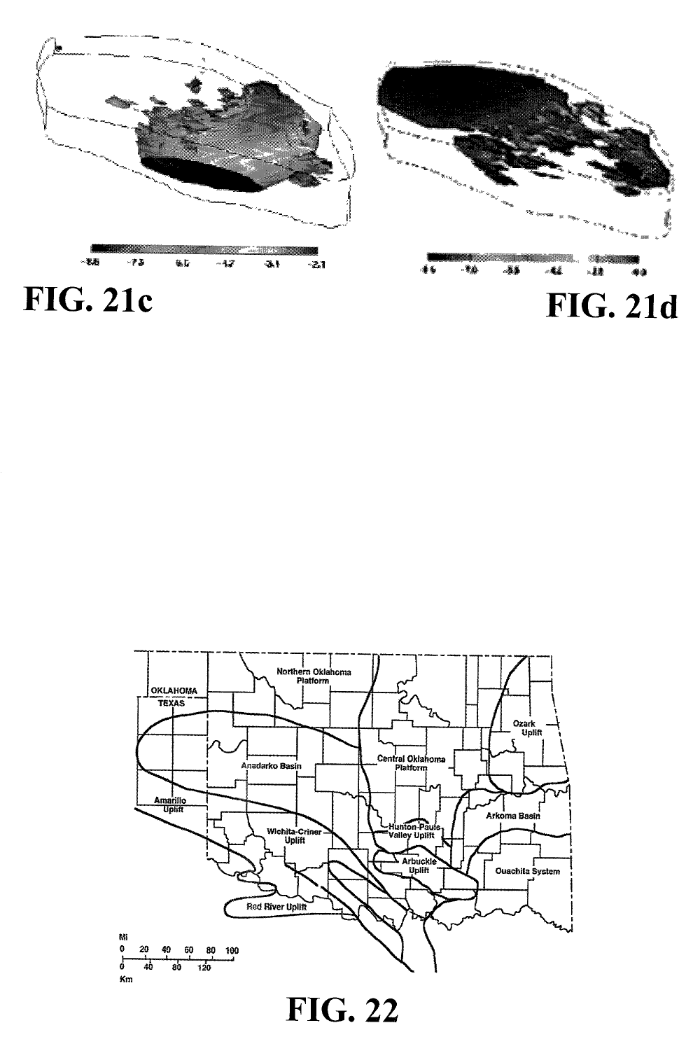

A sedimentary basin is typically divided into a mosaic of compartments whose internal fluid pressures can be over (OP) or under (UP) hydrostatic pressure. An example is the Anadarko Basin as seen in FIGS. 21a, 21b, 21c, 21d, and 22. Compartments are common features worldwide. Compartments are defined as crustal zones isolated in three dimensions by a surrounding seal (rock of extremely low permeability). Identifying them in the subsurface is key to locating by-passed petroleum in mature fields. Extensive interest in these phenomena has been generated because of their role as petroleum reservoirs.

Compartmentation can occur below a certain depth due to the interplay of a number of geological processes (subsidence, sedimentation, and basement heat flux) and physico-chemical processes (diagenesis, compaction, fracturing, petroleum generation, and multi-phase flow). These compartments exist as abnormally pressured rock volumes that exhibit distinctly different pressure regimes in comparison with their immediate surroundings, thus they are most easily recognized on pressure-depth profiles by their departure from the normal hydrostatic gradient. The integration of basin modeling and data through information theory allows one to more accurately predict the location and characteristics of these compartments

Integrated pore-pressure and subsurface geological data indicate the presence of a basinwide, overpressured compartment in the Anadarko Basin. This megacompartment complex (MCC) is hierarchical, i.e., compartments on one spatial scale can be enclosed by compartments on large spatial scales. (See FIG. 21a.) The Anadarko MCC encompasses the Mississippian and Pennsylvanian systems, and it remained isolated through a considerably long period of geological time (early Missourian to present). Compartments within the MCC are isolated from each other by a complex array of seals. Seal rocks often display unique diagenetic banding structures that formed as a result of the mechano-chemical processes of compaction, dissolution, and precipitation.

Data from the Piceance Basin have been used with Basin RTM to evaluate the fluid pressure history of the coastal interval sandstone (Upper Cretaceous Mesaverde Group in the Piceance Basin, northwest Colorado) with gas saturation (pore volume occupied by gas phase generated from underlying source rocks) (FIG. 24). Starting at about 52 Ma, after incipient maturation of the underlying source rock (the paludal interval coal), gas is initially transported into the sandstone dissolved in pore fluids. Aqueous methane concentration increases as more gas is generated from maturing source rocks and as pore fluid migrates upward into the sandstone from compacting and overpressuring source rocks below. Aqueous methane concentration continues to increase until its peak at about 25 Ma. At this time, aqueous methane concentration begins to decrease and the free gas phase forms. The gas phase is exsolving from the aqueous phase because uplift and erosion are decreasing the confining stresses and decreasing the solubility of the gas in the aqueous phase. Aqueous methane continues to decline for the remainder of the simulation, and gas saturation is maintained at about 20%.

Deep gas and by-passed petroleum in compartmented reservoirs (e.g., the Anadarko Basin) likely constitute the most promising natural gas resources for the United States as recent discoveries indicate. The model's current focus on such regimes addresses a number of critical research needs as these systems are still poorly understood from both the exploration and production standpoints. As the novel data/basin modeling interpretation greatly improves the ability to predict the location and characteristics of these reservoirs, the results assist in both improving energy independence and the efficiency with which these regimes are explored.

### VI. Petroleum Reservoirs, CO₂ and Waste Sequestration, and Pollutant Migration

Several aspects of the oil industry may be addressed by the present invention: (a) time-lapse production of oil fields for improved performance; (b) monitoring of enhanced oil-production using injected fluids such as CO₂; (c) reduced greenhouse gas emissions at localized well sites; and (d) reduction in greenhouse gases produced by wide-spread use of petroleum.

The objective of time-lapse production of oil fields is to produce the most oil from a reservoir over its lifetime using the fewest number of wells. Monitoring techniques such as time-lapse 3-D surface seismic and high-resolution crosswell seismology are good indicators of the current state of the reservoir. But these data along with production information need to be incorporated into a physico-chemical modeling approach that will enable reservoir predictions and the implied strategies. Only with the advent of time-lapse monitoring of a reservoir in recent years has this synergy with modeling become feasible.

Enhanced oil recovery by injecting fluids into a reservoir can be a costly prospect resulting in millions of spent dollars. It is important to know where the injected fluid and petroleum migrate to optimize the location of injection and producing wells. Recovery and reuse of the injected fluids and depth are important cost reduction issues.

The technology minimizes losses due to by-passed reserves, formation damage, drilling costs, and excessive water (vs. petroleum) production. Such problems arise in both high and low matrix permeability systems and commonly occur in cases where reservoirs are compartmented or contain zones of super-K (i.e., regions of karst or wide-aperture, connected fractures-leading to anomalously high local permeability). An approach to such systems should be based on a quantified characterization of the reservoir away from the wellbore and down from the surface. The present approach incorporates the following:

production history, well log, seismic, and other data;

estimation of uncertainties and risk in next well citing and production strategy; and

available basin and reservoir simulators.

FDM integrates all the above in one automated procedure that yields a continuously updated forecast and strategy for the future development and production of a field. It achieves this through software that integrates reservoir simulation, data, and information theory.

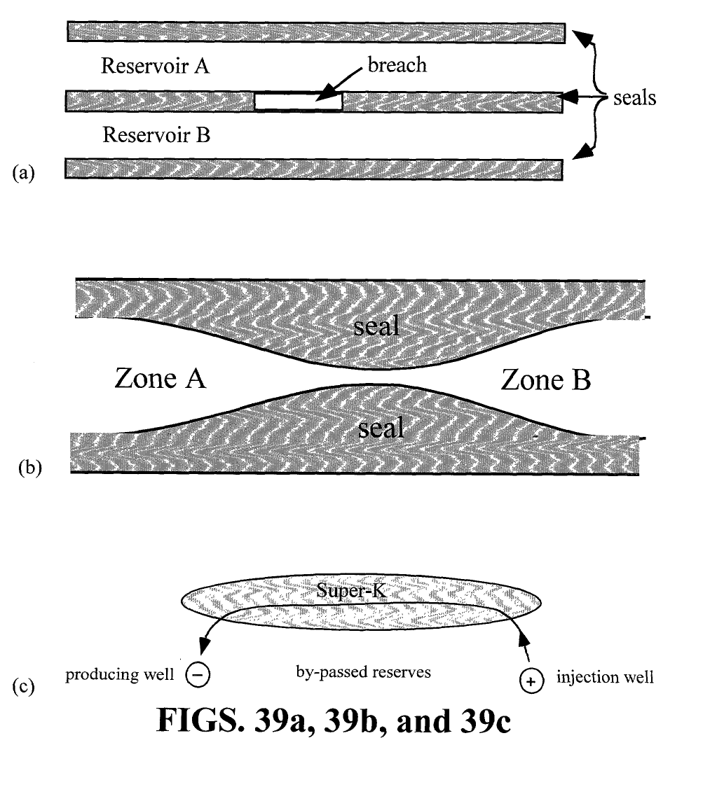

In the cases shown in FIGS. 39a, 39b, and 39c, there are difficulties in placing wells and planning the best production rates from existing wells to minimize by-passed reserves and excessive water cuts. In FIG. 39a, the upper and lower reservoirs are separated by a seal in a poorly defined region. In FIG. 39b, pinchout separates a sandstone reservoir into two poorly connected regimes. In FIG. 39c, a zone of super-K can direct flows around petroleum-saturated matrix and thus lead to by-passing of reserves. The key to making successful decisions is quantifying the geometry of reservoir connectivity or compartmentation. The present approach places quantitative limits on the location, shape, and extent of the zones of super-K or connectivity to other reservoirs or parts of the same, multi-lobed reservoir.

The present approach allows for the following:

A new multi-phase flow law that accounts for the changing wetting and intra-pore geometry (and associated hysteresis) of the fluid phases. This overcomes the weaknesses of other multi-phase models. The flow laws and related reservoir simulator describe CO₂ injection and simultaneous enhanced petroleum recovery with sufficient pore scale detail to calculate the seismic velocity and attenuation needed to interpret tomographic images.

Advanced formulas for the dependence of seismic wave speed and attenuation (as predicted by the new multi-phase flow model) on fluid phase geometry, fractures, and grain size, shape, mineralogy, and packing to achieve enhanced seismic image interpretation. These dependencies are not accounted for in a self-consistent and simultaneous manner in other seismic image interpretation approaches.

By integrating the seismic wave velocity and attenuation formulas with the multi-process reservoir simulator, an automated approach is obtained that is a qualitative improvement in both the interpretation of crosswell tomographic images of the CO₂ plume and other evolving repository features and that improves the accuracy of reservoir simulation. The reservoir model can predict sufficient information to compute the seismic wave velocities and attentions and, thereby, achieve this integration.

The information theory-based approach for estimating the most probable reservoir state and associated risk allows for the automation of the delineation of reservoir size, shape, CO₂ plume characteristics, internal distribution of porosity, and multiphase flow properties, as well as integration of reservoir simulation and crosswell tomographic image interpretation.

A novel numerical algorithm for solving the inverse problem is a major improvement over simulated annealing and other procedures. The technique captures the 3-D complexity of a repository.

The availability of accurate predictive models and of techniques for monitoring the time-course of an injected waste plume are key to the evaluation of a strategy for CO₂ and other fluid waste disposal in geological repositories. The present method addresses both of these requirements using novel modeling and modem seismic imaging methods and integrates them via information theory for predicting and monitoring the time course for original and injected fluids. The technology can be used to optimize the injection process or to assess the economic viability of this disposal approach. The method combines new physical and chemical multi-phase modeling techniques, computational methods, information theory, and seismic data analysis to achieve a completely automated method. As such, the method is of great fundamental interest in delineating the dynamics of the subsurface and of great practical value in a variety of waste disposal and resource recovery applications.

Substantial potential exists for environmentally sound sequestration of CO₂ or other waste fluids in geological formations with high matrix or vuggy porosity/permeability. These include depleted or producing oil and gas reservoirs and brine-filled formations. The widespread geographical distribution of such sites, and the possibility for simultaneous CO₂ sequestration and enhanced petroleum recovery, make this technology of great potential value.

Geological sequestration of CO₂ requires that the CO₂ be transported into the formation, displacing gas or liquid initially present, and trapping CO₂ in the formation for stable, long-term storage. A critical component of a storage strategy is to understand the migration and trapping characteristics of CO₂ and the displaced fluids. This is a multi-phase, porous medium, reaction-transport system. Modeling CO₂ migration and trapping requires a quantitative description of the associated reaction, transport, and mechanical processes from the pore to the field scale. The challenge is made even greater as much of the state of porosity, permeability, and other reservoir characteristics are only known statistically, implying the need for a reliable risk assessment approach.

Crosswell tomography can delineate an image of the CO₂ plume. In FIG. 31, the two darkest gray values represent the largest velocity decrease due to CO₂ of about 1.5 to 2%. The velocity difference becomes smaller for consecutive gray levels from the two darkest gray values while white indicates no velocity difference. However, seismic wave speed and attenuation depend on many reservoir factors that can change during injection (porosity, pore fluid phase and configuration, grain size, shape, mineralogy, and packing and fracture network statistics). Thus an unambiguous delineation of the CO₂ plume, and not other changing reservoir characteristics induced by injection, requires additional information. The present method solves this noninvertability problem by integrating multiple process reservoir simulators with crosswell tomographic image interpretation.

To address these challenges to monitoring and optimizing the geological sequestration of CO₂, the present method:

(1) implements a new multi-phase flow law to account for the evolving pore-scale geometry and wetting of the fluid phases (to overcome the shortcomings of available reservoir simulators);

(2) uses improved seismic velocity/attenuation formulas and implements them into an automated seismic image interpretation algorithm;

(3) uses an information theory method to predict the most probable state and associated uncertainties in the distribution of reservoir characteristics;

(4) integrates the above three with crosswell tomographic imaging of the CO₂ plume; and

(5) is tested in a well studied Vacuum Field.

The subsurface is only partially characterized through well log, seismic, surface, and production histories. What is needed is an objective formulation for integrating all these data into a statistical framework whereby uncertainties in the spatial distribution of fluids, hydrologic properties, and other factors can be estimated and the related uncertainties evaluated. The present method uses a rigorous information theory approach to assess this uncertainty. It obtains the probability for the least well constrained pre-CO₂-injection state of the repository. This allows it to both predict the likely consequence of the injection and to quantify the related risks.

Data on CO₂ injection are gathered to test the integrated seismic imaging and reservoir simulation technologies. Data include well logs, downhole sampling, core analysis, seismic data, and production information. Formulas for the dependence of seismic velocity and attenuation on local reservoir factors are incorporated into the seismic interpretation algorithm. Factors accounted for include fluid phase geometry and wetting, rock texture, and fracture length/aperture/orientation statistics. The multi-phase flow model and reservoir RTM simulator uniquely provide the level of detail on these factors required for reliable seismic image interpretation of both the CO₂ plume and its effects on the repository lithologies and surrounding seals. The seismic formulas, artificial seismic image recreation, and information theory are integrated to yield enhanced interpretation of seismic images (the simulation-enhanced remote geophysics (SERG) technology). This novel approach builds on the simulation-enhanced fracture detection technology shown in FIG. 1 but brings unprecedented speed and accuracy to the invasion problem by directly solving functional differential equations for the most probable state and associated uncertainty.

The crosswell tomography method provides the resolution to image small changes in seismic velocity due to changes in pore fluid saturations such as the miscible CO₂ replacement of brine and oil. Crosswell seismic data acquisition requires that a source be placed in one well while recording seismic energy in another well. Seismic tomographic reconstruction and imaging enables one to define the velocity field and reflection image between the two wells. Typically three or more receiver wells are selected around the source well so that a quasi three-dimensional view of the reservoir is obtained. The first set of observations is generally done before CO₂ injection to obtain a baseline for comparison with later time-lapse repeat observations used to track the progress of the injected CO₂.

High-frequency crosswell seismology can also utilize both compressional and shear waves for delineating the porosity and fracture system between wells. However, time-lapse crosswell studies were made of the San Andres and Grayburg reservoirs in Vacuum Field at constant reservoir pressure. No significant shear-wave velocity variations were noted indicating that changes in effective pore pressure play an important part in the shear-wave response. On the other hand, small changes in compressional-wave velocity and amplitude were correlated to actual CO₂ and verified through drilling. (See FIG. 33.) Hence, crosswell seismic is recommended as the tool of choice for monitoring the flow of CO₂.

Most reservoirs are geometrically complex and have internal compartmentation or super-K zones; many are at stress and fluid pressure conditions that make them vulnerable to pore collapse or fracture closure. This often leads to by-passed petroleum and reservoir damage. The present technology gives quantitative information about the subsurface needed to address these field development and management challenges. The technology is a major advance over presently used history matching or seismic interpretation procedures due to computer automation and advanced algorithms. The present approach yields (1) the most probable state (spatial distribution of permeability, porosity, oil saturation, stress, and fractures across a reservoir), (2) the optimal future production strategy, and (3) associated risks in these predictions. Thus the present approach provides a next-generation field development and management technology. The present approach is demonstrated in a Permian Basin field; the associated reservoirs are complex, ample data are available, and traditional history matching has not proven to be an adequate field management technology.

The capability to integrate all or some of the data noted above gives the present approach a great advantage over presently used history matching approaches. The unique set of three dimensional, multiple reaction, transport, mechanical process reservoir simulators makes it possible to integrate input data. The difference between the synthetic (simulated) and observed data is used via information theory to arrive at the most probable state of a reservoir. The information theory/reservoir simulation software provides an assessment of risk/uncertainty in the present reservoir state and for future field management. Several major advances in the present approach over classic history matching include new computational techniques and concepts that make the construction of the preproduction state and associated uncertainty feasible on available hardware. The integration of a wide spectrum of data types and qualities is made possible by the uniquely comprehensive set of RTM processes implemented in the present approach. This allows the approach to integrate seismic, well log, and other data with historical production information. The approach brings unprecedented efficiency and risk control to the industry, helping the U.S. to achieve greater fossil fuel independence.

The present methodology differs from previous methodologies as follows:

A self-consistent method is used to relate the degree and method of upscaling in the reservoir simulator and in defining the spatial scale on which the most probable reservoir state is obtained.

The number of sensitivity coefficient calculations is greatly reduced, increasing with the number (N) of grid nodes on which the most probable reservoir state is obtained; in contrast, the number of these coefficients increases as (N²) for other methods.

The core and other type of data are more directly imposed on the most probable reservoir state in our method.

The types of reaction and transport processes accounted for in the reservoir simulators make it possible to construct an objective (error) function using synthetic seismic, well log, and production data.

The error function in the present approach decreases monotonically with the number of iterations assuming faster and unambiguous convergence to the most probable reservoir stated in the present method.

The current approach is written in a very general way so that it is not restricted to reservoir simulators with simplified physics (e.g., streamline methods). Fully coupled multi-phase flow, fracture dynamics, formation damage, and other processes are used under the present approach.

In summary, the present approach brings greater efficiency, accuracy, and reliability in determining the most probable reservoir state.

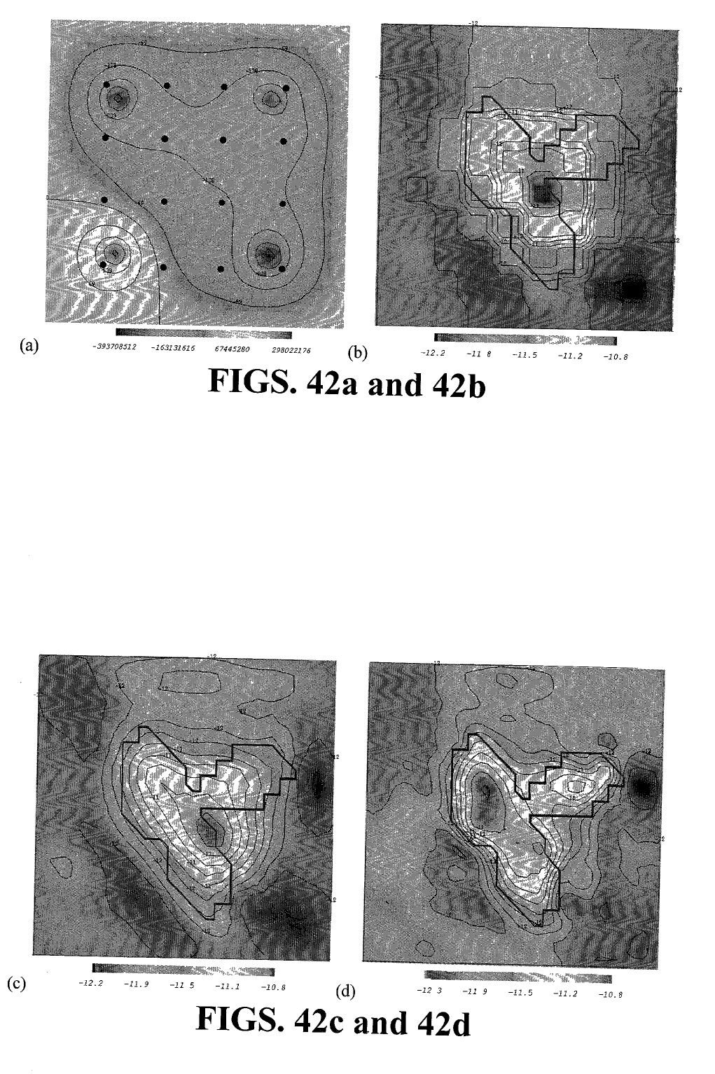

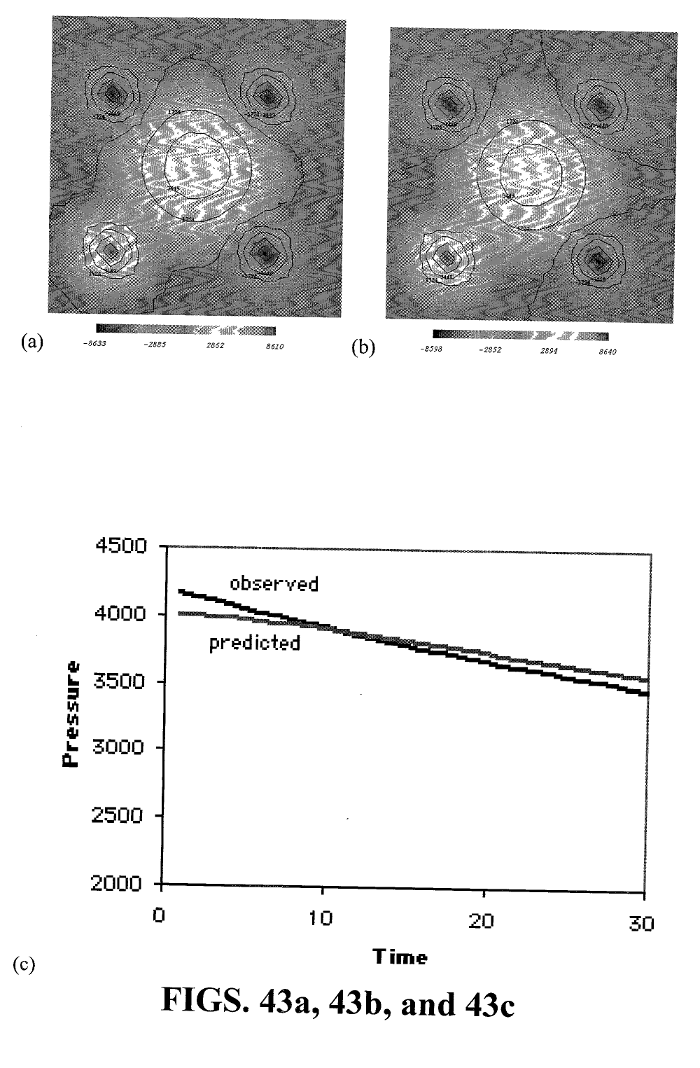

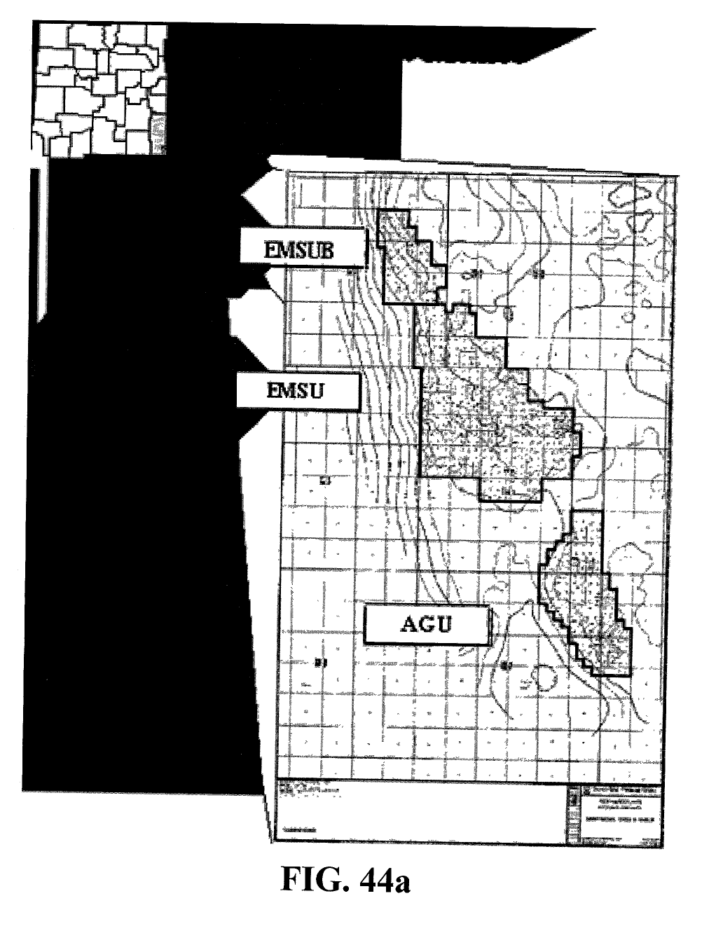

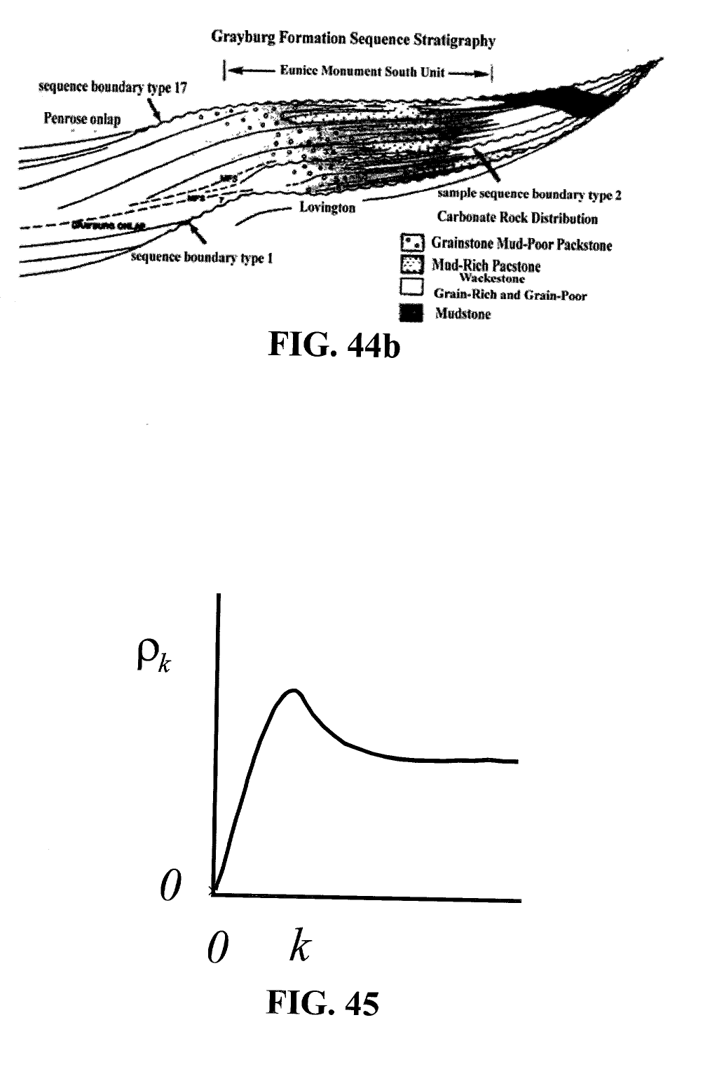

The present approach is a viable technology. FIGS. 42a, 42b, 42c, and 42d show a 2-D 10×10 km test case domain. FIG. 42a shows the locations of sixteen monitoring wells (dots) and injection and production wells. The Figure is a map of fluid pressure related to the configuration of the injection and production wells and the nonuniform distribution of permeability. Information technology computed the assumed unknown permeability distribution. This example demonstrates the multiple gridding approach. First a coarse permeability field (11×11 grid in FIG. 42b) is obtained and used as an initial guess for finer resolved permeability fields (21×21 grid in FIG. 42c and 41×41 grid in FIG. 42d). This process reduces the computational effort to arrive at the most probable permeability field since it takes only a few iterations to solve the coarsely resolved problem. The final result in FIG. 42d is in good agreement with the actual high permeability zone indicated by the thick line, across which the actual permeability jumps one order of magnitude. FIGS. 37a and 37b show another 2-D example where only two permeability logs are available. Although both permeability logs miss the puncture in the center, the present approach results in lower permeability at both ends of the domain and higher permeability in the center. This example demonstrates that the core and well log data can be directly imposed in the most probable reservoir state in the present approach, making it-cost effective. As seen in FIGS. 43a, 43b, and 43c, the FDM approach can also successfully predict the initial pressure distribution showing that production history and other dynamic data can be used to reconstruct the reservoir state. FIG. 43a shows actual distribution of pressure after 30 days indicating locations of injection and production wells as pressure maxima and minima. FIG. 43b shows the same territory as in FIG. 43a, but shows the values predicted by the present approach. Note the excellent agreement with FIG. 43a. FIG. 43c compares actual and predicted pressure at one of the pressure monitoring wells. FIGS. 28a and 28b show that even a crude discretization captures the overall reservoir shape. FIG. 28a shows the actual high permeability zone, and FIG. 28b shows that predicted by the model for a 21×21×21 grid. The domain is 10×10×10 km. Smaller scale features in the actual permeability surface are lost on the predicted one because of the spacing of the pressure monitoring wells and the configuration of the production/injection wells, as would be expected.

A probability functional method is used to determine the most probable state of a reservoir or other subsurface features. The method is generalized to arrive at a self-consistent accounting of the multiple spatial scales involved by unifying information and homogenization theories. It is known that to take full advantage of the approach (e.g., to predict the spatial distribution of permeability, porosity, multi-phase flow parameters, stress, fracturing) one should embed multiple reaction, transport, mechanical process simulators in the computation. A numerical technique is introduced to directly solve the inverse problem for the most probable distribution of reservoir state variables. The method is applied to several two- and three-dimensional reservoir delineation problems.

The state of a reservoir or other subsurface feature is generally only known at selected space-time points on a rather coarse scale. Yet it would be desirable to reconstruct the spatial distribution of fluid/rock state across a reservoir or other system. A probability functional formalism is used to determine such fluid/rock variables as functions of position because the subsurface can only be determined with great uncertainty, that is, the method analyzes the probability of a continuous infinity of variables needed to describe the distribution of properties across the system.

This is not readily accomplished without the use of models that describe many fluid/rock variables. For example, a classical history matching procedure using a single phase flow model could not be used to determine the preproduction oil saturation across a system. As a complete understanding of reservoir state involves the fluid saturations, nature of the wetting, porosity, grain size and mineralogy, stress, fracture network statistics, etc., it is clear that hydrologic simulators are needed that account for a full suite of reaction, transport, and mechanical processes. The present method is a probability functional-RTM reservoir simulator approach to the complete characterization of a subsurface system.

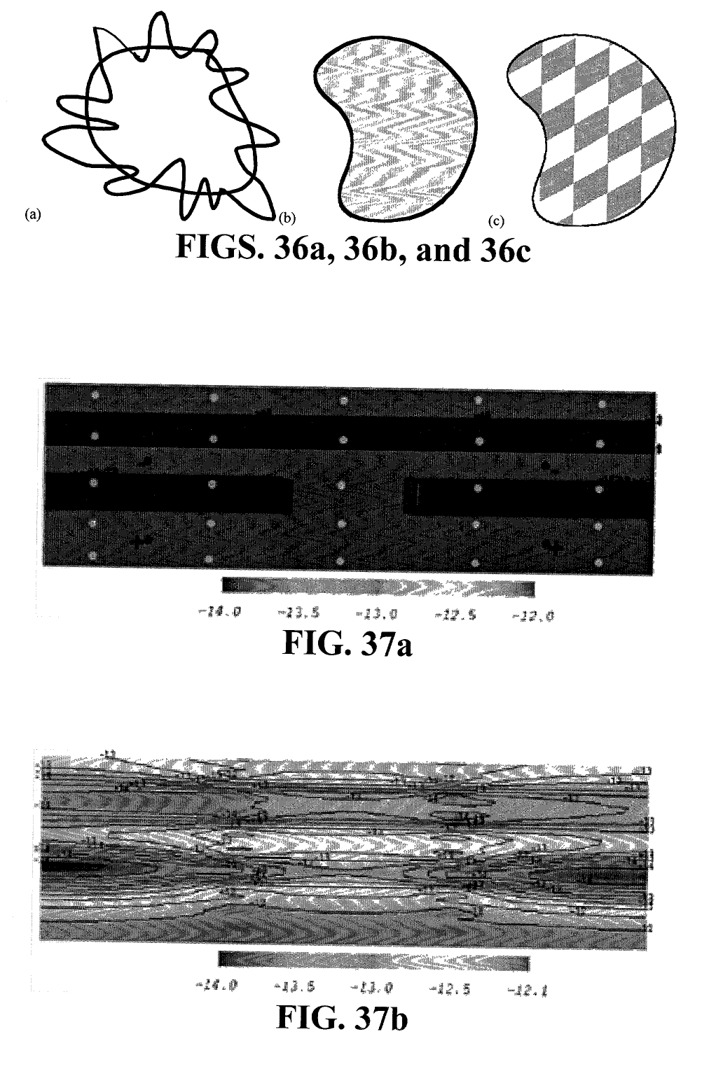

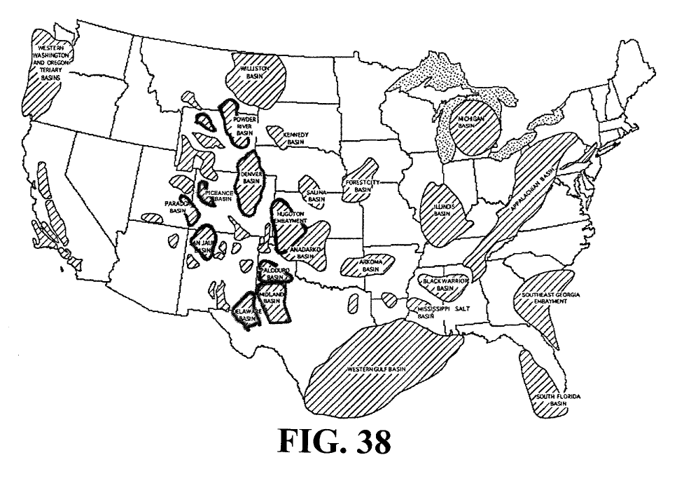

The state of a reservoir involves variations in space over a wide range of length scales. As suggested in FIGS. 36a, 36b, and 36c, the shape and internal characteristics of a reservoir can vary on a wide range of scales including those shorter than the scale on which the observations could resolve. For example, knowing fluid pressure at wells separated by 1 km could not uniquely determine variations of permeability on the 10 cm scale. Therefore one considers the determination of the most probable state among the unrestricted class of states that can involve variations on all spatial scales. FIG. 45 suggests that the probability ρₖ of variations on a length scale 2π/k become independent of k as k→∞. Thus in a classic history matching approach, there is an uncountable infinity of solutions. The present approach seeks the most probable upscaled state consistent with the scale on which the observations are taken.

Let a reservoir be characterized by a set of variables Ψ(\vec{r}) at all points \vec{r} within the system at a given time. For example, Ψ(\vec{r}) may represent the values of porosity, grain size and mineralogy, stress, fractures, petroleum vs. water saturation, and state of wetting before production began. The present method seeks the probability ρ[Ψ] that is a functional of Ψ and, in particular, constructs it to be consistent with a set of observations O(={O₁, O₂, . . . , O_{N}}) at various points across the system or at various times. In addition, assume that an RTM reservoir simulator can compute these observables given an initial state Ψ(\vec{r}). Let Ω(={Ω₁, Ω₂, . . . , Ω_{N}}) be the set of computed values corresponding to O. Clearly, Ω is a functional of Ψ(\vec{r}).

Information theory provides a prescription for computing probability. For the present problem, the prescription may be stated as follows. The entropy S is defined via

$$S = - {S}_{Ψ} ρ ln ρ$$

where [symbol] indicates a functional integral. Normalization implies

$${S}_{Ψ} ρ = 1. \qquad ( 2 )$$

The entropy is to be maximized subject to a set of constraints from the known information. Let C₁, C₂, . . . , C_{Nc} be a set of constraints that depend on O and Ω and, therefore, are functionals of Ψ. Introduce two types of constraints. One group, the “error constraints,” are constructed to increase monotonically with the discrepancy between O and Ω. A second group places bounds on the spatial resolution (the length scale) over which the method seeks to delineate the reservoir attributes. These constraints are required for self-consistency as the reservoir simulators typically used assume a degree of upscaling imposed by a lack of short scale information and practical limits to CPU time. The constraints are functionals of Ψ(C=C[Ψ]). Impose the “information”

$${S}_{Ψ} ρ {C}_{i} = {Γ}_{i} , i = 1 , 2 , ⋯ {N}_{c} . \qquad ( 3 )$$

Using the Lagrange multiplier method, obtain maximum entropy consistent with equations (2 and 3) in the form

$$\begin{matrix}ln ρ = - ln Ξ - {\sum }_{i = 1}^{{N}_{c}} {β}_{i} {C}_{i} [ Ψ ] \\ Ξ = {S}_{Ψ} exp [ {\sum }_{i = 1}^{{N}_{c}} {β}_{i} {C}_{i} ] .\end{matrix}$$

The βs are Lagrange multipliers and Ξ is the normalization constant.

The present approach focuses on the most probable state Ψ^{m}. The maximum in ρ occurs when

$${\sum }_{i = 1}^{{N}_{c}} {β}_{i} \frac{δ {C}_{i}}{δ {Ψ}_{α} ( \overline{r} )} = 0.$$

Here δ/dΨ_{α} indicates a functional derivative with respect to the α-th fluid/rock state variable. The present method solves these functional differential equations for the spatial distribution of the N reservoir attributes Ψ₁^{m}(\vec{r}),Ψ₂^{m}(\vec{r}), . . . Ψ_{N}^{m}(\vec{r}).

There are two sets of conditions necessary for the solution of equation (4). The character of the homogenization constraints is that they only have an appreciable contribution when Ψ has spatial variations on a length scale smaller than that assumed to have been averaged out in the upscaling underlying the RTM reservoir models used to construct the Ψ-dependence of the Ω.

The functional dependence of the predicted values Ω[Ψ] on the spatial distribution of reservoir state Ψ(\vec{r}) is determined by the laws of physics and chemistry that evolve the “fundamental” fluid/rock state variables Ψ. These fundamental variables include

stress;

fluid composition, phases, and their intra-pore scale configuration (e.g., wetting, droplet, or supra-pore scale continuous phase);

grain size, shape, packing, and mineralogy and their statistical distribution;

fracture network statistics; and

temperature.

With these variables, the method predicts the derivative quantities (e.g., phenomenological parameters for the RTM process laws):

permeability;

relative permeabilities, capillary pressure, and other multi-phase parameters;

rock Theological parameters; and

thermal conductivity.

From the last one, one can, through the solution of reservoir RTM equations, determine the functionals Ω[Ψ]. Thus Ψ is considered to be the set of fundamental variables at some reference time (e.g., just prior to petroleum production or pollutant migration). The dependence of Ω on Ψ comes from the solution of RTM equations and the use of phenomenological laws relating the derived quantities to the fundamental ones.

This approach uses information theory to provide a mathematical framework for assessing risk. Information theory software is used to integrate quantitative reservoir simulators with the available field data. The approach allows one to:

use field data of various types and quality;

integrate the latest advances in reservoir or basin modeling/simulation into production planning and reserve assessment;

predict the quantitative state (distribution of porosity, permeability, stress, reserves in place) across the system;

place quantitative bounds on all uncertainties involved in the predictions and strategies; and

carry out all the above in one automated procedure.

This technology improves the industry's ability to develop known fields and identify new ones by use of all the available seismic, well log, production history, and other observation data.

The present approach is a self-consistent method for finding the most probable homogenized solution by integrating multiple scale analysis and information theory. The self consistency is in terms of level of upscaling in the reservoir simulator used and the spatial scale to which one would like to resolve the features of interest. Furthermore, the homogenization removes the great number of alternative solutions of the inverse problem which arise at scales less than that of the spatial resolution of data. The great potential of the method to delineate many fluid/rock properties across a reservoir is attained through the use of multiple RTM process simulators. Finally, having embedded the computations in an overall context of information theory, the approach yields a practical method for assessing risk.

### VII. Seismic and Well Log Inversion and Interpretation

Consider the use of a sonic log to determine the geothermal gradient that operated during basin evolution. To demonstrate the model's approach, use a Basin RTM simulation run at 30° C./km as the observed data, shown in FIG. 25a. FIG. 25b is a plot of the quadratic error E (the sum of the squares of the difference in observed log values and their Basin RTM synthetic log values at a given geothermal gradient). Note the well pronounced minimum at the correct geothermal gradient. What is most encouraging is that the existence of a minimum in E vs. geothermal gradient remains even when the observed data contains random noise. As seen in FIG. 25b, the error has a perceivable minimum at about 30° C./km, proving the practicality of this approach in realistic environments.

The method similarly shows promise when used to determine multiple basin history or other variables. To illustrate this point, consider a production problem wherein the objective is to find the spatial extent of and permeability in a zone of enhanced permeability within a reservoir (the circular zone in FIG. 27a). FIG. 27a shows a vertical cross-section and indicates the location of production and injection wells represented by (−) and (+), respectively. FIG. 27b shows a 3-D depiction of the dependence of the quadratic error on the radius of and permeability in the circular zone of enhanced permeability. The dark “valley” of FIG. 27b is the zone of minimum error while the dark “peak” is the zone of maximum error. The model uses efficient ways of finding the global minimum of the error in the space of the basin history parameters.

Formulas relate the sonic, resistivity, gamma ray, and neutral log signals to the texture (grain size, shape, packing and mineralogy, and porosity) and fluid properties (composition, intra-pore geometry, and saturation of each fluid phase). These formulas allow the creation of synthetic well logs to be used in the optimization algorithm of FIG. 1.

Difficulties with seismic interpretation come from the many factors affecting wave velocity and attenuation:

matrix porosity and texture;

density and phases of pore- and fracture-filling fluids;

fracture length, aperture, and connectivity;

fracture orientation relative to the propagation direction;

fracture cement infilling volume, mineralogy, and texture; and

pressure and temperature.

What is needed for more accurate monitoring is a set of formulas for these dependencies. The key to the success of this facet of the present method is that the pore-scale geometry of the fluids as well as the grain size and mineralogy, porosity, and other predictions of the RTM model provide the information needed to compute the velocities and attentions at all spatial points in the 3-D domain. As the velocities and attentions depend on so many variables (in addition to CO₂ fluid saturation), the present method is comprehensive enough to attain unambiguous imaging of the CO₂ plume as well as possible changes in the reservoir induced by CO₂ injection. The present method uses improved seismic wave velocity and attenuation formulas so as to be compatible with the phase geometry model.

Biot's theory of wave propagation in saturated porous media has been the basis of many velocity and attenuation analyses. Biot's theory is an extension of a poroelasticity theory developed earlier. Biot predicted the presence of two compressional and one rotational wave in a porous medium saturated by a single fluid phase. Plona was the first to experimentally observe the second compressional wave. In the case of multi-phase saturated porous media, the general trend is to extend Biot's formulation developed for saturated media by replacing model parameters with ones modified for the fluid-fluid or fluid-gas mixtures. This approach results in two compressional waves and has been shown to be successful in predicting the first compressional and rotational wave velocities for practical purposes. Brutsaert, who extended Biot's theory, appears to be the first to predict three compressional waves in two-phase saturated porous media. The third compressional wave was also predicted by Garg and Nayfeh and by Santos et al. Tuncay and Corapcioglu derived the governing equations and constitutive relations of fractured porous media saturated by two compressible Newtonian fluids by employing the volume averaging technique. In the case of fractured porous media, Tuncay and Corapcioglu showed the existence of four compressional and one rotational waves. The first and third compressional waves are analogous to the compressional waves in Biot's theory. The second compressional wave arises because of fractures, whereas the fourth compressional wave is associated with the capillary pressure.

The challenge of interpreting seismic (and other remote geophysical) images is their non-unique relation to the distribution in space of the many factors that affect wave velocity and attenuation. However, much information about the state of a reservoir exists in the other data (production history, well logs, cores, fluid samples, surface geology) available to a CO₂ sequestration team. The present approach (1) minimizes interpretation errors by automating the use of all these data to estimate the most likely value of the uncertain reservoir parameters; and (2) uses information theory to assess the uncertainties (and associated risk) in the reservoir parameters so determined.

Information theory provides an advanced seismic image interpretation methodology. Classical seismic image interpretation is done using geological intuition and by discerning patterns in the data to delineate faults, formation contacts, or depositional environments. The present approach integrates the physics and chemistry in the RTM simulator and the seismic data to interpolate between wells. This approach has two advantages: (1) it provides wave properties at all spatial points within the reservoir and (2) it uses basic laws of physics and chemistry. This gives geoscientists a powerful tool for the analysis of remote geophysical data.

This advanced interpretation technology is applied to remotely detect fractures in tight reservoirs. The present method adds the important aspect of risk assessment and the special challenge of two and three phase flow expected in the CO₂ sequestration problem.

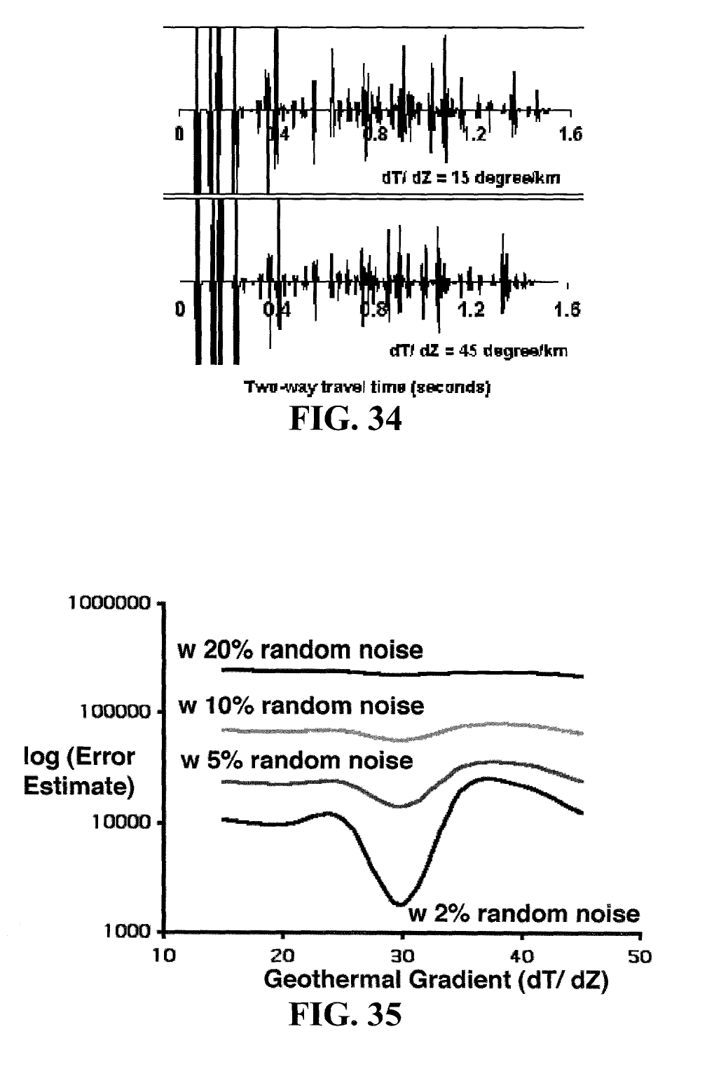

A result of a simulation-enhanced seismic image interpretation approach is seen in FIGS. 25a, 25b, 34, and 35. FIG. 25a shows porosity and compressional seismic wave velocity as predicted by the Basin RTM program for a 25.9 million year simulated evolution. Such profiles of predicted wave velocity (and attenuation) are used to construct synthetic seismic signals as seen in FIG. 34. Note that the two cases in FIG. 34 differ only in the geothermal gradient assumed present during basin evolution. FIG. 35 shows the error (the difference between the predicted and observed signals) as a function of geothermal gradient (for illustrative purposes here, the “observed” signal is the 30° C/km simulation).

The error shown in FIG. 35 is computed as a quadratic measure:

$$E = {\sum }_{i = 1}^{M} {( {Ω}_{i} - {O}_{i} )}^{2} .$$

Here Oᵢ and Ωᵢ are members of a set of M observed and simulated values of quantities characterizing the seismic signal (arrival times, amplitudes, or polarizations of a one, two, or three dimensional data set). The predicted attributes Ωᵢ depend on the values of the least well constrained reservoir parameters (such as the geothermal gradient or overall tectonics present millions of years ago). Two different sets of Ω, O are shown in FIG. 35 that are from the same study but involve different seismic attributes (raw signal and a correlation function). These examples show that the error can have multiple minima so that (1) care should be taken to find the global minimum and (2) one should develop the most reliable error measure. Another concern is the robustness of the method to the presence of noise in the observed seismic signal. These issues are investigated here in the context of CO₂ sequestration.

Results of the information theory approach are shown in FIGS. 27a, 27b, 27c, 37a, and 37b. FIG. 27a shows an application for a case wherein the geometry of the Super-K (anomalously high permeability) zone is constrained to be circular and information theory is used to determine the permeability and radius of this circular zone. This simplified study is used to show the relationship between the reduced function space and a complete analysis of the full probability distribution.

### VIII. Information Theory for Applied Geoscience Problems

A major feature of the present method is an algorithm for computing the most probable reservoirs state and associated risk assessment. To quantify risk one should obtain an objective methodology for assigning a probability to the choice of the least well controlled variables. The present approach is based on the information theory but differs from other applications in geostatistics in that the approach integrates it with RTM simulation as follows.

The following is a description of how the present method computes the probability of reservoir state. The starting point is the probability ρ[Ψ] for continuous variable(s) Ψ(\vec{r}) specifying the spatial (\vec{r}) distribution of properties of the preproduction fluid/rock system. Information theory is generalized as follows. The entropy S is given as a type of integral of ρlnρ over all possible states Ψ(\vec{r}). In the present example, Ψ(\vec{r}) is a continuous infinity of values, one for each spatial point \vec{r}. Thus, S is a “functional integral” designated:

$$S = - {S}_{Ψ} ρ ln ρ$$

where [symbol] implies functional integration. In the spirit of information theory, ρ is the probability functional that maximizes S subject to normalization,

$${S}_{Ψ} ρ = 1.$$

Let O(={O₁, O₂, . . . , O_{M}}) be a set of M observations (i.e., discretized seismic, well data, or production history information). For simplicity here, assume one type of data. Let Ωₗ(l=1, 2, . . . M) be a set of values corresponding to the 0ₗ but as predicted by a reservoir or other model. The Ωₗ are functionals of the spatial distribution of reservoir characteristics, i.e., Ω=Ω[Ψ]. Define the error E[Ψ] via

$$E [ Ψ ] = {\sum }_{l = 1}^{M} {( {Ω}_{l} [ Ψ ] - {O}_{l} )}^{2} . \qquad ( 5 )$$

Constrain ρ by requiring that E have a specified ensemble average value, E*, estimated from an analysis of errors in the reservoir model and observations; thus,

$${S}_{Ψ} E [ Ψ ] ρ [ Ψ ] = {E}^{*} .$$

Also constrain the spatial scale on which Ψ can vary. In a sense, seek the probability density ρ for an upscaled (locally spatially averaged) Ψ. To do so, use a homogenization constraint denoted C₂: the latter provides the preferred weighting of ρ towards smoother Ψ(\vec{r}) so as to make the predicted most probable state consistent with what was used for upscaled in the reservoir model. Introducing Lagrange multipliers β₀, β₁, β₂ gives:

ln ρ[Ψ]=−β₀−β₁E[Ψ]−β₂C₂[Ψ].

A central objective of the present approach is to compute the most probable distribution, i.e., that for which the functional derivative δρ/δΨ(\vec{r}) vanishes. This most probable state satisfies

$$\frac{δ E}{δ Ψ ( \overline{r} )} + λ \frac{δ {C}_{2}}{δ Ψ ( \overline{r} )} = 0$$

where λ=β₂/β₁. The higher the spatial scale of upscaled most probable state sought, the larger the λ chosen. Without the λ-term and with coarse spatial resolution of the known data, there is an uncountable number of distributions Ψ(\vec{r}) that minimize E[Ψ], i.e., for which δE/δT=0.

In this family of solutions, there are members such as suggested in FIG. 36a or others corresponding to a short scale mosaic of variations in Ψ(\vec{r}). Thus the inclusion of the C₂ term filters the ensemble to favor smoother Ψ-distributions. This is a practical consideration as only an overall resolution of the Ψ(\vec{r}) delineation problem is usually required for petroleum E&P applications. Finally, the parameter β₀ is determined from normalization in terms of β₁ and β₂, whereas β₁ and β₂ follow from the constraints from E and C₂.

Uncertainty in the most probable state can be estimated. Let Ψ^{m}(\vec{r}) be the most probable state of the system (i.e., a solution of equation (6)). Introduce an uncertainty measure u via

$${V}_{T} {u}^{2} = {S}_{Ψ} ρ [ Ψ ] \int {ⅆ}^{3} r {\{ Ψ ( \vec{r} ) - {Ψ}^{m} ( \vec{r} ) \}}^{2}$$

where V_{T} is the total volume of the system. With this definition, u^{½} is an RMS uncertainty in Ψ about its most probable distribution Ψ^{m}. u is expected to increase as the spatial coverage and accuracy of the observed data O degrades.

An important feature of the approach is that it can integrate multiple types of data (seismic, well logs, production history) or data of various quality (old versus modern production history). To do so, introduce an error E₍ₖ₎ for each of Nₑ data types (k=1, 2, . . . , Nₑ). In analogy with equation (5), write

$${E}_{( k )} = {\sum }_{i = 1}^{{N}_{chj}} {( {Ω}_{( k ) i} - {O}_{( k ) i} )}^{2}$$

where Ω₍ₖ₎ᵢ is the i-th data of the k-th set (i=1, 2, . . . , N₍ₖ₎). Again, one can impose the constraints

$${S}_{Ψ} ρ {E}_{( k )} = {E}_{( k )}^{*}$$

for estimated error E₍ₖ₎.

The data types (Ω₍ₖ₎, O₍ₖ₎) include production history, seismic, core analysis, and well logs. The functional dependence of the Ωs on reservoir state is computed via the reservoir simulator. The most probable state is computed by solving the functional differential equation (6) generalized for multiple data sets and state variables. The computational algorithms, efficient evaluation of uncertainty, and parallel computing techniques make the present method a major step forward in history matching and crosswell tomographic image interpretation.

An information theory approach is used to determine the most probable state of a reservoir and the associated uncertainty. Quantifying the state of the subsurface provides a challenge for the petroleum industry:

available information consists of mixed data types and quality and with different and often sparse spatial or temporal coverage;

the overall shape and location of a reservoir and its internal state (permeability and porosity distribution and reserves in place) are often uncertain;

there are many uncertainties about the preproduction reservoir state; and

while there is often a great quantity of data available, their use in limiting the uncertain geological and engineering parameters is subject to interpretation rather than being directly usable in a computer-automatable procedure.

### IX: A Second Exemplary Application: Cell Modeling for Drug Discovery, Treatment Optimization, and Biotechnical Applications

This section presents internal details of embodiments of Cyber-Cell. As such, this section is exemplary only and is not meant to restrict the scope of the claimed invention.

A second embodiment of the invention models living cells. Cyber-Cell is an integrated cell simulation and data methodology useful for drug discovery and treatment optimization. Cyber-Cell uses an information theory framework to integrate experimental data. Through information theory and the laws of chemistry and physics, Cyber-Cell automates the development of a predictive, quantitative model of a cell based on its DNA sequence.

Cyber-Cell accepts a DNA nucleotide sequence as input. Applying chemical kinetic rate laws of transcription and translation polymerization, Cyber-Cell computes the MRNA and protein populations as they occur autonomously, in response to changes in the surroundings, or from injected viruses or chemical factors. Cyber-Cell uses rules relating amino acid sequence and function and the chemical kinetics of post-translational protein modification to capture the cell's autonomous behavior. A full suite of biochemical processes (including glycolysis, the citric acid cycle, amino acid and nucleotide synthesis) are accounted for with chemical kinetic laws.

Data input to Cyber-Cell include microscopy, genomics, proteomics, multi-dimensional spectroscopy, x-ray crystallography, thermodynamics, biochemical kinetics, and bioelectric information. Advances in genomic, proteomic, biochemical, and other techniques provide a wide range of types and quality of data. Cyber-Cell integrates comprehensive modeling and data into an automated procedure that incorporates these ever-growing databases into the model development and calibration process.

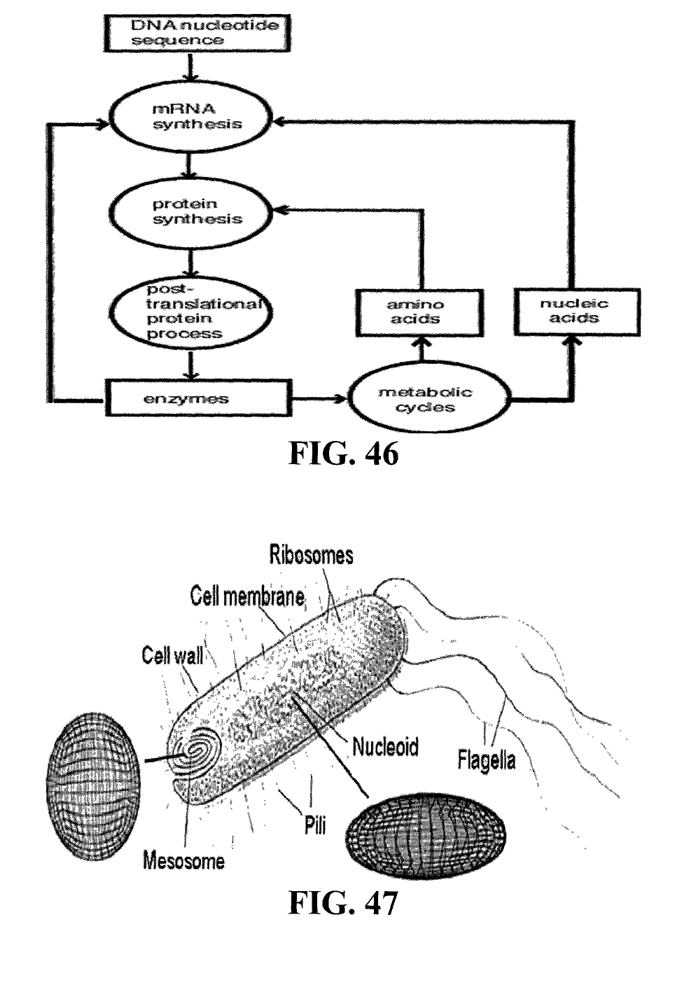

Cyber-Cell is self-sustaining. For example, mathematical equations generate RNA from the DNA nucleotide sequence using polymerization kinetics and post-translational modifications. From this RNA, Cyber-Cell generates the proteins which, through function-sequence rules, affect the metabolic processes. This closes one of the feedback loops among the many processes underlying living cell behavior, as shown in FIG. 46. That Figure shows how DNA nucleotide sequence data are used in a self-consistent way to generate cell reaction-transport dynamics by feedback control and coupling of metabolic, proteomic, and genomic biochemistry. This allows the development of a model of increasing comprehensiveness in an automated fashion, greatly improving the efficiency of the model-building process via its information theory approach.

Cyber-Cell accounts for the many compartments into which a cell is divided and within each of which specialized biochemical processes take place, as suggested by FIG. 47. FIG. 47 shows some of the intracellular features that Cyber-Cell models by evolving them via mesoscopic equations solved on a hexahedral finite-element grid. For example, E. coli's key features include the nucleoid and ribosomes, while other prokaryotes have these features as well as the mesosome. The intracellular features are treated with a mesoscopic reaction-transport theory to capture atomic scale details and corrections to thermodynamics due to the large concentration gradients involved. Metabolic reactions and DNA/RNA/protein synthesis take place in appropriate compartments, and active and passive molecular exchange among compartments is accounted for. Cyber-Cell models transport and reaction dynamics that take place in the membrane-bound organelles of eukaryotic cells. Cyber-Cell accounts for the wide separation of time scales (nanoseconds to hours) on which cellular rate processes take place, using multiple time scale techniques.

Conservation equations compute nucleotide/amino acid concentrations, and polymerization kinetics govern the time course of RNA synthesis. Protein polymerization kinetics are accounted for via rate phenomenologies that allow for cross-coupled control of metabolic networks and other processes. Bioelectrically mediated membrane transport is computed to keep track of the exchange of molecules between the cell's interior and the external medium. Cyber-Cell's embedded information theory framework achieves an integration of model and data for automated cell model building and simulation. Uniqueness is a critical issue in the development of a model of a complex system—can the available data discriminate among models? For example, the overall reaction x+y+z→product with an observed rate proportional to the concentration product xyz can correspond to the more likely mechanism (x+y [symbol] (xy),(xy)+z→product) and two other similar permutations. Also, several proteomes upon tryptic digestion can yield the same MDS (multi-dimensional spectroscopy) signal/separation. Cyber-Cell's integration of model and data through information theory surmounts this problem. For example, there are (by postulate) many fewer fundamental rules of transcription and translation than the number of types of mRNA and proteins in a cell. Cyber-Cell facilitates the use of the MDS and other data to interpret the proteome. Furthermore, as the proteome, for example, depends on metabolism (notably amino acid production), the wealth of biochemical, membrane transport, and other data used in Cyber-Cell helps to constrain the “inversion” of the spectroscopic and other data to yield a more specific identification of the proteins. As more and more data become available, Cyber-Cell's fully automated procedure develops a model of increasing accuracy and uniqueness.

To capture a wide range of cellular phenomena and to achieve an integration with experimental data, Cyber-Cell includes a comprehensive set of cell reaction, transport, and genomic processes. As a result, Cyber-Cell includes these features:

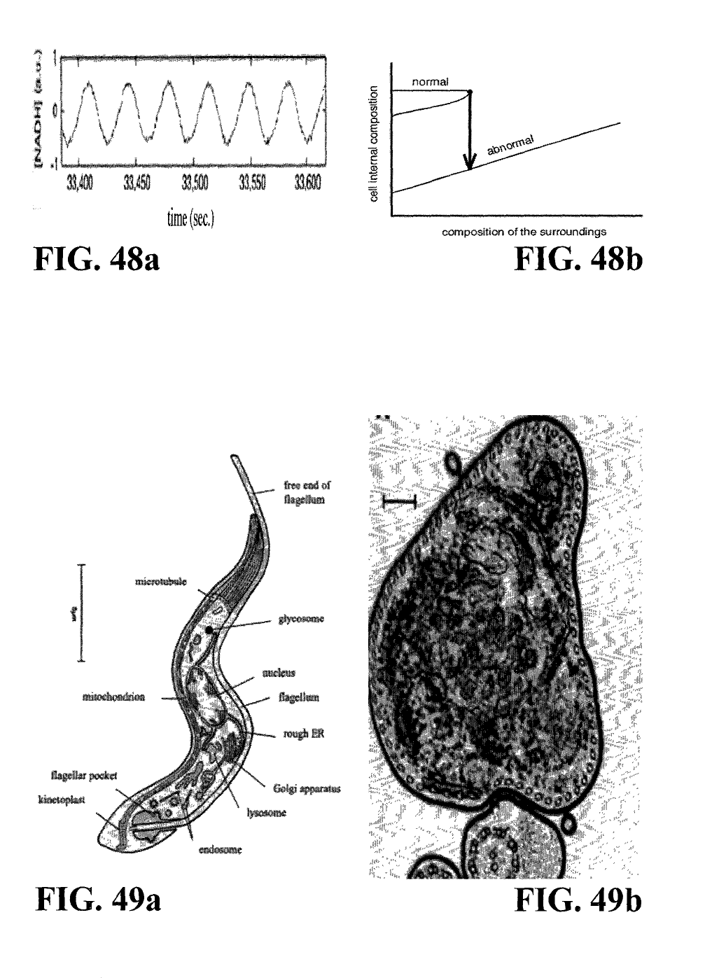

nonlinearity and multiple, stable, cellular states (see FIGS. 48a and 48b);

multiple time scale (fast/slow) reaction formalism;

nonlinear dynamics of interacting local sites of reaction;

bioelectricity;

polymerization kinetics;

passive membrane transport and attendant nonlinearity;

translation and transcription polymerization chemical kinetics; and

mesoscopic structures (e.g., macromolecules, the nucleoid of a prokaryote, etc.) that are too small to treat by usual macroscopic reaction-transport theory. Their atomic scale features should be accounted for in capturing their biochemical functionality.

As an example of cellular nonlinear phenomena, FIG. 48a shows sustained oscillations in Saccharomyces cerevisiae in a continuous-flow stirred tank reactor. In FIG. 48b, Cyber-Cell demonstrates that nonlinear rate laws may allow a cell to make a transition from a normal state to an abnormal one without the possibility of ever returning to the normal state no matter how the surrounding conditions are changed.

The internal complexities of a typical cellular system are shown in FIG. 47. Simplified models (e.g., of one biochemical pathway or compartment) are not satisfactory; such subsystems are so strongly coupled to the rest of the cell that their isolated dynamics do not yield a true picture of the multi-process, compartmentalized living cell. Cyber-Cell's design is flexible (reactions are written with general stoichiometry, rate laws can be easily modified, etc.), and it takes advantages of advances in genomic and proteomic data and supercomputing to grow with the expected expansion of cellular databases.

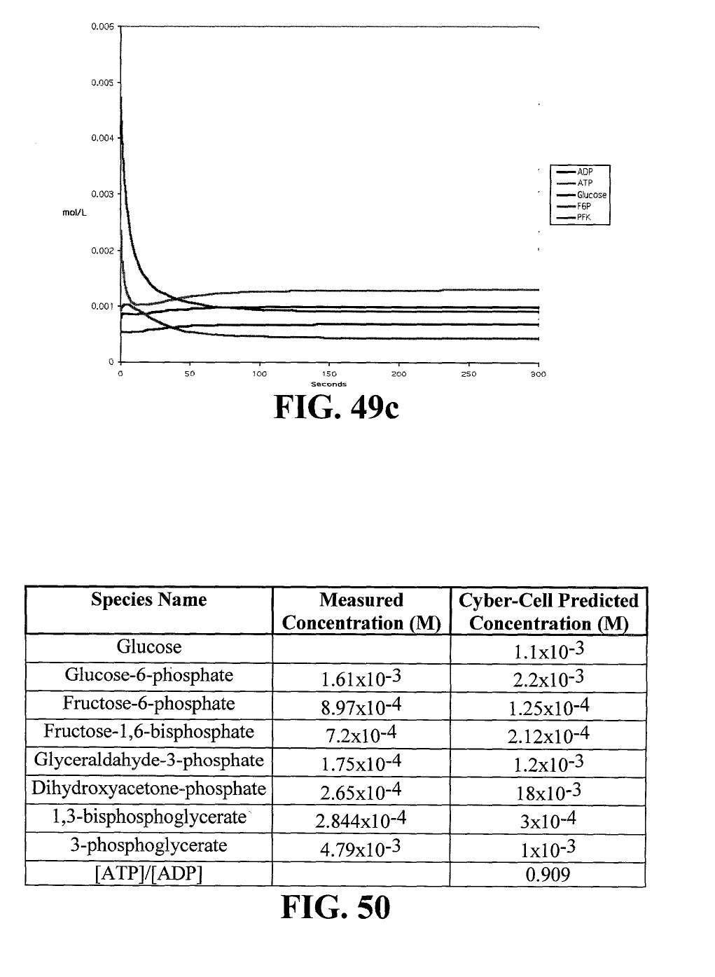

The metabolic kinetics and transport features of Cyber-Cell (see FIG. 46) have been tested on Trypanosoma brucei. T. brucei rhodesiense and T. brucei gambienese are the parasites responsible for sleeping sickness in humans, and T. brucei causes Nagana in domestic animals. FIG. 49a shows T. brucei's “long and slender” form with a long flagellum. The single mitochondrion is forced in a peripheral canal with almost no cristae; there are no cytochromes, and the citric acid cycle does not function. In FIG. 49b, T. brucei is in its “stumpy” form with an expanded mitochondrial canal. The mitochondrion participates in cell metabolism. Shown in FIG. 49c are Cyber-Cell predicted concentrations of some of the chemical species within the glycosome as a function of time for a transient experiment. FIG. 50 compares the predicted results with observed steady state values: column one shows measured concentrations, column two shows Cyber-Cell's simulation of the same system.

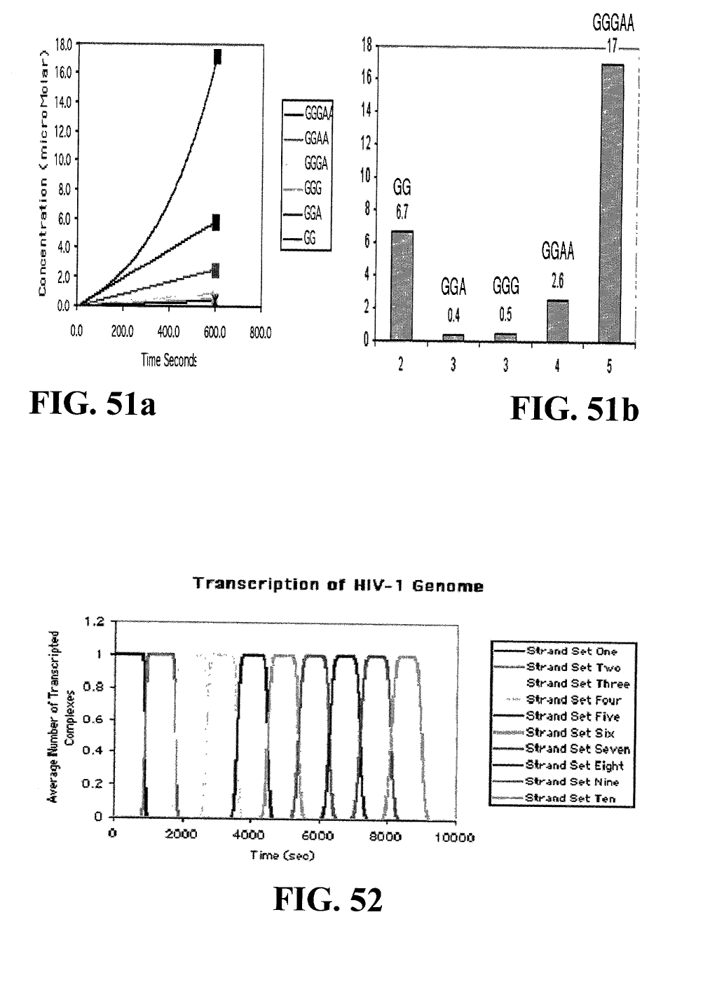

Cyber-Cell's RNA polymerization kinetics have also been tested. The T7 family of DNA-dependent RNA polymerases represents an ideal system for the study of fundamental aspects of transcription because of its simplicity: T7 RNA polymerases do not require any helper proteins and exist as single subunits. These single-subunit RNA polymerases are highly specific for an approximately twenty base pair, nonsymmetric promoter sequence. One major transcript GGGAA and five other mistakes are seen in FIGS. 51a and 51b. The mistakes arise from misinitiation or premature termination. The polymerization model implemented in Cyber-Cell accounts for these mistakes, and its results compare well with experimental data. FIG. 51a shows transcription by a bacteriophage T7 RNA polymerase system inserted in E. coli. This Cyber-Cell simulation agrees with the experimental results shown in FIG. 51b. In the latter Figure, experimental data are shown on in vitro RNA synthesis showing the sequencing and strand length after ten minutes of evolution. The T7 RNA polymerase system is a test case that demonstrates the validity of Cyber-Cell's mathematics and is not used to calibrate transcription. Another Cyber-Cell simulation is seen in FIG. 52, where HIV-1 transcription of the Philadelphia strain is considered. The number of transcribed strands of various length intervals are shown as a function of time. Strand set one is the sum of nucleotides from length 1 to 1000, set two is for strands of length 1001 to 2000, and so on.

In some embodiments, Cyber-Cell runs in four modes:

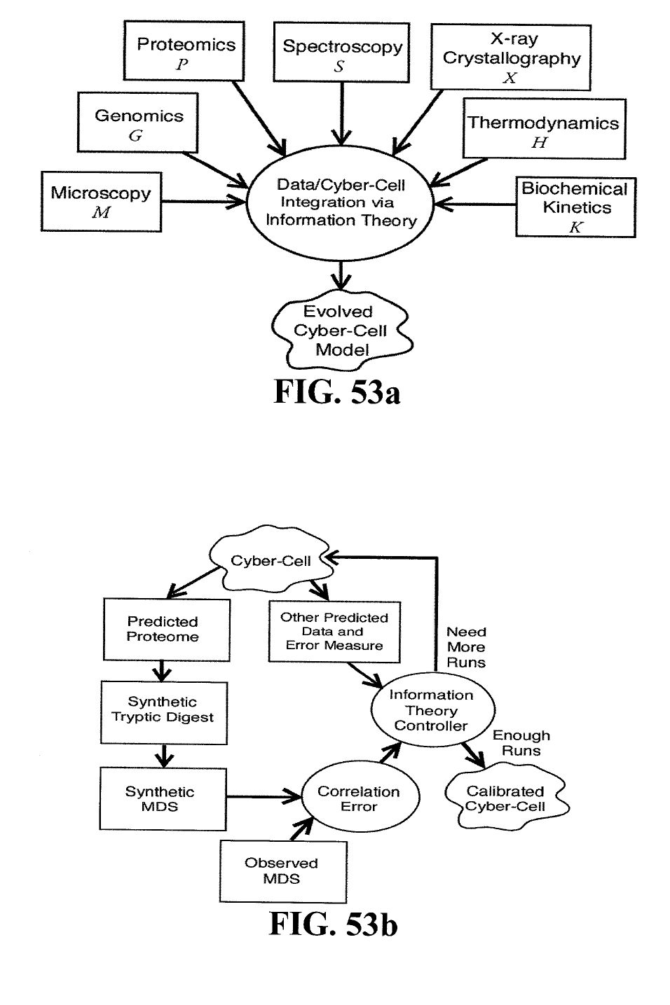

a model building/calibration mode wherein model parameters are determined using experimental data of a variety of types (FIG. 53a);

a probability functional mode for estimating the most probable time-course of key species whose mechanisms of production or destruction are not known;

a mode wherein estimated Cyber-Cell input or output data are assigned uncertainties; and

a mode to aid an investigator in designing experiments to reduce the uncertainties in model parameters.

Cyber-Cell divides the system to be modeled into N_{c} compartments labeled α=1, 2, . . . N_{c}. There are N molecular species labeled i=1, 2, . . . , N of concentrations cᵢ^{α}(t) at time t. Conservation of mass for species i in compartment α implies

$${( {V}^{α} \frac{ⅆ {c}_{i}^{α}}{ⅆ t} = {\sum }_{{α}^{′} \neq α} {A}^{{αα}^{′}} {h}_{i}^{{αα}^{′}} {E}_{i}^{{αα}^{′}} + {J}_{i}^{{αα}^{′}} + {v}^{α} Rxn ) )}_{i}^{α} \qquad ( 7 )$$

where

hᵢ^{αα′}=permeativity of species i between compartments α and α′;

Eᵢ^{αα′}=factor which, at exchange equilibrium for passive transport between compartments α and α′ for species i, is zero;

Jᵢ^{αα′}=net rate of active transport of species i from compartment α′ to α;

A^{αα′}=surface area between compartments α and α′;

V^{α}=volume of compartment α;

Rxn)ᵢ^{α}=net rate of reaction in compartment α for species i (moles/volume-time); and

V_{τi}^{α}=stoichiometric coefficient for species i in reaction τ in compartment α. For eukaryotes, the h parameters are flux coefficients for transfer of species across membrane-bound organelles. For prokaryotes, the h parameters are permeativities associated with the surroundings, while for the internal compartments (e.g., nucleoid, mesosome) they serve as rate coefficients for molecular exchange with the cytosol. However, Cyber-Cell optionally treats internal dynamics of internal compartments, such as the nucleoid, using mesoscopic equations. Coulomb forces impose charge neutrality within each compartment; if zᵢ and cᵢ^{α} are the valence and concentration of species i in compartment α, respectively, then

$${\sum }_{i = 1}^{N} {z}_{i} {c}_{i}^{α} = 0.$$

Formulas for the activity of species i in each compartment and the rate laws for transport across the membranes complete the model, yielding electrical potential and concentration in each compartment. Biochemical reactions proceed on a wide range of time scales (from nanoseconds to days). Thus, for practical and conceptual reasons, Cyber-Cell divides reactions into fast and slow groups. With this, the reaction term in equation (7) is rewritten

$${( Rxn ) )}_{i}^{α} = {\sum }_{k = 1}^{{N}^{α f}} {v}_{ki}^{α f} \frac{{W}_{k}^{α f}}{ϵ} + {\sum }_{k = 1}^{{N}^{α s}} {v}_{ki}^{α , s} {W}_{k}^{α , s}$$

where the smallness parameter ε<<1 emphasizes the large rate coefficients of the fast reactions relative to those of the slow ones. Using the equilibrium submanifold projection technique, such rate problems are solved in the limit ε→0. The generality of this approach allows for the automated creation of reactions, and thereby information theory is used to guide the model building effort of Cyber-Cell.

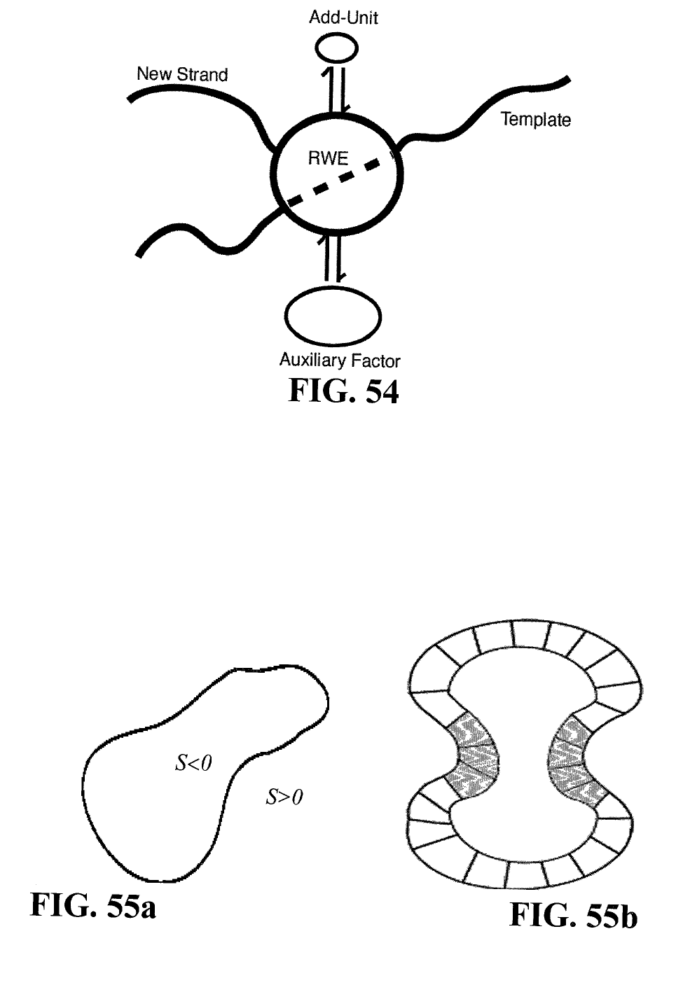

Cyber-Cell accounts for the interplay between the molecular scale (at which information is stored and molecular function is determined) and the macroscopic scale of metabolite balance. To do this, Cyber-Cell reads and transfers nucleotide and amino acid sequences through a polymerization kinetic model. Thereby Cyber-Cell utilizes the growing genomic and proteomic databases for model development, calibration, and simulation of cell behavior. This is illustrated by considering the kinetics of RNA and protein synthesis. (See FIG. 54.) Key aspects of the synthesis of these macromolecules are the role of a template molecule (e.g., mRNA for proteins) and the mediation by enzymes in controlling the biopolymerization. Cyber-Cell uses a chemical kinetic formalism to capture effects of DNA/RNA/protein synthesis. In order to complete the coupling of these syntheses to the rest of the cell processes, Cyber-Cell uses relations between sequence and function as they become known in the art.

FIG. 54 illustrates the need for Cyber-Cell's complex polymerization chemical kinetics. In the Figure, a polymerase or editing system (performing read, write, or edit (RWE) functions) accepts a templating DNA/RNA strand and produces a new strand (DNA, RNA, or protein). The RWE complex binds to the template and advances along the templating strand, reading its information in search of the initiation sequence where the R WE forms a closed complex on the promoter sequence. An isomerization occurs whereby an open complex is formed. Polymerization takes place where the appropriate nucleotide sequence is laid according to the DNA sequence for the seven to twelve area base pairs or the DNA strand that the enzyme covers. Auxiliary molecules may complex with an RWE unit to modify its kinetics (i.e., rules of reading the templating strand to decide on initiation, elongation, and termination). The σ-subunit of the enzyme must detach in order for the enzyme to have a strong affinity for nonspecific DNA. If the σ-subunit does not detach, abortive mRNAs are created, otherwise elongation occurs. Some RWE complexes can read the new strand and edit it by deletion or addition processes. Finally, end units can be added to the new strand in a process mediated by an RWE. A given cell may have several types of RWEs.

The essential chemical species is a complex of an RWE unit with the templating and new strands. To characterize this complex, Cyber-Cell keeps track of the location n on the template strand being read and the presence or absence of any auxiliary factors. Cyber-Cell also accounts for the complexing to an add-unit ω (amino acids for proteins and nucleotides for DNA or RNA). Example Cyber-Cell reactions formulated to capture the aforementioned processes are as follows:

$$Enz + DNA ( gene ) ⇔ {( E \cdot DNA )}_{gene , n}^{closed}$$

$${( E \cdot DNA )}_{gene , n}^{closed} ⇔ {( E \cdot DNA )}_{gene , n}^{closed}$$

$${( E \cdot DNA )}_{gene , n}^{open} + ntp ⇔ {( E \cdot DNA \cdot RNA )}_{gene , n + 1}^{open}$$

$${( E \cdot DNA \cdot RNA )}_{gene , p}^{open} + ntp ⇔ {( E \cdot DNA \cdot RNA )}_{gene , p + 1}^{open}$$

$$where p = n + 1 , n + 6$$

$${( E \cdot DNA \cdot RNA )}_{gene , n + 6}^{open} + ntp -> {( E \cdot DNA \cdot RNA \cdot no σ )}_{gene , n + 7}^{open}$$

$${( E \cdot DNA \cdot RNA \cdot no σ )}_{gene , m}^{open} + ntp ⇔ {( E \cdot DNA \cdot RNA \cdot no σ )}_{gene , m + 1}^{open}$$

$$where m = n + 7 , N - 1$$

$${( E \cdot DNA \cdot RNA \cdot no σ )}_{gene , N}^{open} -> Enz + DNA ( gene ) + RNA ( gene ) .$$

The process starts at the promoter region.

Cyber-Cell's formalism captures the biochemical control of the cellular system. For example, complexing with an auxiliary molecule may make one pathway possible (e.g., location of initiation or termination, nature of editing) while another auxiliary factor or set of complexed factors may favor another pathway. The above approach is used for modeling E. coli, the in vitro T7 RNA polymerase (FIGS. 51a and 51b), and the HIV (FIG. 52). In the HIV case, the full length HIV RNA strands are templated from HIV DNA inserted in a host helper T-cell. These features can be tested using data from E. coli, Saccharomyces cerevisiae, and their subsystems, for which laboratory kinetics data are available. Such test systems serve to calibrate the parameters (chemical rate, transport, etc.) in Cyber-Cell as values for those systems or preliminary values for analogous systems. The information theory shell program in Cyber-Cell greatly facilitates the use of a variety of genomic and proteomic data to carry out this calibration.

Intracellular mesoscopic structures (e.g., the nucleoid, globules and bubbles, ribosomes) should not be treated using the macroscopic reaction-transport theory as described above. Free energy-minimizing structures are often not global minima, but are rather functioning entities that are local minima lying close to the global minimum.

Cyber-Cell models simple and multi-phase liquid droplets immersed in a host medium. Composite structures of multiple macromolecules are analyzed via a global coordinate approach. Micelles, nucleoids, ribosomes, and other mesoscopic objects made of a shell of molecules can take on morphologies dictated by the number and shape of the shell-forming molecules and their distribution over the shell. The following is a formalism for determining the relationship between the composition and the shape of these mesoscopic objects.

Consider a body surrounded by a shell of N molecular types i=1, 2, . . . , N. Let σᵢ be the number of molecules of type i per surface area. FIG. 55a suggests the morphology of mesoscopic objects consisting of an interior medium (S<0) surrounded by a bounding surface (S=0) immersed in an external medium (S>0). The morphology results from the coupling of the curvature of the shell (S=0) and the distribution of molecules of various types within the shell. The objective is to construct the free energy functional F[σ, S] and delineate the free energy-minimizing structures it implies. First write the free energy as an integral of the free energy density f(σ, τ) over the surface S=0:

$$F = {\int }_{S = 0} {ⅆ}^{2} rf .$$

Through the curvature tensor, τ, of the domain of integration, F depends on the shape function S. As a first approximation, f can be written as

$$\begin{matrix}f = {f}^{cl} ( \underline{σ} ) + \frac{1}{2} {\sum }_{{α}_{1} , {α}_{2} , {α}_{3} , {α}_{4} = 1}^{3} {Γ}_{{α}_{1} {α}_{2} {α}_{3} {α}_{4}} {\tilde{κ}}_{{α}_{1} {α}_{2}} {\tilde{κ}}_{{α}_{3} {α}_{4}} + \\ \frac{1}{2} {\sum }_{i , j = 1}^{N} {Λ}_{ij} \vec{∇} {σ}_{i} \cdot \vec{∇} {σ}_{j} ,\end{matrix}$$

where \tilde{τ} is τ minus a σ-dependent reference value that incorporates the effect of molecular shape. In FIG. 55b, the indented area is induced by the presence of one type of molecule (dark area) that reflects the sign and magnitude of the preferred radius of curvature associated with the dark vs. the light molecules. The energy-minimizing structures are the solution of the following equations:

$$\frac{δ F}{{δσ}_{i}} = {\overline{μ}}_{i}$$

$$\frac{δ F}{δ S} = {\sum }_{i = l}^{N} {\overline{μ}}_{i} \frac{δ}{δ S} {\int }_{s = 0} {ⅆ}^{2} r {σ}_{i}$$

for Lagrange multiplier \overline{μ}ᵢ.

Macromolecules may aggregate into ribosomes, nucleoids, or other mesostructures. Also, the escape of RNA from and the import of nucleotides into the nucleoid, with its maze of DNA and other molecules, occurs in a geometrically restricted and crowded environment. These and other key biochemical processes typically take place without altering the bonding relations among the constituent atoms. Thus although local structure may only change slightly, the cumulative effect is a large deformation or assembly of the mesostructure. Cyber-Cell generalizes the collective coordinate method for use in the efficient computing of the stable structures of these macromolecular assemblages. To illustrate this approach, consider the assembly of a complex structure from its constituent macromolecules (e.g., proteins or RNA). The challenge in constructing a theory of these objects is that the essence of their behavior may involve both their overall morphology and the atomic structure underlying their chemical reactivity.

Cyber-Cell computes the assembly of a free energy minimizing structure from a given initial configuration of the molecules. Self-assembly is dictated by the cumulative effect of atomic forces. To start, introduce a set of collective coordinates Γ^{(m)} for each of the M constituent macromolecules m=1, 2, . . . , M. As the interatomic forces induce an interaction between these constituents, the equations yielding the overall free energy minimizing structure form a set of coupled equations for these collective coordinates. This approach preserves the atomic scale detail while attaining great computational efficiency.

For each macromolecule m=1, 2, . . . , M, a space-warping transformation is introduced via

$${\vec{r}}^{′} = {\sum }_{n} {Γ}_{n}^{( m )} {\vec{f}}_{n} ( \vec{r} ) , m = 1 , 2 , ⃛ M .$$

This transformation takes a point \vec{r} to a new point \vec{r}′. The atomic coordinates of the m-th macromolecule move via a change in the Γ^{(m)}s so as to minimize the free energy F^{tot} of the M macromolecular assemblage. Let F be F^{tot}, except with the atomic coordinates of each macromolecule related to its Γs and to a set of reference coordinates that are indicated with a superscript “0,” i.e., \vec{r}ᵢ=\vec{r}ᵢ(Γ^{(m)}, \vec{r}^{o} . . . \vec{r}_{N}^{o}), where the molecule has Nₘ atoms. Then Γ^{(m)} is determined as the solution of

$$\frac{ⅆ {Γ}_{n}^{( m )}}{ⅆ τ} = - \frac{\partial F}{\partial {Γ}_{n}^{( m )}} , m = 1 , 2 , ⃛ M .$$

These equations are solved until the rate of change of the Γs is reduced appreciably, and then a similar procedure is used for the atomic coordinates via a solution of d\vec{r}ᵢ^{(m)}/dτ=−∂F^{tot}/∂\vec{r}ᵢ^{(m)}. This Γ/γ cycle is repeated until F^{tot} is minimized. Finally, the above procedure can be generalized for the solution of Newton's equation for carrying out efficient molecular dynamics simulations

The benefit of Cyber-Cell's procedure is that changes in the Γs allow for overall translation, rotation, bending, and twisting of each macromolecule as the macromolecules organize to form the free energy minimizing assembly. Massive computations based on direct atomic simulation are unfeasible while the present approach yields results on available computer hardware.

Many of the equations describing mesoscopic cellular subsystems can be solved using numerical methods. The descriptive variables, either on a surface or in a 3-D volume, are solved by finite element techniques. A key problem in many cases is the need to constrain the minimization due to mass conservation or other conditions.

Mesostructures, such as the nucleoid, interact with the cytoplasm and other intracellular features through an exchange of molecules. This exchange takes place across a surface defining the nucleoid region. A simple model of a subcellular body assumes that the configuration of the body's macromolecules rapidly adjusts to the internal medium but that the latter is controlled by the kinetics of exchange with the surroundings across a boundary surface. A schematic view of such a model system is suggested in FIG. 47. The overall dynamics of the model can be quite dramatic as the response of the macromolecules can be nonlinearly related to the internal compositional state. The free energy of the compartment, F^{tot}, is assumed to be given by

F^{tot}=U(ξ)+∫d³rf

including entropic effects from internal vibrations plus a term from the interaction of any membranes. Hence U is a functional of membrane shape.

In the quasi-equilibrium model, F^{tot} is minimized with respect to ξ and the distribution of composition c(={c₁, c₂, . . . , c_{N}}) of the N continuum molecular species in the mesoscopic compartment. If nᵢ^{tot} is the total number of moles of species i in the compartment, then F^{tot} is to be minimized with respect to c for a given n^{tot}. Thus one has

$${μ}_{i} ≡ \frac{δ {F}^{Tot .}}{δ {c}_{i}} = {\overline{μ}}_{i}$$

$$\frac{\partial {U}^{*}}{\partial {ξ}_{α}} = 0.$$

The effective potential U* is defined via

U*=U−∫d³rp

for pressure p=

$$p = {\sum }_{i = 1}^{N} {c}_{i} {μ}_{i} - f .$$

The constants \overline{u}ᵢ can be determined via a penalty method.

The time course of n^{tot} is determined from the exchange with the surroundings. Let Jᵢ be the net influx of component i into the compartments. Assuming that Jᵢ depends on c and c⁰ (the concentrations in the surroundings), and possibly on the electrical potentials V and V⁰ as well, net conservation of mass yields

$$\frac{ⅆ {n}_{i}^{tot}}{ⅆ t} = \int {ⅆ}^{2} {rJ}_{i} ( \underline{c} , {\underline{c}}^{0} , V , {V}^{0} )$$

where the integral is over the compartment surface just inside the compartment. Thus if c⁰ and V⁰ are known, this quasi-equilibrium model gives the coupled dynamics of mass exchange with the surroundings and the free energy minimizing internal state.

In the nucleoid, the dense packing of macromolecules can greatly slow down the migration of molecules. Thus, the assumption of diffusional equilibrium as used above may break down. In these cases, Cyber-Cell's intracompartmental dynamics are augmented with time-dependent mesoscopic reaction-transport equations.

### X. Data for Cell Modeling

Cyber-Cell integrates a variety of data types and qualities into its model development and calibration process. Thus, up-to-date knowledge of the types of data available is of paramount importance. As seen from FIG. 53a, data are divided into seven categories. Biochemical kinetic and thermodynamic data are needed for modeling transcription, translation, and metabolic processes. Examples of this type of data include enzyme affinity for a substrate, equilibrium constants, reaction rates, Gibbs free energy, and entropy values. Advances in analytical biochemical spectroscopy, microscopy, chromatography, and electrophoresis provide a wealth of knowledge related to the physico-chemical dynamics of cells. Techniques such as dynamic light scattering spectroscopy, matrix-assisted laser desorption/ionization mass spectroscopy, multidimensional HPLC-IMS-MS, NMR spectroscopy, UV/Visible spectroscopy, and SDS-PAGE electrophoresis allow biologists to gain extensive knowledge of the composition, function, and conformation of proteins and produce data usable by Cyber-Cell.

For simulations of prokaryotic systems, the wealth of physiological, metabolic, genetic, proteomic, and x-ray crystallography data currently available on E. coli make it ideal for whole cell testing. The E. coli genome has been extensively and comprehensively studied, and the current explosion of E. coli proteomic studies has led to creation of many proteomic and genomic web-based databases available from a variety of institutions around the world. For example, some of the more noteworthy are presented in the following Table. Much of the same type of information is available, and from some of the same sources, for the yeast cell Saccharomyces cerevisiae, making it ideal for whole cell eukaryotic testing.

TABLE

| Database Name | Web Address | Comment |
|---|---|---|
| Kyoto Encyclopedia of Genes and | www.genome.ad.jp/kegg/ | Genomics, |
| Genomes (KEGG), Institute for Chemical | | Proteomics, Enzyme |
| Research, Kyoto University | | Kinetics |
| What is There? (WIT), Argonne National | wit.mcs.anl.gov/WIT/ | Genomics, Enzyme |
| Laboratory, USA | | Kinetics |
| BRENDA: The Enzyme Database, | srs.ebi.ac.uk/srs6bin/cgi-bin/wgetz?- | Enzyme Kinetics |
| European Bioinformatics Institute, | page+LibInfo+-id+66MWY1G5_nt+- | |
| Hinxton, UK | lib+BRENDA | |
| Regulon DB: A database on | tula.cifn.unam.mx:8850/regulondb/regulon | Genomics |
| transcriptional regulation of E. coli, | _intro.frameset | |
| Laboratory of Comparative Biology, | | |
| Universidad Nacional Autonoma de | | |
| Mexico | | |
| E. coli Database Collection (ECDC), | susi.bio.uni-giessen.de/ecdc/ecdc.html | Genomics, |
| Institut f\ddot{ur} Milro- und Molekularbiologie, | | Proteomics |
| Giesser, Germany | | |
| E. coli Stock Center Database, Yale | cgsc.biology.yale.edu/cgsc.html | Genomics, |
| University, USA | | Proteomics |
| NCBI Entrez: E. coli k-12 Complete | www.ncbi.nlm.nih.gov/cgi- | Genomics |
| Genome, National Institutes of Health, | bin/Entrez/framik?db=genome&gi=115 | |
| USA | | |
| MetalGen: A graphic-oriented database | ftp://pasteur.fr/pub/GenomeDB | Genomics, Enzyme |
| which links metabolism to the genome of | | Kinetics |
| E. coli, Institute Pasteur, France | | |
| Colibri: A complete dataset of DNA and | genolist.pasteur.fr/Colibri | Genomics, |
| protein sequences derived from E. coli k- | | Proteomics |
| 12 and linked to relevant annotations and | | |
| functional assignments, Institute Pasteur, | | |
| France | | |
| EcoGene: Database of genes, proteins, and | bmb.med.miami.edu/Ecogene/EcoWeb | Genomics, |
| intergenic regions of E. coli k-12, | | Proteomics |
| University of Miami, USA | | |
| E. coli Strain Database of National | www.shigen.nig.ac.jp/ecoli/strain/ | Genomics |
| Institute of Genetics, Japan | | |
| Genobase 3.0, Nara Institute of Science | e.coli.aist-nara.ac.jp | Genomics |
| and Technology, Japan | | |
| E. coli Genome Project, University of | www.genome.wisc.edu | Genomics |
| Wisconsin at Madison, USA | | |
| Profiling of E. coli Chromosome (PEC), | www.shigen.nig.ac.jp/ecoli/pec | Genomics |
| National Institute of Genetics, Japan | | |
| EcoCyc: Encyclopedia of E. coli Genes | ecocyc.PangeaSystems.com/ecocyc/ecocyc. | Genomics, |
| and Metabolism | html | Proteomics, Enzyme |
| | | Kinetics |
| GenProtEC: E. coli Genome and | genprotec.mbl.edu/start | Genomics, |
| Proteomic Database, Marine Biology | | Proteomics |
| Laboratory, Woods Hole, MA, USA | | |
| Express DB RNA Expression Database, | arep.med.harvard.edu/cgi- | Genomics, |
| Lipper Center for Comparative Genetics, | bin/ExpressDBecoli/EXDstart | Proteomics |
| Harvard University, USA | | |

### XI. Information Theory and Cell Model Data Integration

Cyber-Cell resolves gaps in the understanding of many cell processes via its information theory approach. This leads to a computational algorithm for simultaneously using data of various types and qualities to constrain the ensemble of possible processes and rate parameters. A probability functional method is used to account for the time-dependence of the concentrations of chemical species whose mechanisms of production or destruction are not known but whose enzymatic or other role is known.

Cyber-Cell can be calibrated when some of its processes are not well understood (e.g., post-translation chemical kinetics network and rate laws). Cyber-Cell addresses the dilemma of calibrating or running a model that is incomplete, a situation which should be faced in any cell modeling effort. For example, cell extract or other in vitro experiments are known to yield different rate parameters than those in the complete cell-seemingly implying the need for a complete model before calibration can commence. However, by its information theory method, Cyber-Cell predicts the most probable time course of enzymes or other factors that play a key role, but whose mechanisms of production or destruction are not known. Cell response data are used to predict the most probable time course of these factors by solving functional differential equations derived using information theory. In this way, information theory with Cyber-Cell calibrates rate parameters for reactions in which an enzyme takes part even though the origins of that enzyme are poorly understood.

Cyber-Cell's overall data and modeling integration scheme is portrayed in FIG. 53a. The Figure summarizes the richness of data types available for E. coli and yeast that Cyber-Cell integrates. FIG. 53b details an exemplary information theory methodology that automates Cyber-Cell model building and calibration processes. Cyber-Cell is integrated with a variety of data to compute the most probable values of the least well constrained model parameters via the information theory method. The method also yields the most probable time-course of the concentrations of key chemical species whose origins are not known. The computation involves execution of many Cyber-Cell simulations that can be run in parallel. For example, in FIG. 53b, the Cyber-Cell predicted proteome is processed via a synthetic tryptic digest and experimentally calibrated fragment flight time and drift time relationships. Information theory is used to compare Cyber-Cell's predicted MDS data with observed MDS data and to integrate observed data and comprehensive reaction-transport-mechanical modeling. A similar approach is used for other data types.

The Cyber-Cell model is calibrated against known results. Many calibration problems are formulated as Ax=y, where y is a vector of observed quantities, and x is the vector of parameters needed for the model. The matrix A usually depends on x. Because the problem is usually ill-posed, A is ill-conditioned. The error E equals ∥Ax−y∥², a quadratic to be minimized with respect to x. A number of techniques have been proposed to regularize such systems. Tikhonov's approach introduces a small regularization parameter λ to modify E to equal ∥Axx−y∥²+λ∥x∥². Regularization is achieved by minimizing this function with respect to x. However, the selection of the regularization parameter λ significantly affects the inversion. This technique is equivalent to the minimization of E subject to the constraint ∥x∥²=f through the use of the Lagrange multiplier technique. Minimization of the modified -error damps the large oscillations in the least-squares solution. The Levenberg-Marquardt technique uses a full Newton approach and introduces another regularization parameter that is added to the diagonal of the Jacobian matrix. Once again, the choice of the regularization parameter is difficult, and the usual practice is to change it as the simulation progresses so as to minimize its effect. In practice, multiple regularization techniques are employed simultaneously.

In Cyber-Cell, information and homogenization theories are unified into a technique that accounts for multiple scales (spatial and temporal) in the problem of interest. This provides a physically motivated regularization technique and allows the control of regularization parameters with physical arguments. While previous techniques assume that regularization and a posteriori analysis of the results are independent, Cyber-Cell's information theory-based approach integrates multiple types and qualities of observed data and regularization techniques and quantifies the uncertainty in the results.

Cell models involve poorly constrained factors that should be estimated if progress is to be made. Cyber-Cell uses a probabilistic approach based on a new formulation of information theory to estimate these factors. The three types of factors in this approach are as follows:

A Discrete Parameters (e.g., the stoichiometric coefficients that specify the numbers of each molecular species participating in a given reaction or parameters determining protein sequence→function rules);

B Continuous Parameters (e.g., reaction rate coefficients, membrane transport parameters, equilibrium constants; they can reside in a continuous range); and

C Functions (e.g., the time-course of the concentration of chemical species whose role is known, such as an enzyme, but whose mechanisms of creation and destruction are not known).

To estimate the most probable values of types A and B and the time-course of type C, Cyber-Cell uses a method that surmounts the limitations of regularization techniques used in past approaches. To do so, Cyber-Cell introduces the probability p(Γ), (Γ=A, B, C). Perhaps the most dramatic aspect of this approach is a differential equation for the most probable time-course of the C-factors.

Normalization of the probability p(Γ) implies

$${S}_{Γ} ρ = 1 \qquad ( 8 )$$

where [symbol] implies a sum over the discrete variables A, an integration over B, and a functional integration over C. To apply this, divide experiments into Nₑ types labeled k=1, 2, . . . , Nₑ, for each of which there is a set of data values O^{(k)}. For example, O^{(l)} could be the time-course of a set of intracellular constituents as they change in response to an injected chemical disturbance, O⁽²⁾ can be the normal proteome, O⁽3) can be the proteome of a virally infected cell, and O⁽⁴⁾ can be a set of membrane potentials in a rest state or as they change in response to an electrode-imposed disturbance. Through Cyber-Cell, compute a set of values Ω^{(k)}(Γ) of predicted data. As Cyber-Cell predictions depend on the choice of Γ, so do the values of the Ω^{(k)}. Define the k-th type error by:

$${E}^{( k )} = {\sum }_{i = 1}^{{N}^{( k )}} {( {Ω}_{i}^{( k )} ( Γ ) - {O}_{i}^{( k )} )}^{2} .$$

Typically, however, data are only indirectly related to the model parameters Γ. The power of this method is that even very indirect data (e.g., membrane potentials) can be used to find the most probable value of Γ (e.g., the rate coefficient for a metabolic reaction).

The entropy S of information theory is a measure of the overall uncertainty about the value of Γ; it is defined via

$$S = - {S}_{Γ} ρlnρ .$$

In the spirit of information theory, ρ is the probability that maximizes S subject to the normalization equation (8) and the available data. Among the latter are the error conditions

$${S}_{Γ} ρ {E}^{( k )} = {E}^{( k ) *} \qquad ( 9 )$$

where E^{(k)} is the value of E^{(k)} as estimated from experimental data error analysis and errors in the numerical techniques in Cyber-Cell.

It is necessary to apply regularization constraints on the time (t) dependence of the continuous variables C(t). For example, assume that estimates based on known reactions suggest that C varies on a second timescale or longer, not, say, on a nanosecond scale. Then, impose a constraint on the expected rate of change of C:

$${S}_{Γ} ρ {\int }_{0}^{{i}_{f}} ⅆ {t ( \frac{\partial {C}_{J}}{\partial t} )}^{2} = {t}_{f} {X}_{J} \qquad ( 10 )$$

for the j-th time-dependent parameter Cⱼ; the value of Xⱼ represents the typical value of the square of the rate of change of Cⱼ averaged over the ensemble and the total time (t_{f}) of the experiment.

Introducing Lagrange multipliers βₖ and Λⱼ, shows that the ρ that maximizes S subject to equations (8 and 10) takes the form

$$ln ρ = - ln Q - \frac{1}{2} {\sum }_{j = 1}^{M} {\int }_{0}^{{i}_{f}} ⅆ t {( {Λ}_{J} ( \frac{\partial {C}_{J}}{\partial t} ) )}^{2} - {\sum }_{k = 1}^{{N}_{e}} {β}_{k} {E}^{( k )} ( Γ ) .$$

The factor Q is a constant to be determined by imposing the constraints of equation (8). The most probable value of Γ is that which maximizes ρ. For A this follows from a discrete search; for B(=B₁, B₂, . . . , B_{N}_{_{b}}) and C(=C₁, C₂, . . . , C_{N}_{_{c}}) solve

$${\sum }_{k = 1}^{{N}_{e}} {β}_{k} \frac{\partial {E}^{( k )}}{\partial {B}_{J}} = 0 , i = 1 , 2 , ⃛ , {N}_{b} \\ and \\ {Λ}_{J} \frac{{\partial }^{2} {C}_{J}}{\partial {t}^{2}} + {\sum }_{k = 1}^{{N}_{Γ}} {β}_{k} δ \frac{{E}^{( k )}}{δ {C}_{J}} = 0 , j = 1 , 2 , ⃛ , {N}_{c} . \qquad ( 11 )$$

and

Equation (11) is a time-differential equation which has similarities in its behavior to a steady state diffusion equation in the time dimension t. In analogy to ordinary derivatives, the functional derivatives δE^{(k)}/δCⱼ measure the degree to which E^{(K)} changes when the form of the function Cⱼ(t) changes by an infinitesimal amount. As the Λ-parameters get larger, the Cs become smoother functions of time. The values of the β and Λ parameters are determined in this procedure via the imposition of equations (9 and 10). This computation is implemented by assuming that ρ(F) is narrowly peaked about the most probable value of Γ.

A simple reaction model illustrates this approach. The model involves three species X, Y, and C that are known to participate in the reactions

X+Y→2X

2X→products

2Y→products

C+X→products

C+Y→2Y. (12)

For this example, assume that all the reactions creating or destroying X and Y are known, but that those affecting the catalyst C are not. Consider now the challenge of determining the catalyst concentration time-course C(t) given limited or noisy data on X(t) at a set of discrete times (but not Y(t)). Assume also that C is known at t=0 and at the final time t_{f} (5 minutes). In order to test this approach, let

C(t)=e^{-|sin(ωt)|}

and then generate X(t) via the numerical solution of mass action rate laws for the mechanism of equation (12). Call this solution the “observed data”; various levels of noise are added to evaluate the effect of uncertainty in the data.

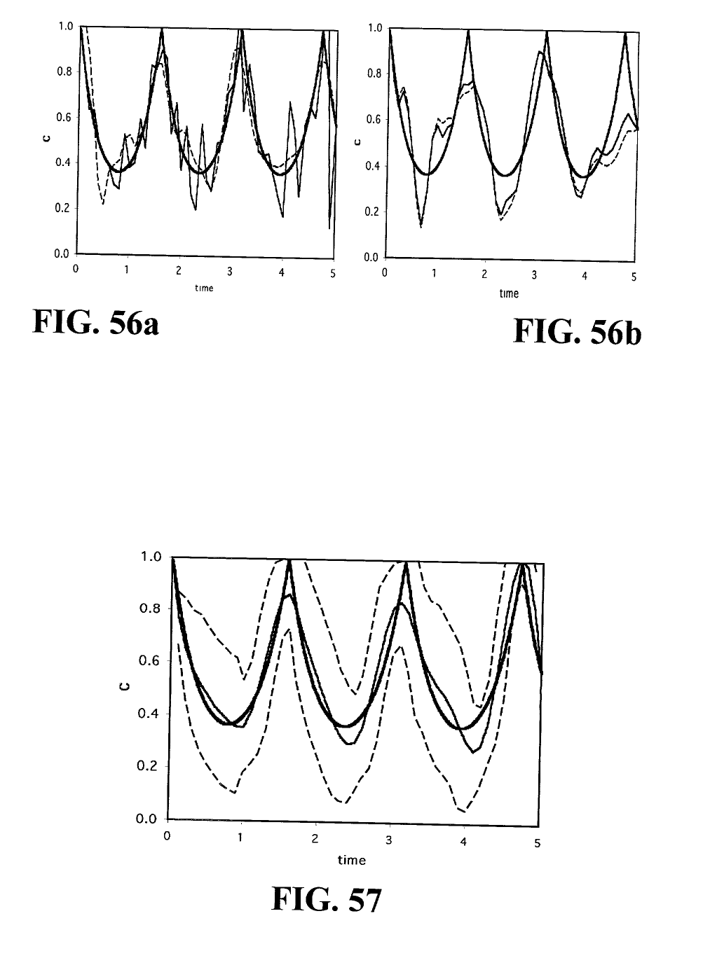

FIGS. 56a and 56b compare results for various levels of noise in the experimental data. FIG. 56a shows the effect of 0.3% noise in the observed data X(t) on the solution. In the absence of regularization, high frequency oscillations are amplified significantly even when there is a small amount of noise in the observed data. In contrast, FIG. 56b shows that even when the level of noise is increased significantly (2% and 3% for thin solid and dashed lines, respectively), regularization yields satisfactory results. The physically-motivated regularization equation (10) increases the allowable noise in the experimental data by an order of magnitude. As this method is based on an objective probability analysis, it provides the uncertainty in the predictions—see, for example, FIG. 57 (showing the root mean square deviation of C(t) (dashed lines) for E*=0.001).

This approach yields accurate results even with limited and noisy data, a situation typical for experimental cell data. The method even works for highly nonlinear problems as for the above test system and for numerical simulations-both of which are a key part of Cyber-Cell. Thus, this test case demonstrates the feasibility of Cyber-Cell's approach.

Cyber-Cell is calibrated using its unique information theory approach. This allows the use of diverse proteomic, genomic, biochemical, and other data sets. This automated approach not only obtains the most probable values of the rate and other parameters, but also automatically obtains an assessment of the associated uncertainty. The uncertainty assessment provides guidelines for experimental research teams in the design of the most efficient data acquisition strategy. Cyber-Cell is calibrated using data distinct from the test data set. The wealth of available data (see Table above) and the rapidly increasing proteomic, genomic, and other databases make this feasible.

### XII. Summary

The two above-described embodiments illustrate the broad applicability of the invention, spanning as they do a range of time coordinates from nanoseconds to geologic eons and a range of space coordinates from the atomic to the continental. In view of the many possible embodiments to which the principles of this invention may be applied, it should be recognized that these embodiments are meant to be illustrative only and should not be taken as limiting the scope of the invention. Therefore, the invention as described herein contemplates all such embodiments as may come within the scope of the following claims and equivalents thereof.

We claim:

1. A method for producing a model of a region of interest, the method comprising:
collecting a first set of data points pertaining to the region of interest;
dividing the first data set into a second data set and a third data set;
populating a model with data points from the second data set;
interpolating a data point in the model using a subset of data points from the second data set;
comparing a subset of data points in the model to a subset of data points in the third data set; and
if comparing yields a discrepancy larger than an error limit, then varying a data point in the model corresponding to a data point in the second data set and repeating the interpolating and comparing.

2. The method of claim 1 wherein collecting comprises collecting data points of more than one type.

3. The method of claim 1 wherein dividing produces data points common to the second and third data sets.

4. The method of claim 1 wherein interpolating comprises applying multi-dimensional, finite-element methods to a subset of data points in the model.

5. The method of claim 1 wherein interpolating comprises applying an equation to a subset of data points in the model, the equation being of a type in the set:
thermodynamic, chemical, genomic.

6. The method of claim 1 wherein interpolating is based, at least in part, on a spacing among a subset of data points in the model.

7. The method of claim 1 wherein comparing yields a discrepancy based, at least in part, on a sum of squares of differences between a subset of data points in the model and a subset of data points in the third data set.

8. The method of claim 1 wherein varying a data point comprises varying an item in the set: a value of the data point, a position of the data point in the model.

9. The method of claim 1 wherein varying comprising varying multiple data points in the model corresponding to data points in the second data set.

10. The method of claim 1 wherein collecting comprises associating measures of constraint with data points in the second data set and wherein varying comprises choosing a data point in the model to vary, the chosen data point's measure of constraint being less than that of another data point in the model.

11. The method of claim 10 wherein a measure of constraint is associated with a probable error range and wherein a larger error range yields a lower constraint.

12. The method of claim 10 wherein interpolating is based, at least in part, on measures of constraint of a subset of data points in the model.

13. The method of claim 1 further comprising:
estimating a probability of the model resulting from the varying;
wherein the varying comprises choosing an amount by which to vary a data point, the data point and the amount to vary the data point chosen, at least in part, in order to maximize an estimated probability of the model.

14. The method of claim 13 wherein estimating a probability is subject to a constraint based on a subset of data points in the third data set.

15. The method of claim 13 wherein estimating a probability comprises:
calculating a probability functional that maximizes an entropy, the calculating subject to normalizing the probability functional and subject to a constraint based on a subset of data points in the third data set.

16. The method of claim 15 wherein entropy is defined to comprise a negative of a functional integral over possible states of the model of the probability functional multiplied by a natural log of the probability functional.

17. The method of claim 15 wherein normalizing the probability functional comprises setting a functional integral over possible states of the model of the probability functional to one.

18. The method of claim 15 wherein the calculating is subject to a constraint based on a subset of data points in the third data set when a functional integral over possible states of the model of the discrepancy multiplied by the probability functional is equal to an ensemble error average.

19. The method of claim 15 wherein maximizing an estimated probability of the model comprises:
determining where a functional derivative of the probability functional with respect to the model becomes zero.

20. A computer-readable medium having instructions for performing the method of claim 1.

21. A method of extending a model of a region of interest along a coordinate, the method comprising:
applying an equation to evolve the model a distance along the coordinate; and
maximizing a probable state of the evolved model.

22. The method of claim 21 wherein maximizing a probable state comprises:
collecting a set of data points pertaining to the region of interest;
comparing a subset of data points in the model to a subset of data points in the collected data set; and
if comparing yields a discrepancy larger than an error limit, then varying a data point in the model and repeating the comparing.

23. The method of claim 22 wherein comparing comprises comparing data points of more than one type.

24. The method of claim 22 wherein comparing yields a discrepancy based, at least in part, on a sum of squares of differences between a subset of data points in the model and a subset of data points in the collected data set.

25. The method of claim 22 wherein varying a data point comprises varying an item in the set: a value of the data point, a position of the data point in the model.

26. The method of claim 22 wherein varying comprising varying multiple data points in the model.

27. The method of claim 22 further comprising:
estimating a probability of the model resulting from the varying;
wherein the varying comprises choosing an amount by which to vary a data point, the data point and the amount to vary the data point chosen, at least in part, to maximize an estimated probability of the model.

28. The method of claim 27 wherein estimating a probability is subject to a constraint based on a subset of data points in the collected data set.

29. The method of claim 27 wherein estimating a probability comprises:
calculating a probability functional that maximizes an entropy, the calculating subject to normalizing the probability functional and subject to a constraint based on a subset of data points in the collected data set.

30. The method of claim 29 wherein entropy is defined to comprise a negative of a functional integral over possible states of the model of the probability functional multiplied by a natural log of the probability functional.

31. The method of claim 29 wherein normalizing the probability functional comprises setting a functional integral over possible states of the model of the probability functional to one.

32. The method of claim 29 wherein the calculating is subject to a constraint based on a subset of data points in the collected data set when a functional integral over possible states of the model of the discrepancy multiplied by the probability functional is equal to an ensemble error average.

33. The method of claim 29 wherein maximizing an estimated probability of the model comprises:
determining where a functional derivative of the probability functional with respect to the model becomes zero.

34. The method of claim 21 wherein the model is evolved along a coordinate in the set:
time, space.

35. The method of claim 21 wherein applying an equation comprises applying an equation to a subset of data points in the model, the equation being of a type in the set: thermodynamic, chemical, genomic.

36. A computer-readable medium having instructions for performing the method of claim 21.

37. A method of estimating a probability of a model of a region of interest, the method comprising:
collecting a set of data points pertaining to the region of interest;
comparing a subset of data points in the model to a subset of data points in the collected data set to yield a discrepancy; and
calculating a probability functional that maximizes an entropy, the calculating subject to normalizing the probability functional and subject to a constraint based on a subset of data points in the collected data set.

38. The method of claim 37 wherein comparing comprises comparing data points of more than one type.

39. The method of claim 37 wherein comparing yields a discrepancy based, at least in part, on a sum of squares of differences between a subset of data points in the model and a subset of data points in the collected data set.

40. The method of claim 37 wherein entropy is defined to comprise a negative of a functional integral over possible states of the model of the probability functional multiplied by a natural log of the probability functional.

41. The method of claim 37 wherein normalizing the probability functional comprises setting a functional integral over possible states of the model of the probability functional to one.

42. The method of claim 37 wherein the calculating is subject to a constraint based on a subset of data points in the collected data set when a functional integral over possible states of the model of the discrepancy multiplied by the probability functional is equal to an ensemble error average.

43. A computer-readable medium having instructions for performing the method of claim 37.

44. A method for producing a model of fracture locations and fracture characteristics in a geologic basin, the method comprising:
collecting a first set of data points pertaining to the geologic basin;
dividing the first data set into a second data set and a third data set;
populating a model with data points from the second data set;
processing a subset of data points in the model by applying equations to simulate rock rheology by integrating continuous deformation with fracture, fault, gouge, and pressure solutions;
processing a subset of data points in the model by applying equations to simulate mechanical processes to coevolve deformation with multi-phase flow, petroleum generation, mineral reactions, and heat transfer;
comparing a subset of data points in the model to a subset of data points in the third data set; and
if comparing yields a discrepancy larger than an error limit, then varying a data point in the model corresponding to a data point in the second data set and repeating the processing and comparing.

45. The method of claim 44 wherein collecting a first set of data points comprises collecting data in the set: well log data, surface data, core data, seismic data.

46. A computer-readable medium having instructions for performing the method of claim 44.

47. A method for producing a model of a biological cell, the method comprising:
collecting a first set of data points pertaining to the biological cell;
dividing the first data set into a second data set and a third data set;
populating a model with data points from the second data set;
processing a subset of data points in the model by applying equations to simulate reactions, the equations being of types in the set: chemical kinetic, proteomic, genomic, glycolysis, citric acid cycle, amino acid synthesis, nucleotide synthesis, membrane transport;
comparing a subset of data points in the model to a subset of data points in the third data set; and
if comparing yields a discrepancy larger than an error limit, then varying a data point in the model corresponding to a data point in the second data set and repeating the processing and comparing.

48. The method of claim 47 wherein collecting a first set of data points comprises collecting data in the set: microscopy, genomics, proteomics, multi-dimensional spectroscopy, x-ray crystallography, thermodynamics, biochemical kinetics, bioelectrics.

49. A computer-readable medium having instructions for performing the method of claim 47.
